(19) United States
(12) Patent Application Publication
(10) Pub. No.: US 2008/0063747 A1
(43) Pub. Date: Mar. 13, 2008

(54) DUSTING COMPOSITIONS FOR CHEWING GUM PRODUCTS

(75) Inventors: Navroz Boghani, Flanders, NJ (US); Petros Gebreselassie, Piscataway, NJ (US); Bharat Jani, East Brunswick, NJ (US); Kishor Kabse, Morris Plains, NJ (US); R. Steve Grant, Chester, NJ (US); Jesse Kiefer, Columbia, NJ (US); Thomas Kuncewitch, Long Valley, NJ (US); Colleen Kramer, Ho-Ho-Kus, NJ (US); Mary K. Robinson, Sparta, NJ (US); Kristen Schmitz, Jersey City, NJ (US); Shiuh John Luo, Livingston, NJ (US)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 11/840,729

(22) Filed: Aug. 17, 2007

Related U.S. Application Data
(63) Continuation-in-part of application No. 11/205,874, filed on Aug. 17, 2005.
Application No. 11/205,874 is a continuation-in-part of application No. 10/955,149, filed on Sep. 30, 2004.
Application No. 11/205,874 is a continuation-in-part of application No. 10/955,225, filed on Sep. 30, 2004.
(63) Continuation-in-part of application No. 11/415,043, filed on May 1, 2006.
(63) Continuation-in-part of application No. 11/210,954, filed on Aug. 24, 2005.
(63) Continuation-in-part of application No. 10/925,822, filed on Aug. 25, 2004.
(63) Continuation-in-part of application No. 11/415,044, filed on May 1, 2006.
(63) Continuation-in-part of application No. 11/210,954, filed on Aug. 24, 2005.
(63) Continuation-in-part of application No. 10/925,822, filed on Aug. 25, 2004.
(63) Continuation-in-part of application No. 11/415,006, filed on May 1, 2006.
(63) Continuation-in-part of application No. 11/210,954, filed on Aug. 24, 2005.
(63) Continuation-in-part of application No. 10/925,822, filed on Aug. 25, 2004.
(63) Continuation-in-part of application No. 11/415,012, filed on May 1, 2006.
(63) Continuation-in-part of application No. 11/210,954, filed on Aug. 24, 2005.
(63) Continuation-in-part of application No. 10/925,822, filed on Aug. 25, 2004.
(63) Continuation-in-part of application No. PCT/US06/19879, filed on May 19, 2006.
(60) Provisional application No. 60/776,699, filed on Feb. 24, 2006.
(60) Provisional application No. 60/683,634, filed on May 23, 2005.
(60) Provisional application No. 60/650,758, filed on Feb. 7, 2005.
(60) Provisional application No. 60/776,699, filed on Feb. 24, 2006.
(60) Provisional application No. 60/683,634, filed on May 23, 2005.
(60) Provisional application No. 60/650,758, filed on Feb. 7, 2005.
(60) Provisional application No. 60/776,699, filed on Feb. 24, 2006.
(60) Provisional application No. 60/683,634, filed on May 23, 2005.
(60) Provisional application No. 60/650,758, filed on Feb. 7, 2005.
(60) Provisional application No. 60/776,699, filed on Feb. 24, 2006.
(60) Provisional application No. 60/683,634, filed on May 23, 2005.
(60) Provisional application No. 60/650,758, filed on Feb. 7, 2005.
(60) Provisional application No. 60/683,634, filed on May 23, 2005.
(60) Provisional application No. 60/838,524, filed on Aug. 17, 2006.

(51) Int. Cl. A23G 4/20; A23G 3/54; A23G 4/00; A23G 4/12

(52) U.S. Cl. 426/5; 424/43; 426/531; 426/533; 426/534; 426/540; 426/648; 426/650; 426/96

(57) ABSTRACT

The present application relates to compositions for dusting chewing gum products and chewing gum products incorporating same. The dusting compositions have a managed release profile. The compositions generally include a dusting component, which is at least partially encapsulated with an encapsulating material. The compositions also may include an unencapsulated dusting component. The present invention also includes dusted chewing gum products, such as center-fill, compressed or candy gum, and methods of making same.

### CROSS-REFERENCE TO RELATED APPLICATIONS

This application is a continuation-in-part of U.S. application Ser. No. 11/205,874, filed Aug. 17, 2005, which is a continuation-in-part of both U.S. application Ser. No. 10/955,149, filed Sep. 30, 2004 and U.S. application Ser. No. 10/955,225, filed Sep. 30, 2004; and the present application is a continuation-in-part of U.S. application Ser. No. 11/415,043, filed May 1, 2006, which claims the benefit of both U.S. Provisional Application No. 60/776,699, filed Feb. 24, 2006 and U.S. Provisional Application No. 60/683,634, filed May 23, 2005, and which is a continuation-in-part of U.S. application Ser. No. 11/210,954, filed Aug. 24, 2005, which claims the benefit of U.S. Provisional Application No. 60/650,758, filed Feb. 7, 2005, and which is a continuation-in-part of U.S. patent application Ser. No. 10/925,822, filed Aug. 25, 2004; and the present application is a continuation-in-part of U.S. application Ser. No. 11/415,044, filed May 1, 2006, which claims the benefit of U.S. Provisional Application No. 60/776,699, filed Feb. 24, 2006 and U.S. Provisional Application No. 60/683,634, filed May 23, 2005, and which is a continuation-in-part of U.S. patent application Ser. No. 11/210,954, filed Aug. 24, 2005, which claims the benefit of U.S. Provisional Application No. 60/650,758, filed Feb. 7, 2005, and which is a continuation-in-part of U.S. patent application Ser. No. 10/925,822, filed Aug. 25, 2004; and the present application is a continuation-in-part of U.S. application Ser. No. 11/415,006, filed May 1, 2006, which claims the benefit of U.S. Provisional Application No. 60/776,699, filed Feb. 24, 2006 and U.S. Provisional Application No. 60/683,634, filed May 23, 2005, and which is a continuation-in-part of U.S. patent application Ser. No. 11/210,954, filed Aug. 24, 2005, which claims the benefit of U.S. Provisional Application No. 60/650,758, filed Feb. 7, 2005, and which is a continuation-in-part of U.S. patent application Ser. No. 10/925,822, filed Aug. 25, 2004; and the present application is a continuation-in-part of U.S. application Ser. No. 11/415,012, filed May 1, 2006, which claims the benefit of U.S. Provisional Application No. 60/776,699, filed Feb. 24, 2006 and U.S. Provisional Application No. 60/683,634, filed May 23, 2005, and which is a continuation-in-part of U.S. patent application Ser. No. 11/210,954, filed Aug. 24, 2005, which claims the benefit of U.S. Provisional Application No. 60/650,758, filed Feb. 7, 2005, and which is a continuation-in-part of U.S. patent application Ser. No. 10/925,822, filed Aug. 25, 2004; and the present application is a continuation-in-part of International Patent Application No. PCT/US06/19879, filed May 19, 2006, which claims the benefit of U.S. Provisional Application No. 60/683,634, filed May 23, 2005, U.S. application Ser. No. 11/135,149, filed May 23, 2005, and U.S. application Ser. No. 11/135,153, filed May 23, 2005, which is a continuation-in-part of both PCT/US04/37185, filed Nov. 22, 2004, which is a continuation-in-part of U.S. application Ser. No. 10/719,298, filed Nov. 21, 2003, and of U.S. application Ser. No. 11/083,968, filed Mar. 21, 2005, which is a continuation-in-part of U.S. application Ser. No. 10/719,298, filed Nov. 21, 2003, and PCT/US06/19879 also claims the benefit of U.S. application Ser. No. 11/134,367, filed May 23, 2005, which is a continuation-in-part of U.S. application Ser. No. 10/719,298, filed Nov. 21, 2003, and PCT/US06/19879 also claims the benefit of U.S. application Ser. No. 11/134,370, filed May 23, 2005, U.S. application Ser. No. 11/134,356, filed May 23, 2005, U.S. application Ser. No. 11/134,371, filed May 23, 2005, U.S. application Ser. No. 11/134,480, filed May 23, 2005, U.S. application Ser. No. 11/134,369, filed May 23, 2005, U.S. application Ser. No. 11/134,364, filed May 23, 2005, U.S. application Ser. No. 11/134,365, filed May 23, 2005, and U.S. Provisional Application No. 60/734,680, filed Nov. 8, 2005; and the present application claims the benefit of U.S. Provisional Application No. 60/838,524, filed Aug. 17, 2006, the contents all of which are incorporated herein by reference.

### FIELD

The present invention includes compositions for dusting chewing gum products. The compositions generally include a dusting component, which is at least partially encapsulated with an encapsulating material. The present invention also includes dusted chewing gum products and methods of making same.

### BACKGROUND

It is known to dust products, such as chewing gum products, with materials such as powdered sugar or sugar-free substances to improve characteristics of the gum, such as appearance and initial taste. Dusting also provides the benefits of preventing the chewing gum from sticking to manufacturing equipment, consumers' fingers when handled, or to the wrapper when the product is unwrapped. The material used to dust chewing gum is known as a dusting compound, such materials are also referred to as rolling compounds because they are used to prevent sticking during processing including rolling and scoring.

A dusting compound is typically applied to the surface of chewing gum as it is formed. Dusting compounds can serve a variety of purposes. For example, dusting compounds can serve to reduce sticking to machinery as it is wrapped, and can reduce sticking to wrappers after the chewing gum is wrapped and being stored.

Previously known dusting compounds, however, may experience problems with stability and resistance to heat during processing and storage. There is a need, therefore, for dusting compositions having enhanced stability and resistance to heat both during processing and during storage. Additionally, previously known dusting compounds fail to provide controlled-release profiles, which may be desirable in some chewing gum products.

### SUMMARY

Some embodiments provide a dusting composition which includes a dusting component and an encapsulating material, where the dusting component may be at least partially encapsulated by the encapsulating material. In some embodiments, the dusting composition further includes an unencapsulated dusting component, which may be the same as the encapsulated dusting component or different than the encapsulated dusting component.

Some embodiments provide a dusting composition including: a dusting component; and an encapsulating material, wherein the dusting component is at least partially encapsulated by the encapsulating material.

Some embodiments provide a chewing gum composition including: (a) a chewing gum piece including: (i) a gum base; (ii) a flavor; and (iii) a sweetening agent; and (b) a dusting composition including: (i) a dusting component; and (ii) an encapsulating material, wherein the dusting component is at least partially encapsulated by the encapsulating material, wherein the chewing gum piece has an outer surface and wherein the dusting composition at least partially surrounds the outer surface.

Some embodiments provide a chewing gum composition which includes a chewing gum unit and a dusting composition, where the chewing gum unit has an outer surface and the dusting composition at least partially surrounds the outer surface. The chewing gum unit may include a gum base, a flavor and a sweetening agent and the dusting composition may include a dusting component and an encapsulating material, where the dusting component is at least partially encapsulated by the encapsulating material. The chewing gum unit may be a sheet which is scored or not scored, a stick, a slab, a ball, a pellet, a square, or a cube.

Some embodiments provide a chewing gum composition including: (a) a chewing gum unit including an elastomer; and (b) a dusting composition including: (i) a dusting component; and (ii) an encapsulating material, wherein the dusting component is at least partially encapsulated by the encapsulating material; and wherein the chewing gum unit has an outer surface and wherein the dusting composition is located on the outer surface.

Some embodiments provide a multi-region chewing gum composition including: (a) a chewing gum unit including: (i) a first region composition; and (ii) a second region composition surrounding at least a portion of said first region composition, said second region composition including an elastomer and having a first region contacting surface and an outer surface; and (b) a dusting composition, at least a portion of which is encapsulated, located on at least one of the first region contacting surface and the outer surface.

Some embodiments provide a center-fill chewing gum composition including: (a) a center-fill region; (b) a gum region surrounding the center-fill region, said gum region including a gum base; and (c) a dusting composition including: (i) a dusting component; and (ii) an encapsulating material, wherein the dusting component is at least partially encapsulated by the encapsulating material; wherein the dusting composition at least partially surrounds at least one of the center-fill region and the gum region.

Some embodiments provide a multi-region chewing gum composition which includes a first region composition, a second region composition surrounding at least a portion of the first region composition, and a dusting composition, where the dusting composition at least partially surrounds at least one of the first region composition and the second region composition. In some embodiments, the second region composition includes an elastomer and the dusting composition includes a dusting component and an encapsulating material, where the dusting component is at least partially encapsulated by the encapsulating material.

Some embodiments provide a center-fill chewing gum composition which includes a center-fill region in slab form, a gum region in slab form surrounding the center-fill region and a dusting composition, where the dusting composition at least partially surrounds at least one of the center-fill regions and the gum region. The gum region includes a gum base and the dusting composition includes a dusting component and an encapsulating material, where the dusting component is at least partially encapsulated by the encapsulating material.

Some embodiments provide a center-fill chewing gum composition including: (a) a center-fill region in slab form; (b) a gum region in slab form surrounding said center fill region, said gum region including a gum base; and (c) a dusting composition including: (i) a dusting component; and (ii) an encapsulating material wherein said dusting component is at least partially encapsulated by the encapsulating material; and wherein the dusting composition at least partially surrounds at least one of the center fill region and the gum region.

Some embodiments provide a center-fill chewing gum composition which includes a center-fill region, a gum region surrounding the center-fill region, which includes a gum base and has a center-fill contacting surface, and a dusting composition, at least a portion of which is encapsulated, located on the center-fill contacting surface.

A center-fill chewing gum composition including: (a) a center-fill region; (b) a gum region surrounding the center-fill region; the gum region including a gum base and having a center-fill contacting surface; and (c) a dusting composition, at least a portion of which is encapsulated, located on the center-fill contacting surface.

Some embodiments provide a center-fill chewing gum composition which includes a center-fill region, a gum region surrounding the center-fill region and including a gum base, and a dusting composition, at least a portion of which is encapsulated and which is located on a surface of the center-fill region or a surface of the gum region.

Some embodiments provide a chewing gum composition which includes a compressible gum base composition and a dusting composition at least partially surrounding the compressible gum base composition, which dusting composition includes a dusting component and an encapsulating material, where the encapsulating material at least partially surrounds the dusting component.

Some embodiments provide a chewing gum tablet including: (a) a particulate chewing gum base component pressed into a tablet form; and (b) a dusting composition, said dusting composition including: (i) a dusting component; and (ii) an encapsulating material, wherein the encapsulating material at least partially surrounds the dusting component.

Some embodiments provide a chewing gum tablet which includes a particulate chewing gum base component pressed into a tablet form, and a dusting composition at least partially surrounding the tablet form, which includes a dusting component and an encapsulating material, where the encapsulating material at least partially surrounds the dusting component.

Some embodiments provide a candy gum composition which includes a cooked saccharide region, an elastomeric region adjacent to the cooked saccharide region and a dusting composition, where the dusting composition at least partially surrounds at least one of the cooked saccharide regions and the elastomeric region. The dusting composition includes a dusting component and an encapsulating material, where the encapsulating material at least partially surrounds the dusting component.

Some embodiments provide a candy gum composition including: (a) a cooked saccharide region; (b) an elastomeric region adjacent to the cooked saccharide region; and (c) a dusting composition including: (i) a dusting component; and (ii) an encapsulating material, wherein the encapsulating material at least partially surrounds the dusting component, and wherein the dusting composition at least partially surrounds at least one of the cooked saccharide region, the elastomeric region, and the candy gum composition.

Other embodiments provide for a method of preparing a chewing gum piece, which includes the steps of (a) providing a chewing gum composition, where the chewing gum composition includes a gum base, a flavor and a sweetening agent; (b) forming an individual piece of chewing gum, the piece having an outer surface; and (c) applying a dusting composition to the outer surface, the dusting composition including a dusting component and an encapsulating material, where the dusting component is at least partially encapsulated by the encapsulating material.

Other embodiments provide for a method of preparing a chewing gum unit including the steps of: (a) providing a chewing gum composition including an elastomer; (b) forming a chewing gum unit, the unit having an outer surface; and (c) applying a dusting composition to the outer surface, the dusting composition including a dusting component and an encapsulating material, wherein the dusting component is at least partially encapsulated by the encapsulating material.

Other embodiments provide for a method of preparing a center-fill chewing gum piece including the steps of: (a) providing a chewing gum composition, including a center-fill region and a gum region surrounding the center-fill region, the gum region including a gum base; (b) applying a dusting composition to at least one of the center-fill and the gum region, the dusting composition including a dusting component and an encapsulating material, where the dusting component is at least partially encapsulated by the encapsulating material; and (c) forming an individual piece of center-fill chewing gum from the chewing gum composition. In some embodiments, the method further includes the step of removing the dusting composition prior to wrapping the individual piece of chewing gum.

A method of preparing a multi-region chewing gum unit including the steps of: (a) providing a chewing gum composition including: (i) a first region; (ii) a second region surrounding at least a portion of said first region, said second region including an elastomer; (b) applying a dusting composition to at least one of the first and second region, said dusting composition including a dusting component and an encapsulating material, wherein the dusting component is at least partially encapsulated by the encapsulating material; and (c) forming a unit of multi-region chewing gum from the chewing gum composition. In some embodiments, such a method further includes the step of removing the dusting composition prior to wrapping the unit of chewing gum.

Other embodiments provide a method for encapsulating a dusting component with an encapsulating material for a dusting component, including determining a desired release profile for a dusting component in a chewing gum composition; selecting an encapsulating material such that hydrophobicity of the encapsulating material and a tensile strength of a dusting composition will provide the desired release profile for the dusting component in the chewing gum composition, where the dusting composition includes a dusting component encapsulated with the encapsulated material; and encapsulating the dusting component with the encapsulating material.

Another embodiment provides a method for encapsulating a dusting component with an encapsulating material for a dusting component, including: providing a dusting component; providing an encapsulating material; encapsulating the dusting component with the encapsulating material to produce an encapsulated dusting component; and incorporating the encapsulated dusting component into a dusting composition.

Another embodiment provides a method for modifying a release profile of a dusting component encapsulated with an encapsulating material in a dusting composition, the dusting composition being included in a chewing gum composition, including: determining a first release profile for the dusting component; determining a desired change in release profile for the dusting component based on the first release profile; and modifying hydrophobicity of the encapsulating material based on the desired change in release profile for the dusting component.

A method for modifying a release profile of a dusting component encapsulated with an encapsulating material in a dusting composition, said dusting composition having at least one release characteristic and said dusting composition being included in a chewing gum composition, including: determining a first release profile for said dusting component; determining a desired change in said first release profile for said dusting component based on said first release profile; and modifying said at least one first release characteristic of said dusting composition based on said desired change in said first release profile. In some embodiments of such a method, the at least one first release characteristic of the dusting composition is selected from the group consisting of tensile strength of said encapsulating material, ratio of the dusting component to the encapsulating material, type of encapsulating material, ratio of the dusting component to the encapsulating material, type of encapsulating material, molecular weight of the encapsulating material, hydrophobicity of the encapsulating material, average particle size of the dusting component, the number of layers of encapsulating material, and combinations thereof.

Another embodiment provides a method for modifying a release profile of a dusting component encapsulated with an encapsulating material in a dusting composition, the dusting composition being included in a chewing gum composition, including: determining a first release profile for the dusting component; determining a desired change in release profile for the dusting component based on the first release profile; and modifying a ratio of the dusting component to the encapsulating material in the dusting composition based on the desired change in release profile for the dusting component.

Another embodiment provides a method for modifying a release profile of a dusting component encapsulated with an encapsulating material in a dusting composition, the dusting composition being included in a chewing gum composition, including: determining a first release profile for the dusting component; determining a desired change in release profile for the dusting component based on the first release profile; and modifying average particle size of the dusting composition in the chewing gum composition based on the desired change in release profile.

Another embodiment provides a method for modifying a release profile of a dusting component in a dusting composition, the dusting composition being included in a chewing gum composition, including: determining a first release profile for the dusting component; determining a desired change in release profile for the dusting component based on the first release profile; and modifying tensile strength of the dusting composition based on the desired change in release profile for the dusting composition.

### DETAILED DESCRIPTION

Embodiments described herein provide compositions for dusting chewing gum products and chewing gum products dusted thereby, such as, for example, center-fill gum, compressed gum, candy gum, and the like. The dusting compositions may by used to provide processing advantages, to reduce sticking for consumers, as well to as provide different textures, initial tastes and appearances to the chewing gum product.

The dusting compositions desirably have a modified release profile. One method of providing modified release is encapsulation of the dusting component. Encapsulation techniques are used to take advantage of texturization, initial impact, color, and appearance. Encapsulation has the added benefit of controlled release properties when the encapsulate, i.e., the dusting component, is an active.

Accordingly, in some embodiments, the dusting compositions include a dusting component and an encapsulating material. The encapsulating material at least partially encapsulates the dusting component. A variety of different ingredients may be used as dusting components, such as, for example, sweeteners, flavors, sensates, acids, salts, functional agents and the like.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

As used herein, the terms “bubble gum” and “chewing gum” are used interchangeably and are both meant to include any gum compositions.

As used herein, the term “dusting composition” refers to any composition including particles of one or more materials that may be applied, such as by brushing or shaking or sprinkling during rolling and scoring, to a surface of a chewing gum piece. In some embodiments, the particles are dry.

As used herein, the term “dusting component” refers to any material that maybe used in particulate form in a dusting composition, as defined above.

As used herein, the terms “dusting” and “rolling” are used interchangeably and have the same meaning.

As used herein, the term “active” refers to any composition which may be included in the encapsulated compositions of some embodiments, wherein the active provides some desirable property upon release from encapsulation. Examples of suitable actives include sweeteners, such as sucralose, flavors, breath fresheners, sensates such as coolers, warmer and spicy components, medicaments, acids, salts, flavors, vitamins, and combinations thereof.

As used herein, the term “thermally stabilized active” refers to an active which has been treated to allow the active to be subjected to higher temperatures without decomposition, degradation, and/or discoloration of the active. These temperatures are higher than the temperatures at which the free or untreated actives would normally begin to decompose, degrade, and/or discolor.

As used herein, the terms “first region” or “center-fill” refer to the innermost region of the compositions. The term “center-fill” does not imply symmetry of a gum piece, only that the “center-fill” is within another region of the gum piece. In some embodiments, more than one center-fill may be present.

As used herein, the terms “second region” or “gum region” refer to a region of the compositions that may be adjacent to or at least partially surrounding the center-fill, first, or innermost, region.

As used herein, the term “coating” refers to the outermost region of the compositions, which may at lease partially surround the second or gum region. The term “coating” can include particulate or non-particulate compositions. The coating may be any conventional sugar or sugarless coating. Exemplary coatings include hard coatings, gumming or glazing, soft coating, smoothing, frosting, sanding, and wet crystallization.

As used herein, the term “multi-region” refers to compositions with more than one region with distinct compositions. Such “multi-region” compositions can be configured in any way including concentric multiple layers, horizontal/vertical layers, and the like. As such, the multiple layers can surround at least a portion of each and/or can be adjacent to each other.

As used herein, the term “unit” refers to a formed chewing gum composition. The chewing gum unit may be a sheet or rope which is scored or not scored and which may be divided into multiple individual pieces. The chewing gum unit may also be individual pieces in any shape such as, but not limited to, a stick, a slab, a ball, a pellet, a square, or a cube. The chewing gum unit may be further formed as when a chewing gum sheet is scored to form individual pieces.

As used herein, the terms “surround,” “surrounding,” and the like are not limited to encircling. These terms may refer to enclosing or confining on all sides, encircling or enveloping, and are not limited to symmetrical or identical thicknesses for a region in the gum product. Nor are these terms limited to direct contact between the surrounding and the surrounded materials.

As used herein, the term “liquid” includes compositions that can transfer moisture from the center-fill region to the gum region in center-fill gum embodiments. The term includes, but is not limited to, compositions which will readily flow or maintain fluid properties at room temperature and pressure. The term “liquid” may include solutions, suspensions, emulsions, semi-solids, cremes, gels, etc. that may not be completely liquid, but that can still lose liquidity because of a transfer of moisture from the center-fill region to the gum region. The “liquid” may be aqueous or non-aqueous. Also, the “liquid” may include non-liquid components, such as solid particles or gases.

As used herein, the term “ingredient” and the term “component” are used interchangeably to describe any additive, fixing, substance, material, agent, active, element, or part that may be included in the gum compositions of some embodiments.

Dusting Compositions

Dusting compositions described herein for use with chewing gum products may have a managed, or modified release. In some embodiments, the release of the dusting component may be modified by encapsulation techniques. Dusting compositions as described herein generally may include a dusting component and an encapsulating material, where the dusting component is at least partially encapsulated by the encapsulating material. The at least partially encapsulated dusting composition may be used to dust a variety of different chewing gum products.

In some embodiments, the dusting composition may contain an unencapsulated, or “free”, dusting component, which may be the same as or different from the encapsulated dusting component. For example, an encapsulated flavor may be combined with the same flavor in its unencapsulated form to provide a dusting composition. In other embodiments, the unencapsulated dusting component may be different from the encapsulated dusting component. For instance, a dusting composition may include a combination of one encapsulated sweetener, such as xylitol, with a different unencapsulated sweetener, such as sorbitol.

In some embodiments, the dusting compositions may include encapsulated and/or unencapsulated dusting components.

Further, in some embodiments, encapsulation may act to stabilize the specific active used as the dusting component. As such, some dusting compositions may include a thermally stabilized active.

In general, the dusting component maybe present in amounts of about 0.5% to about 100% by weight of the dusting composition, more specifically about 1% to about 50%, and more specifically about 5% to about 50% by weight of the dusting composition. In some embodiments, the dusting composition is present in an amount that is from about 0.001% to about 20% by weight of chewing gum composition, a center-fill chewing gum composition, or a chewing gum tablet. The dusting component may have an average particle size of about 800 μm or less. In some embodiments, the dusting component may have an average particle size of about 10-800 μm. More particularly, in some embodiments, the dusting composition may have an average particle size from about 50 μm to about 800 μm.

In general, the encapsulating material may be present in amounts of about 1% to about 50% by weight of the dusting composition. The encapsulating material may include a high molecular weight polymer. The high molecular weight polymer may be selected from acrylic polymers and copolymers, carboxyvinyl polymer, polyamides, polystyrene, polyvinyl acetate, polyvinyl acetate phthalate, polyvinyl pyrrolidone, and combinations thereof. The high molecular weight polymer may have a molecular weight of at least about 300,000. Further detail regarding suitable encapsulating materials and methods of encapsulating is provided in the section entitled “Dusting Composition Release Management.”

In instances where the dusting component includes a liquid, such as a flavor, oil or other active, the liquid may first be adsorbed or absorbed onto a particulate carrier. The carrier may be another particulate dusting component, such as a sweetener, particulates, starches, actives or functional agents. A combination of dusting components may be used and incorporated into the dusting compositions. Adsorption or absorption of various liquids onto the particulates may be performed by various methods, including spray drying, spray congealing, extrusion, coating, drying and other similar methods.

Dusting Compositions

Numerous different ingredients can be used as the dusting component, such as sweeteners, flavors, starches, sensates, taste potentiators, breath freshening ingredients, dental care ingredients, active ingredients, effervescing system ingredients, appetite suppressor ingredients, mouth moistening ingredients, lubricants, coloring agents, food acid ingredients, micronutrients, throat care ingredients, nutraceuticals, phytochemicals, bioeffecting agents (such as vitamins and drugs), gum tahla, gum base, bitterness inhibitor, an anti-caking agent or flow agent, an elastomer, resin, fats and oils, waxes, softeners, inorganic fillers, and combinations thereof. A further description of suitable dusting components is provided in U.S. Pat. Nos. 4,976,972; 4,988,518; 5,145,696; 6,612,070; 6,472,000; and 6,949,264, the contents of which are incorporated herein by reference, and mixtures thereof, may be used.

Further exemplary, non-exhaustive description of various dusting components is provided below. Any of these components may be used in their encapsulated and/or unencapsulated form to provide dusting compositions.

Flavors

In some embodiments, the dusting component may include flavorants, which may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors whose release profiles can be managed include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

In some embodiments, other flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. These may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, .e., melonal (melon), 2,6-dimethyloctanal (green fruit), and 2-dodecenal (citrus, mandarin), cherry, grape, blueberry, blackberry, strawberry shortcake, and mixtures thereof.

In some embodiments, a flavoring agent may be employed in either liquid form and/or dried form. When employed in the latter form, suitable drying means such as spray drying the liquid may be used. Alternatively, the flavoring agent may be absorbed onto water soluble materials, such as cellulose, starch, sugar, maltodextrin, gum arabic and so forth or may be encapsulated. In still other embodiments, the flavoring agent may be adsorbed onto silicas, zeolites, and the like.

In some embodiments, the flavoring agents may be used in many distinct physical forms. Without being limited thereto, such physical forms include free forms, such as spray dried, powdered, beaded forms, encapsulated forms, and mixtures thereof.

Illustrations of the encapsulation of flavors as well as other additional components can be found in the examples provided herein. Typically, encapsulation of a component will result in a delay in the release of the predominant amount of the component during consumption of a chewing gum composition that includes the encapsulated component (e.g., as part of a delivery system added as a dusting component to the chewing gum composition). In some embodiments, the release profile of the dusting component (e.g., the flavor, sweetener, etc.) can be managed by managing various characteristics of the dusting component, delivery system containing the dusting component, and/or the chewing gum composition containing the delivery system and/or how the delivery system is made. For example, characteristics might include one or more of the following: tensile strength of the delivery system, water solubility of the dusting component, water solubility of the encapsulating material, water solubility of the delivery system, ratio of dusting component to encapsulating material in the delivery system, average or maximum particle size of dusting component, average or maximum particle size of ground delivery system, the amount of the dusting component or the delivery system in the chewing gum composition, ratio of different polymers used to encapsulate one or more dusting component, hydrophobicity of one or more polymers used to encapsulate one or more dusting component, hydrophobicity of the delivery system, the type or amount of coating on the delivery system, the type or amount of coating on a dusting component prior to the dusting component being encapsulated, etc.

Flavors may be present in an amount of about 0.1% to about 15% by weight of the delivery system. In particular, flavors may be present in an amount of about 0.1% to about 15% by weight of a chewing gum composition, a center-fill chewing gum composition or a chewing gum tablet.

Sweetening Ingredients

In some embodiments, the dusting component may include high-intensity sweeteners known to the skilled artisan. Without being limited to particular sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erytlhritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6, 1′,6′-tetradeoxygalacto-sucrose; and 4,6,1′,6′-tetradeoxy-sucrose, and mixtures thereof;

(e) protein based sweeteners such as thaumatococcus danielli (Thaumatin I and II) and talin;

(f) the sweetener monatin (2-hydroxy-2-(indol-3-ylmethyl)-4-aminoglutaric acid) and its derivatives; and

(g) the sweetener Lo han guo (sometimes also referred to as “Lo han kuo” or “Lo han quo”).

In some embodiments, hydrophobic sweeteners such as those disclosed in U.S. Pat. No. 7,025,999, which disclosure is incorporated herein by reference, and mixtures thereof, may be used. For example, such hydrophobic sweeteners include those of the formulae I-XI as set forth below: 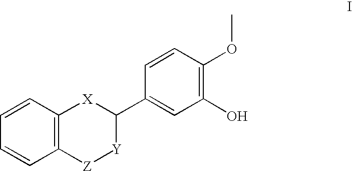
wherein X, Y and Z are selected from the group consisting of CH₂, O and S; 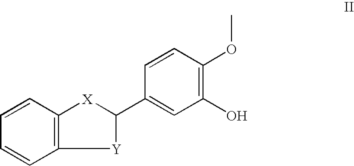
wherein X and Y are selected from the group consisting of S and O; 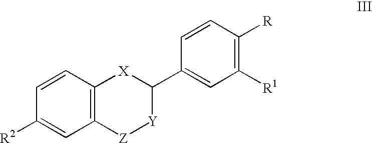
wherein X is S or O; Y is O or CH₂; Z is CH₂, SO₂ or S; R is OCH₃, OH or H; R¹ is SH or OH and R² is H or OH; 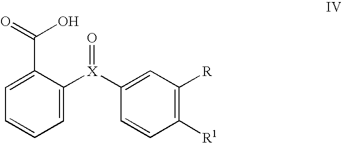
wherein X is C or S; R is OH or H and R¹ is OCH₃ or OH; 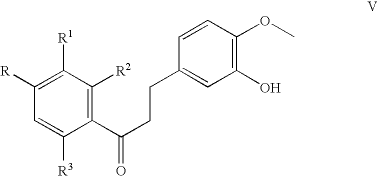
wherein R, R² and R³ are OH or H and R¹ is H or COOH; 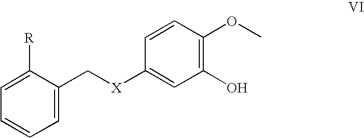
wherein X is O or CH₂ and R is COOH or H; 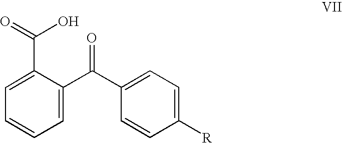
wherein R is CH₃CH₂, OH, N (CH3)₂ or Cl;

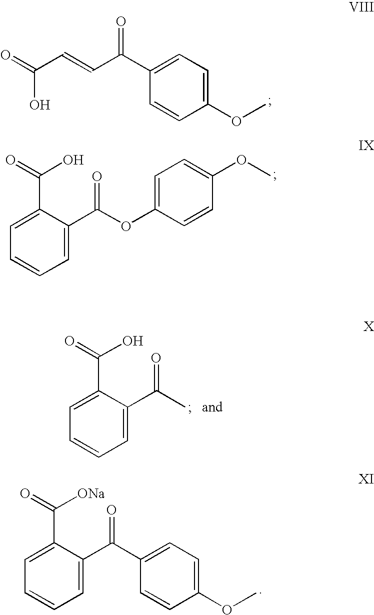

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K).

In some embodiments, the sweetener may be a polyol. Polyols can include, but are not limited to glycerol, sorbitol, maltitol, maltitol syrup, mannitol, isomalt, erythritol, xylitol, hydrogenated starch hydrolysates, polyglycitol syrups, polyglycitol powders, lactitol, and combinations thereof.

The active component (e.g., sweetener), which is part of the delivery system, may be used in amounts necessary to impart the desired effect associated with use of the active component (e.g., sweetness). In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art. For example, a sweetening agent maybe present in an amount of about 0.01% to about 90% by weight of a chewing gum composition, center-fill chewing gum composition or chewing gum tablet.

Sensate Ingredients

In some embodiments, the dusting component may include sensate ingredients, which may include those sensate compounds known to the skilled artisan. Sensate compounds may include cooling agents, warming agents, tingling agents, effervescent agents, and combinations thereof. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 341-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds can include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation can be provided. One such tingling sensation is provided by adding jambu, oleoresin, or spilanthol to some examples. In some embodiments, alkylamides extracted from materials such as jambu or sanshool can be included. Additionally, in some embodiments, a sensation is created due to effervescence. Such effervescence is created by combining an alkaline material with an acidic material. In some embodiments, an alkaline material can include alkali metal carbonates, alkali metal bicarbonates, alkaline earth metal carbonates, alkaline earth metal bicarbonates and mixtures thereof. In some embodiments, an acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes.

Sensate components may also be referred to as “trigeminal stimulants” such as those disclosed in U.S. Patent Application No. 205/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, methyl succinate, menthone glycerol ketals, bulk sweeteners such as xylitol, erythritol, dextrose, and sorbitol, and combinations thereof. Trigeminal stimulants can also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof.

Breath Freshening Ingredients

Breath fresheners can include essential oils as well as various aldehydes, alcohols, and similar materials. In some embodiments, essential oils can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, and orange. In some embodiments, aldehydes such as cinnamic aldehyde and salicylaldehyde can be used. Additionally, chemicals such as menthol, carvone, iso-garrigol, and anethole can function as breath fresheners. Of these, the most commonly employed are oils of peppermint, spearmint and chlorophyll.

In addition to essential oils and chemicals derived from them, in some embodiments breath fresheners can include but are not limited to zinc citrate, zinc acetate, zinc fluoride, zinc ammonium sulfate, zinc bromide, zinc iodide, zinc chloride, zinc nitrate, zinc flurosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based materials, carbon-based materials, enzymes such as laccase, and combinations thereof In some embodiments, the release profiles of probiotics can be managed for a gum including, but not limited to lactic acid producing microorganisms such as Bacillus coagulans, Bacillus subtilis, Bacillus laterosporus, Bacillus laevolacticus, Sporolactobacillus inulinus, Lactobacillus acidophilus, Lactobacillus curvatus, Lactobacillus plantarum, Lactobacillus jenseni, Lactobacillus casei, Lactobacillus fermentum, Lactococcus lactis, Pedioccocus acidilacti, Pedioccocus pentosaceus. Pedioccocus urinae, Leuconostoc mesenteroides, Bacillus coagulans, Bacillus subtilis, Bacillus laterosporus, Bacillus laevolacticus, Sporolactobacillus inulinus and mixtures thereof Breath fresheners are also known by the following trade names: Retsyn,™ Actizol,™ and Nutrazin.™ Examples of malodor-controlling compositions are also included in U.S. Pat. No. 5,300,305 to Stapler et al. and in U.S. Patent Application Publication Nos. 2003/0215417 and 2004/0081713 which are incorporated in their entirety herein by reference for all purposes.

Dental Care Ingredients

In some embodiments, the dusting component may include dental care ingredients, which may include those dental care ingredients known to the skilled artisan. Dental care ingredients (also known as oral care ingredients) may include but are not limited to tooth whiteners, stain removers, oral cleaning, bleaching agents, desensitizing agents, dental remineralization agents, antibacterial agents, anticaries agents, plaque acid buffering agents, surfactants and anticalculus agents. Non-limiting examples of such ingredients can include, hydrolytic agents including proteolytic enzymes, abrasives such as hydrated silica, calcium carbonate, sodium bicarbonate and alumina, other active stain-removing components such as surface-active agents, including, but not limited to anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. In some embodiments, dental care ingredients can also include tetrasodium pyrophosphate and sodium tri-polyphosphate, sodium bicarbonate, sodium acid pyrophosphate, sodium tripolyphosphate, xylitol, sodium hexametaphosphate.

In some embodiments, peroxides such as carbamide peroxide, calcium peroxide, magnesium peroxide, sodium peroxide, hydrogen peroxide, and peroxydiphospate are included. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Further examples can include surfactants such as sodium stearate, sodium ricinoleate, and sodium lauryl sulfate surfactants for use in some embodiments to achieve increased prophylactic action and to render the dental care ingredients more cosmetically acceptable. Surfactants can preferably be detersive materials which impart to the composition detersive and foaming properties. Suitable examples of surfactants are water-soluble salts of higher fatty acid monoglyceride monosulfates, such as the sodium salt of the monosulfated monoglyceride of hydgrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolamine salts of N-lauroyl, N-myristoyl, or N-palmitoyl sarcosine.

In addition to surfactants, dental care ingredients can include antibacterial agents such as, but not limited to, triclosan, chlorhexidine, zinc citrate, silver nitrate, copper, limonene, and cetyl pyridinium chloride. In some embodiments, additional anticaries agents can include fluoride ions or fluorine-providing components such as inorganic fluoride salts. In some embodiments, soluble alkali metal salts, for example, sodium fluoride, potassium fluoride, sodium fluorosilicate, ammonium fluorosilicate, sodium monofluorophosphate, as well as tin fluorides, such as stannous fluoride and stannous chloride can be included. In some embodiments, a fluorine-containing compound having a beneficial effect on the care and hygiene of the oral cavity, e.g., diminution of enamel solubility in acid and protection of the teeth against decay may also be included as an ingredient. Examples thereof include sodium fluoride, stannous fluoride, potassium fluoride, potassium stannous fluoride (SnF.sub.2-KF), sodium hexafluorostannate, stannous chlorofluoride, sodium fluorozirconate, and sodium monofluorophosphate. In some embodiments, urea is included.

Further examples are included in the following U.S. patents and U.S. published patent applications, the contents of all of which are incorporated in their entirety herein by reference for all purposes: U.S. Pat. No. 5,227,154 to Reynolds, U.S. Pat. No. 5,378,131 to Greenberg, U.S. Pat. No. 6,846,500 to Luo et al., U.S. Pat. No. 6,733,818 to Luo et al., U.S. Pat. No. 6,696,044 to Luo et al., U.S. Pat. No. 6,685,916 to Holme et al., U.S. Pat. No. 6,485,739 to Luo et al., U.S. Pat. No. 6,479,071 to Holme et al., U.S. Pat. No. 6,471,945 to Luo et al., U.S. Patent Publication Nos. 20050025721 to Holme et al., 2005008732 to Gebreselassie et al., and 20040136928 to Holme et al.

Functional Agents

The dusting component may include functional agents, which may include those functional agents known to the skilled artisan. Functional agents generally refer to those ingredients that are included in a delivery system and/or chewing gum composition for the desired end benefit they provide to the user. In some embodiments, functional agents can include medicaments, nutrients, nutraceuticals, herbals, nutritional supplements, pharmaceuticals, drugs, and the like and combinations thereof.

Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra™, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of functional ingredients contemplated for use in the present invention can include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Analgesics include opiates and opiate derivatives, such as Oxycontin™, ibuprofen, aspirin, acetaminophen, and combinations thereof that may optionally include caffeine.

Other drug active ingredients for use in embodiments can include anti-diarrheals such as Immodium™ AD, anti-histamines, anti-tussives, decongestants, vitamins, and breath fresheners. Also contemplated for use herein are anxiolytics such as Xanax™; anti-psychotics such as Clozaril™ and Haldol™; non-steroidal anti-inflammatories (NSAID's) such as ibuprofen, naproxen sodium, Voltaren™ and Lodine™, anti-histamines such as Claritin™, Hismanal™, Relafen™, and Tavist™; anti-emetics such as Kytril™ and Cesamet™; bronchodilators such as Bentolin™, Proventil™; anti-depressants such as Prozac™, Zoloft™, and Paxil™; anti-migraines such as Imigra™, ACE-inhibitors such as Vasotec™, Capoten™ and Zestril™; anti-Alzheimer's agents, such as Nicergoline™; and CaH-antagonists such as Procardia™, Adalat™, and Calan™.

The popular H2-antagonists which are contemplated for use in the present invention include cimetidine, ranitidine hydrochloride, famotidine, nizatidien, ebrotidine, mifentidine, roxatidine, pisatidine and aceroxatidine.

Active antacid ingredients can include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

A variety of nutritional supplements may also be used as functional agents including virtually any vitamin or mineral. For example, vitamin A, vitamin C, vitamin D, vitamin E, vitamin K, vitamin B₆, vitamin B₁₂, thiamine, riboflavin, biotin, folic acid, niacin, pantothenic acid, sodium, potassium, calcium, magnesium, phosphorus, sulfur, chlorine, iron, copper, iodine, zinc, selenium, manganese, choline, chromium, molybdenum, fluorine, cobalt and combinations thereof, may be used.

Examples of nutritional supplements that can be used as functional agents are set forth in U.S. Patent Application Publication Nos. 2003/0157213 A1, 2003/0206993 and 2003/0099741 A1 which are incorporated in their entirety herein by reference for all purposes.

Various herbals may also be used as functional agents such as those with various medicinal or dietary supplement properties. Herbals are generally aromatic plants or plant parts and or extracts thereof that can be used medicinally or for flavoring. Suitable herbals can be used singly or in various mixtures. Active ingredients derived from herbal or botanical sources are sometimes referred to as phytochemicals. Classes of phytochemicals include, but are not limited to, polyphenols, flavonoids, flavanols, flavonols, flavanones, isoflavanones, anthocyanins, catechins, and flavonones. Commonly used herbs include Echinacea, Goldenseal, Calendula, Rosemary, Thyme, Kava Kava, Aloe, Blood Root, Grapefruit Seed Extract, Black Cohosh, Ginseng, Guarana, Cranberry, Gingko Biloba, St. John's Wort, Evening Primrose Oil, Yohimbe Bark, Green Tea, Ma Huang, Maca, Bilberry, Lutein, and combinations thereof.

Effervescing System Ingredients

In some embodiments, the dusting component may include effervescencing system ingredients, which may include any effervescent system known to the skilled artisan. An effervescent system may include one or more edible acids and one or more edible alkaline materials. The edible acid(s) and the edible alkaline material(s) may react together to generate effervescence.

In some embodiments, the alkaline material(s) may be selected from, but is not limited to, alkali metal carbonates, alkali metal bicarbonates, alkaline earth metal carbonates, alkaline earth metal bicarbonates, and combinations thereof. The edible acid(s) may be selected from, but is not limited to, citric acid, phosphoric acid, tartaric acid, malic acid, ascorbic acid, and combinations thereof. In some embodiments, an effervescing system may include one or more other ingredients such as, for example, carbon dioxide, oral care ingredients, flavorants, etc.

For examples of use of an effervescing system in a chewing gum, refer to U.S. Provisional Patent No. 60/618,222 filed Oct. 13, 2004, and entitled “Effervescent Pressed Gum Tablet Compositions,” the contents of which are incorporated herein by reference for all purposes. Other examples can be found in U.S. Pat. No. 6,235,318, the contents of which are incorporated herein by reference for all purposes.

Appetite Suppressor Ingredients

In some embodiments, the dusting component may include appetite suppressors, which may include appetite suppressors known to the skilled artisan. Appetite suppressors can be ingredients such as fiber and protein that finction to depress the desire to consume food. Appetite suppressors can also include benzphetamine, diethylpropion, mazindol, phendimetrazine, phentermine, hoodia (P57), Olibra,™ ephedra, caffeine and combinations thereof. Appetite suppressors are also known by the following trade names: Adipex,™ Adipost,™ Bontril™ PDM, Bontril™ Slow Release, Didrex,™ Fastin,™ Ionamin,™ Mazanor,™ Melfiat,™ Obenix,™ Phendiet,™ Phendiet-105,™ Phentercot,™ Phentride,™ Plegine,™ Prelu-2,™ Pro-Fast,™ PT 105,™ Sanorex,™ Tenuate,™ Sanorex,™ Tenuate,™ Tenuate Dospan,™ Tepanil Ten-Tab,™ Teramine,™ and Zantryl.™ These and other suitable appetite suppressors are further described in the following U.S. patents, all of which are incorporated in their entirety by reference hereto: U.S. Pat. No. 6,838,431 to Portman, U.S. Pat. No. 6,716,815 to Portman, U.S. Pat. No. 6,558,690 to Portman, U.S. Pat. No. 6,468,962 to Portman, U.S. Pat. No. 6,436,899 to Portman.

Potentiator Ingredients

In some embodiments, the dusting component may include potentiators, which may include those potentiators known to the skilled artisan. Potentiators can consist of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof can be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

Lubricants

In some embodiments, the dusting component may include lubricants, which may include those lubricants known to the skilled artisan. Examples of suitable food-grade lubricants include: metallic stearates; fatty acids; hydrogenated vegetable oil; partially hydrogenated vegetable oils; animal fats; polyethylene glycols; polyoxyethylene monostearate; talc; silicon dioxide; and combinations thereof.

Coloring Agents

In some embodiments, the dusting component may include coloring agents, which may include those coloring agents known to the skilled artisan. Coloring agents may be used in amounts effective to produce the desired color. The coloring agents may include pigments which may be incorporated in amounts up to about 6%, by weight of the gum composition. For example, titanium dioxide may be incorporated in amounts up to about 2%, and preferably less than about 1%, by weight of the gum composition. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No.2, which is the disodium salt of 5,5-indigotindisulfonic acid. Similarly, the dye known as F.D.& C. Green No.1 comprises a triphenylmethane dye and is the monosodium salt of 4-[4-(N-ethyl-p-sulfoniumbenzylamino) diphenylmethylene]-[1 -(N-ethyl -N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

Food Acid Ingredients

In some embodiments, the dusting component may include food acid ingredients, which may include those food acids known to the skilled artisan. Acids can include, but are not limited to acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof.

Micronutrient Ingredients

In some embodiments, the dusting component may include micronutrients, which may include those micronutrients known to the skilled artisan. Micronutrients can include materials that have an impact on the nutritional well being of an organism even though the quantity required by the organism to have the desired effect is small relative to macronutrients such as protein, carbohydrate, and fat. Micronutrients can include, but are not limited to vitamins, minerals, enzymes, phytochemicals, antioxidants, and combinations thereof.

In some embodiments, vitamins can include fat soluble vitamins such as vitamin A, vitamin D, vitamin E, and vitamin K and combinations thereof In some embodiments, vitamins can include water soluble vitamins such as vitamin C (ascorbic acid), the B vitamins (thiamine or B₁, riboflavin or B₂, niacin or B₃, pyridoxine or B₆, folic acid or B₉, cyanocobalimin or B₁₂, pantothenic acid, biotin), and combinations thereof.

In some embodiments minerals can include but are not limited to sodium, magnesium, chromium, iodine, iron, manganese, calcium, copper, fluoride, potassium, phosphorous, molybdenum, selenium, zinc, and combinations thereof.

In some embodiments micronutrients can include but are not limited to L-carnitine, choline, coenzyme Q10, alpha-lipoic acid, omega-3-fatty acids, pepsin, phytase, trpsin, lipases, proteases, cellulases, and combinations thereof.

Antioxidants can include materials that scavenge free radicals. In some embodiments, antioxidants can include but are not limited to ascorbic acid, citric acid, rosemary oil, vitamin A, vitamin E, vitamin B phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and combinations thereof

In some embodiments phytochemicals can include but are not limited to cartotenoids, chlorophyll, chlorophyllin, fiber, flavanoids, anthocyanins, cyaniding, delphinidin, malvidin, pelargonidin, peonidin, petunidin, flavanols, catechin, epicatechin, epigallocatechin, epigallocatechingallate, theaflavins, thearubigins, proanthocyanins, flavonols, quercetin, kaempferol, myricetin, isorhamnetin, flavononeshesperetin, naringenin, eriodictyol, tangeretin, flavones, apigenin, luteolin, lignans, phytoestrogens, resveratrol, isoflavones, daidzein, genistein, glycitein, soy isoflavones, and combinations thereof.

Mouth Moistening Ingredients

In some embodiments, the dusting component may include mouth moistening ingredients, which may include those mouth moisteners known to the skilled artisan. Mouth moisteners can include, but are not limited to, saliva stimulators such as acids and salts and combinations thereof In some embodiments, acids can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof.

Mouth moisteners can also include hydrocolloid materials that hydrate and may adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. In some embodiments, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations can be included. In some embodiments, modified celluloses can be included such as microcrystalline cellulose, carboxymethlcellulose (CMC), methylcellulose (MC), hydroxypropylmethylcellulose (HPCM), and hydroxypropylcellulose (MPC), and combinations thereof.

Similarly, humectants which can provide a perception of mouth hydration can be included. Such humectants can include, but are not limited to glycerol, sorbitol, polyethylene glycol, erythritol, and xylitol. Additionally, in some embodiments, fats can provide a perception of mouth moistening. Such fats can include medium chain triglycerides, vegetable oils, fish oils, mineral oils, and combinations thereof.

Throat Care Ingredients

In some embodiments, the dusting component may include throat care ingredients, which may include those throat care ingredients know to the skilled artisan. Throat soothing ingredients can include analgesics, anesthetics, demulcents, antiseptic, and combinations thereof. In some embodiments, analgesics/anesthetics can include menthol, phenol, hexylresorcinol, benzocaine, dyclonine hydrochloride, benzyl alcohol, salicyl alcohol, and combinations thereof. In some embodiments, demulcents can include but are not limited to slippery elm bark, pectin, gelatin, and combinations thereof. In some embodiments, antiseptic ingredients can include cetylpyridinium chloride, domiphen bromide, dequalinium chloride, and combinations thereof.

In some embodiments, antitussive ingredients such as chlophedianol hydrochloride, codeine, codeine phosphate, codeine sulfate, dextromethorphan, dextromethorphan hydrobromide, diphenhydramine citrate, and diphenhydramine hydrochloride, and combinations thereof can be included.

In some embodiments, throat soothing agents such as honey, propolis, aloe vera, glycerine, menthol and combinations thereof can be included. In still other embodiments, cough suppressants can be included. Such cough suppressants can fall into two groups: those that alter the consistency or production of phlegm such as mucolytics and expectorants; and those that suppress the coughing reflex such as codeine (narcotic cough suppressants), antihistamines, dextromethorphan and isoproterenol (non-narcotic cough suppressants). In some embodiments, ingredients from either or both groups can be included.

In still other embodiments, antitussives can include, but are not limited to, the group consisting of codeine, dextromethorphan, dextrorphan, diphenhydramine, hydrocodone, noscapine, oxycodone, pentoxyverine and combinations thereof. In some embodiments, antihistamines can include, but are not limited to, acrivastine, azatadine, brompheniramine, chlorpheniramine, clemastine, cyproheptadine, dexbrompheniramine, dimenhydrinate, diphenhydramine, doxylamine, hydroxyzine, meclizine, phenindamine, phenyltoloxamine, promethazine, pyrilamine, tripelennamine, triprolidine and combinations thereof. In some embodiments, non-sedating antihistamines can include, but are not limited to, astemizole, cetirizine, ebastine, fexofenadine, loratidine, terfenadine, and combinations thereof.

In some embodiments, expectorants can include, but are not limited to, ammonium chloride, guaifenesin, ipecac fluid extract, potassium iodide and combinations thereof. In some embodiments, mucolytics can include, but are not limited to, acetylcycsteine, ambroxol, bromhexine and combinations thereof. In some embodiments, analgesic, antipyretic and anti-inflammatory agents can include, but are not limited to, acetaminophen, aspirin, diclofenac, diflunisal, etodolac, fenoprofen, flurbiprofen, ibuprofen, ketoprofen, ketorolac, nabumetone, naproxen, piroxicam, caffeine and mixtures thereof In some embodiments, local anesthetics can include, but are not limited to, lidocaine, benzocaine, phenol, dyclonine, benzonotate and mixtures thereof.

In some embodiments nasal decongestants and ingredients that provide the perception of nasal clearing can be included. In some embodiments, nasal decongestants can include but are not limited to phenylpropanolamine, pseudoephedrine, ephedrine, phenylephrine, oxymetazoline, and combinations thereof In some embodiments ingredients that provide a perception of nasal clearing can include but are not limited to menthol, camphor, borneol, ephedrine, eucalyptus oil, peppermint oil, methyl salicylate, bornyl acetate, lavender oil, wasabi extracts, horseradish extracts, and combinations thereof. In some embodiments, a perception of nasal clearing can be provided by odoriferous essential oils, extracts from woods, gums, flowers and other botanicals, resins, animal secretions, and synthetic aromatic materials.

Dusting Composition Release Management

In different embodiments, different techniques, dusting components, and/or delivery systems, i.e., dusting compositions or chewing gum compositions, may be used to manage release of one or more dusting components in a chewing gum composition. In some embodiments, more than one of the techniques, dusting components, and/or delivery systems may be used.

In some embodiments, the delay in availability or other release of a dusting component in an edible composition caused by encapsulation of the dusting component may be based, in whole or in part, by one or more of the following: the type of encapsulating material, the molecular weight of the encapsulating material, the tensile strength of the delivery system containing the dusting component, the hydrophobicity of the encapsulating material, the particle size of the dusting component, the particle size of the delivery system, the presence of other materials in the edible composition (e.g., tensile strength modifying agents, emulsifiers), the ratio of the amounts of one or more dusting components in the delivery system to the amount of the encapsulating material in the delivery system, the order and/or amount of addition of one or more dusting components during mixing of the delivery system or edible composition, the number of layers of encapsulating material, the desired texture, flavor, shelf life, or other characteristic of edible composition, the ratio of the encapsulating material to the dusting component being encapsulated, etc. Thus, by changing or managing one or more of these release characteristics of a delivery system or the edible composition, or the manufacturing method used to create the delivery system or the edible composition, release of one or more dusting components in an edible composition during consumption of the edible composition can be managed more effectively and/or a more desirable release profile for one or more dusting components in the delivery system may be obtained. This may lead to a more positive sensory or consumer experience during consumption of the product, more effective release of such one or more dusting components during consumption of the product, less need for the dusting component (e.g., more effective release of the dusting component may allow the amount of the dusting component in the edible composition to be reduced), increased delivery of a therapeutic or other functional benefit to the consumer, etc. Additionally, in some embodiments, managing the release rate or profile can be tailored to specific consumer segments.

In some embodiments, a method for managing release profile or one or more dusting components in a delivery system or in an edible composition containing the delivery system, may include measuring, estimating, or otherwise determining a partial or complete release profile for the one or more dusting components during consumption of delivery system or edible composition. Such a release profile may show one or more points of interest (e.g., flavor intensity, active availability, taste) over a period of time and/or at distinct points in time during consumption of a delivery system or an edible composition that includes the delivery system. Such a release profile may be obtained from a descriptive panel analysis, deduced or otherwise determined from an analytical chemistry analysis, and/or from other techniques known in the art. One example of a descriptive analysis technique is the Quantitative Descriptive Analysis (QDA™) method developed by Tragon Corp. (as described in SENSORY EVALUATION TECHNIQUES, 3^{RD} ED., MORTON MEILGAARD, GAIL CIVILLE, B. THOMAS CARR, EDS., CRC Press (1999), pp. 167-68). Another descriptive analysis technique is the Spectrum™ Descriptive Analysis Method developed by Civille (see SENSORY EVALUATION TECHNIQUES, 3^{RD} ED., pp. 168, 173-76.

In some embodiments, if it is desired to delay or sustain the release of at least a portion of one or more dusting components encapsulated in a delivery system as part of an edible composition, one or more of the following actions may be taken:

1. the tensile strength of the delivery system may be increased (e.g., by using a different encapsulating material that provides a higher tensile strength to the delivery system);

2. an encapsulating material having a higher molecular weight than the encapsulating material in the delivery system can be substituted for some or all of the encapsulated material in the delivery system;

3. an encapsulating material having a higher hydrophobicity than the encapsulating material in the delivery system can be substituted for some or all of the encapsulated material in the delivery system;

4. the ratio of components in the encapsulating material may be modified to increase the hydrophobicity of the encapsulating material;

5. the ratio of the amount of encapsulating material in the delivery system to the amount of the one or more dusting components in the delivery system may be increased;

6. a different delivery system that includes the same one or more dusting components as the original delivery system in the edible composition and has a higher hydrophobicity and/or tensile strength than the original delivery system may be substituted for some or all of the original delivery system;

7. a different delivery system that includes the same one or more dusting components as the original delivery system in the edible composition and has a higher hydrophobicity and/or tensile strength than the original delivery system may be added to the edible composition;

8. the particle size of the delivery system in the edible composition may be increased (e.g., from 250 microns to 420 or 710 microns);

9. the amount of tensile strength modifying agents in the delivery system or in the edible composition that reduce the tensile strength of the delivery system may be decreased;

10. the amount of a dusting component in the edible composition, but not the delivery system, may be decreased if the dusting component reacts or mixes with the delivery system or one of its components in an adverse manner or otherwise causes one of the components to release too early or too early;

11. another dusting component may be added to the edible composition that may cause additional release or availability of the one or more dusting components (this may be particularly beneficial when free amounts of the one or more dusting components are present in the edible composition, but do not release from the edible composition);

12. another dusting component may be added to the edible composition that may reduce or otherwise impact capture of the one or more dusting components in some other component (e.g., a chewing gum base) of the edible composition (e.g., a chewing gum), thereby increasing the amount of the one or more dusting components delivered or available to the consumer (this may be particularly beneficial when free amounts of the one or more dusting components are present in the edible composition, but do not release from the edible composition (e.g., they get trapped in the gum base of a chewing gum composition));

13. the edible composition can be manipulated to increase the mechanical pressure needed to chew the composition;

14. the delivery system can be more intimately mixed with the remaining dusting components in the edible composition;

15. the delivery system can be situated in the edible composition such that more time and/or effort are required to reach the delivery system during consumption (e.g., the delivery system can be located in an inner layer of a multilayer edible composition);

16. the delivery system may be encapsulated again in the same or a different encapsulating material;

17. a fixative can be added to the delivery system or to an edible composition that contains the delivery system, the fixative acting to change the vapor pressure or other characteristic of the dusting component so as to delay its release or otherwise extend its availability during consumption;

18. the delivery system can be partially or completed coated or treated with another material; and/or;

19. the one or more dusting components in the delivery system may be coated or otherwise pre-treated prior to encapsulation to increase the tensile strength and/or hydrophobicity of the delivery system, decrease the miscibility of the one or more dusting components with the encapsulating material, or otherwise stabilize the one or more dusting components prior to, during, and/or after the encapsulation process.

If it is desired to hasten the release of at least a portion of the one or more dusting components in the delivery system that is itself a dusting component in the edible composition, in some embodiments, one or more of the following actions may be taken:

1. the tensile strength of the delivery system may be decreased (e.g., by using a different encapsulating material that provides a lower tensile strength to the delivery system, by adding tensile strength modifying agents to the delivery system);

2. an encapsulating material having a lower molecular weight than the encapsulating material in the delivery system can be substituted for some or all of the encapsulated material in the delivery system;

3. an encapsulating material having a lower hydrophobicity than the encapsulating material in the delivery system can be substituted for some or all of the encapsulated material in the delivery system;

4. the ratio of components in the encapsulating material may be modified to decrease the hydrophobicity of the encapsulating material;

5. the ratio of the amount of encapsulating material in the delivery system to the amount of the one or more dusting components in the delivery system may be decreased;

6. a different delivery system that includes the same one or more dusting components as the original delivery system in the edible composition and has a lower hydrophobicity and/or tensile strength than the original delivery system may be substituted for some or all of the original delivery system;

7. a different delivery system that includes the same one or more dusting components as the original delivery system in the edible composition and has a lower hydrophobicity and/or tensile strength than the original delivery system may be added to the edible composition;

8. the particle size of the dusting components in the delivery system may be decreased;

9. the particle size of the delivery system in the edible composition may be decreased;

10. the amount of tensile strength modifying agents in the delivery system or in the edible composition that reduce the tensile strength of the delivery system may be increased;

11. the amount of a dusting component in the edible composition, but not the delivery system, may be increased if the dusting component reacts or mixes with the delivery system or one of its components in a way that causes one or more components to release faster or earlier;

12. another dusting component may be partially or completely removed from the edible composition if such removal will cause additional release or availability of the one or more dusting components;

13. the edible composition can be manipulated to decrease the mechanical pressure needed to chew the composition;

14. the delivery system can be less intimately mixed with the edible composition;

15. the delivery system can be situated in the edible composition such that less time and/or effort are required to reach the delivery system during consumption (e.g., the delivery system can be located in an outer layer of a multilayer edible composition);

16. another dusting component may be added to the edible composition that may increase or otherwise impact capture of the one or more dusting components in some other component (e.g., a chewing gum base) of the edible composition (e.g., a chewing gum), thereby decreasing the amount of the one or more dusting components delivered or available to the consumer; and/or

17. the one or more dusting components in the delivery system may be coated or otherwise pre-treated prior to encapsulation to decrease the tensile strength and/or hydrophobicity of the delivery system, increase the miscibility of the one or more dusting components with the encapsulating material, or otherwise destabilize the one or more dusting components prior to, during, and/or after the encapsulation process.

In some embodiments, in addition to or as an alternative to implementing one or more of the above changes, if it is desired to modify the release profile of at least a portion of one or more dusting components encapsulated in a delivery system as part of an edible composition, one or more of the following actions may be taken:

1. the amount of delivery system in the edible composition may be increased (which may serve to increase the intensity and/or duration of availability of the one or more dusting components during consumption of the edible composition);

2. the amount of delivery system in the edible composition may be decreased (which may serve to decrease the intensity and/or duration of availability of the one or more dusting components during consumption of the edible composition);

3. the process for mixing or otherwise making the delivery system can be modified;

4. the process for mixing or otherwise making the edible composition can be modified;

5. the average or maximum particle size of the dusting components in the delivery system can be increased;

6. the average or maximum particle size of the dusting components in the delivery system can be decreased;

7. the average particle size of the delivery system may be increased and the distribution of the average particle size of the delivery system can be sharpened or narrowed;

8. the average particle size of the delivery system may be increased and the distribution of the average particle size of the delivery system can be widened or made more smooth;

9. the average particle size of the delivery system may be decreased and the distribution of the average particle size of the delivery system can be sharpened or narrowed; and/or

10. the average particle size of the delivery system may be decreased and the distribution of the average particle size of the delivery system can be widened or made more smooth.

By using one or more of these techniques, the release of the one or more dusting components may be hastened or delayed as desired and/or the release profile of the one or more dusting components may be directed or otherwise managed towards a desired release profile, or at least a more desirable release profile. By trying various combinations of these techniques, as desired, or at least more desirable, release profile can be obtained for the one or more dusting components in the edible composition. In some embodiments, obtaining such a desired release profile may include decreasing or increasing unencapsulated (i.e., free) amounts of the one or more dusting components in the edible composition and/or decreasing or increasing amounts of one or more additional delivery systems to the edible composition, wherein each of the delivery systems includes the one or more dusting components and is designed to release a predominant amount of the one or more dusting components at a desired time or during a desired time period following the start of consumption or other use of the edible composition. In some embodiments, the amount or location of a delivery system added to a mixing process for the delivery system or the edible composition, and/or the mixing time, also might be changed or experimented with to obtain a more desirable release profile for the one or more dusting components.

In some embodiments, changes to amounts of two or more dusting components may be made in accordance with preferred or required ratios or equations. For example, oral compositions may need to balance acceptable germ kill properties and desirable taste characteristics. Adding too much of one or more germ killing ingredients in the oral composition may create a bad taste for the oral composition that will be unacceptable to the consumer. However, if not enough of the germ killing ingredient(s) are present in the oral composition, the oral composition may not function adequately as a germ killer or antimicrobial product. Thus, a balance may be created between the amount of the germ killing ingredient(s) in the oral composition and the flavor ingredients in the oral composition. Further examples of this can be found in U.S. patent application Ser. No. 11/010,082, the entire contents of which are incorporated herein by reference for all purposes.

In some embodiments, mixing limitations, ingredient limitations, technical requirements or limitations, ingredient availability, preferences or requirements regarding taste, texture, shelf life, mixing or other processing limitations or requirements, thermal stability and/or miscibility characteristics of one or more ingredients and or encapsulating materials, consumption duration, or other characteristic of the edible composition, consumer preference or acceptance criteria, implementation cost, government regulations, health concerns, etc., may limit the applicability of one or more of the techniques described herein. For example, in some embodiments, merely adding more of an ingredient (e.g., menthol, germ killing agents) may produce a bitter or bad taste that may be unacceptable to a consumer or not allowed under government regulations.

In some embodiments, a method for modifying a release profile of a dusting component in a delivery system, the delivery system being included in an edible composition, may include determining a first release profile for the dusting component; determining a desired change in release profile for the dusting component based on the first release profile; and modifying tensile strength of the delivery system based on the desired change in release profile for the dusting component. In some embodiments, the delivery system may include an encapsulating material with the dusting component being encapsulated with the encapsulating material. In some embodiments, the method may include one or more of the following: modifying hydrophobicity of the encapsulating material based on the desired change in release profile; modifying components of the encapsulating material to obtain a desired hydrophobicity of the encapsulating material; modifying a ratio of the dusting component to the encapsulating material based on the desired change in release profile; modifying an amount of the delivery system in the edible composition based on the desired change in release profile; modifying an unencapsulated amount of the dusting component in the edible composition based on the desired change in release profile; modifying average particle size of the delivery system in the edible composition based on the desired change in release profile; modifying maximum particle size of the delivery system in the edible composition based on the desired change in release profile; modifying average particle size of the dusting component based on the desired change in release profile; modifying maximum particle size of the dusting component based on the desired change in release profile.

In some embodiments, a method of encapsulating a dusting component with an encapsulating material (or otherwise selecting the encapsulating material for the dusting component) may include determining a desired release profile for a dusting component in an edible composition; selecting an encapsulating material such that hydrophobicity of the encapsulating material and a tensile strength of a delivery system that will provide the desired release profile for the dusting component in the edible composition, wherein the delivery system includes the dusting component encapsulated with the encapsulating material; and encapsulating the dusting component with the encapsulating material.

In some embodiments, a method for modifying a release profile of a dusting component in a delivery system, the delivery system being included in an edible composition, may include determining a first release profile for the dusting component in the edible composition; determining a desired change in release profile for the dusting component based on the first release profile; and modifying at least one characteristic of the delivery system based on the desired change in release profile for the dusting component. In some embodiments, the characteristic of the delivery system may include one or more of the following: hydrophobicity of an encapsulating material used to encapsulate the dusting component; molecular weight of an encapsulating material used to encapsulate the dusting component; amount or other availability of a tensile strength modifying agent in the delivery system; amount of other availability of an emulsifier in the delivery system; ratio of an amount of the dusting component to an amount of an encapsulating material used to encapsulate the dusting component, average particle size of the delivery system; minimum or maximum particle size of the delivery system; average particle size of the dusting component; or minimum or maximum particle size of the dusting component.

In some embodiments, a method for modifying a release profile of a dusting component in a delivery system, the delivery system being included in an edible composition, may include determining an actual release profile for the dusting component in the edible composition; determining a desired change in release profile for the dusting component based on the actual release profile; and modifying at least one characteristic of the delivery system based on the desired change in release profile for the dusting component. In some embodiments, the delivery system may include the dusting component being encapsulated with an encapsulating material and modifying at least one characteristic of the delivery system may include one or more of the following: modifying tensile strength of the delivery system; modifying distribution of particle size of the delivery system; adding a fixative to the delivery system; modifying the encapsulating material to alter its hydrophobicity; modifying hydrophobicity of the encapsulating material; modifying a coating applied to the delivery system; modifying a coating applied to the dusting component before being encapsulated with the encapsulating material; modifying availability of a tensile strength modifying agent in the delivery system; modifying availability of an emulsifier in the delivery system; modifying availability of another dusting component in the delivery system; modifying ratio of the dusting component to the encapsulating material in the delivery system; modifying average particle size of the dusting component; modifying maximum particle size of the dusting component; modifying distribution of particle size of the delivery system; adding another layer of encapsulation to the delivery system; adding a hydrophilic coating to the delivery system; modifying minimum particle size of the delivery system; modifying average particle size of the delivery system; and modifying maximum particle size of the delivery system.

In some embodiments, a method for method for modifying a release profile of a dusting component in a delivery system, the delivery system being included in an edible composition, may include determining an actual release profile for the dusting component in the edible composition; determining a desired change in release profile for the dusting component based on the actual release profile; and modifying at least one characteristic of the edible composition based on the desired change in release profile for the dusting component.

In some embodiments, the delivery system may include the dusting component being encapsulated with an encapsulating material and modifying at least one characteristic of the edible composition may include one or more of the following: modifying tensile strength of the delivery system; modifying distribution of particle size of the delivery system; adding a fixative to the delivery system; modifying the encapsulating material to alter its hydrophobicity; modifying hydrophobicity of the encapsulating material; modifying availability of an emulsifier in the edible composition; modifying a coating applied to the delivery system; modifying a coating applied to the dusting component before being encapsulated with the encapsulating material; modifying availability of an unencapsulated amount of the dusting component in the edible composition; modifying availability of another dusting component in the edible composition; modifying availability of a tensile strength modifying agent in the delivery system; modifying availability of an emulsifier in the delivery system; modifying availability of another dusting component in the delivery system; modifying ratio of the dusting component to the encapsulating material in the delivery system; modifying average particle size of the dusting component; modifying maximum particle size of the dusting component; modifying distribution of particle size of the delivery system; adding another layer of encapsulation to the delivery system; adding a hydrophilic coating to the delivery system; modifying minimum particle size of the delivery system; modifying average particle size of the delivery system; and modifying maximum particle size of the delivery system.

In some embodiments, a method for modifying a release profile of a dusting component encapsulated with an encapsulating material in a delivery system, the delivery system being included in an edible composition, may include determining a first release profile for the dusting component; determining a desired change in release profile for the dusting component based on the first release profile; and modifying hydrophobicity of the encapsulating material based on the desired change in release profile for the dusting component.

In some embodiments, a method for modifying a release profile of a dusting component encapsulated with an encapsulating material in a delivery system, the delivery system being included in an edible composition, may include determining a first release profile for the dusting component; determining a desired change in release profile for the dusting component based on the first release profile; and modifying the ratio of the dusting component to the encapsulating material in the delivery system based on the desired change in release profile for the dusting component.

In some embodiments, a method for modifying a release profile of a dusting component encapsulated with an encapsulating material in a delivery system, the delivery system being included in an edible composition, may include determining a first release profile for the dusting component; determining a desired change in release profile for the dusting component based on the first release profile; and modifying average particle size of the delivery system in the edible composition based on the desired change in release profile.

In some embodiments, a method for managing a release profile of a dusting component in a delivery system, the delivery system being included in an edible composition, may include selecting a desired release profile of the dusting component; and selecting a tensile strength of the delivery system based on the desired release profile.

In some embodiments, a method for managing a release profile of a dusting component in a delivery system, the delivery system including the dusting component encapsulated with an encapsulating material and being included in an edible composition, may include selecting a desired release profile of the dusting component; and selecting a hydrophobicity of the encapsulating material based on the desired release profile.

In some embodiments, a method for managing a release profile of a dusting component in a delivery system, the delivery system including the dusting component encapsulated with an encapsulating material and being included in an edible composition, may include selecting a desired release profile of the dusting component; and selecting a ratio of the dusting component to the encapsulating material in the delivery system based on the desired release profile for the dusting component.

In some embodiments, a method for managing a release profile of a dusting component in a delivery system, the delivery system including the dusting component encapsulated with an encapsulating material and being included in an edible composition, may include selecting a desired release profile of the dusting component; and selecting a minimum, maximum, and/or average particle size of the delivery system in the edible composition based on the desired release profile.

In some embodiments, a method for managing a release profile of a dusting component in a delivery system, the delivery system including the dusting component encapsulated with an encapsulating material and being included in an edible composition, may include selecting a desired release profile of the dusting component; and selecting a distribution in the particle size of the delivery system in the edible composition based on the desired release profile.

In some embodiments, a method for managing a release profile of a dusting component in a delivery system, the delivery system including the dusting component encapsulated with an encapsulating material and being included in an edible composition, may include two or more of the following: selecting a desired release profile of the dusting component; selecting a ratio of the dusting component to the encapsulating material based on the desired release profile; selecting a tensile strength for the delivery system in the edible composition based on the desired release profile; selecting a hydrophobicity for the encapsulating material based on the desired release profile; and selecting an average particle size of the delivery system in the edible composition based on the desired release profile.

In some embodiments, a method for managing a release profile of a dusting component in a delivery system, the delivery system including the dusting component encapsulated with an encapsulating material and being included in an edible composition, may include selecting a desired release profile of the dusting component; and selecting a coating for the delivery system based on the desired release profile.

In some embodiments, a method for managing a release profile of a dusting component in a delivery system, the delivery system including the dusting component encapsulated with an encapsulating material and being included in an edible composition, may include selecting a desired release profile of the dusting component; and selecting a coating for the dusting component based on the desired release profile.

In some embodiments, a method for managing a release profile of a dusting component in a delivery system, the delivery system including the dusting component encapsulated with an encapsulating material and being included in an edible composition, may include selecting at least one of the following: tensile strength of the delivery system; distribution of particle size of the delivery system; a fixative for the delivery system; hydrophobicity of the encapsulating material; availability of a tensile strength modifying agent in the delivery system; availability of an emulsifier in the delivery system; ratio of the dusting component to the encapsulating material in the delivery system; average particle size of the dusting component; maximum particle size of the dusting component; a coating for the dusting component; a coating for the delivery system; another layer of encapsulation to be added to the delivery system; a hydrophilic coating to be added to the delivery system; minimum particle size of the delivery system; average particle size of the delivery system; and maximum particle size of the delivery system; and then making the delivery system. In some embodiments, the method also may include making an edible composition that includes the delivery system.

Encapsulation

In some embodiments, one or more dusting components may be encapsulated with an encapsulating material. In general, partially or completely encapsulating a dusting component used in an edible composition with an encapsulating material may delay release of the dusting component during consumption of the edible composition, thereby delaying when the dusting component becomes available inside the consumer's mouth, throat, and/or stomach, available to react or mix with another dusting component, and/or available to provide some sensory experience and/or functional or therapeutic benefit. This can be particularly true when the dusting component is water soluble or at least partially water soluble.

In some embodiments, a material used to encapsulate a dusting component may include water insoluble polymers, co-polymers, or other materials capable of forming a strong matrix, solid coating, or film as a protective barrier with or for the dusting component. In some embodiments, the encapsulating material may completely surround, coat, cover, or enclose a dusting component. In other embodiments, the encapsulating material may only partially surround, coat, cover, or enclose a dusting component. Different encapsulating materials may provide different release rates or release profiles for the encapsulated dusting component. In some embodiments, encapsulating material used in a delivery system may include one or more of the following: polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof.

In some embodiments, a dusting component may be pre-treated prior to encapsulation with an encapsulating material. For example, a dusting component may be coated with a “coating material” that is not miscible with the dusting component or is at least less miscible with the dusting component relative to the dusting component's miscibility with the encapsulating material.

In some embodiments, an encapsulation material may be used to individually encapsulate different dusting components in the same edible composition. For example, a delivery system may include aspartame encapsulated by polyvinyl acetate. Another delivery system may include ace-k encapsulated by polyvinyl acetate. Both delivery systems may be used as dusting components in the same chewing gum or in other edible compositions. For addition examples, see U.S. patent application Ser. No. 11/134,367 entitled “A Delivery System for Active Components as Part of an Edible Composition” and filed May 23, 2005, the entire contents of which are incorporated herein by reference for all purposes.

In some embodiments, different encapsulation materials may be used to individually encapsulate different dusting components used in the same edible composition. For example, a delivery system may include aspartame encapsulated by polyvinyl acetate. Another delivery system may include ace-k encapsulated by EVA. Both delivery systems may be used as dusting components in the same chewing gum or other edible compositions. Examples of encapsulated ingredients using different encapsulating materials can be found in U.S. Patent Application Ser. No. 60/655,894 filed Feb. 25, 2005, and entitled “Process for Manufacturing a Delivery System for Active Components as Part of an Edible Composition,” the entire contents of which are incorporated herein by reference for all purposes.

Methods of Encapsulation

There are many ways to encapsulate one or more dusting components with an encapsulating material. For example, in some embodiments, a sigma blade or Banbury™ type mixer may be used. In other embodiments, an extruder or other type of continuous mixer may be used. In some embodiments, spray coating, spray chilling, absorption, adsorption, inclusion complexing (e.g., creating a flavor/cyclodextrin complex, forming a glassy matrix, etc.), coacervation, fluidized bed coating, or other process may be used to encapsulate a dusting component with an encapsulating material.

Examples of encapsulation of dusting components can be found in U.S. Patent Application Ser. No. 60/655,894, filed Feb. 25, 2005, and entitled “Process for Manufacturing a Delivery System for Active Components as Part of an Edible Composition,” the entire contents of which are incorporated herein by reference for all purposes. Other examples of encapsulation of dusting components can be found in U.S. Patent Application Ser. No. 10/955,255 filed Sep. 30, 2004, and entitled “Encapsulated Compositions and Methods of Preparation,” the entire contents of which are incorporated herein by reference for all purposes. Further examples of encapsulation of dusting components can be found in U.S. Patent Application Ser. No. 10/955,149 filed Sep. 30, 2004, and entitled “Thermally Stable High Tensile Strength Encapsulation Compositions for Actives,” the entire contents of which are incorporated herein by reference for all purposes. Still further examples of encapsulation of dusting components can be found in U.S. patent application Ser. No. 11/052,672 filed Feb. 7, 2005, and entitled “Stable Tooth Whitening Gum with Reactive Components,” the entire contents of which are incorporated herein by reference for all purposes. Further encapsulation techniques and resulting delivery systems may be found in U.S. Pat. Nos. 6,770,308, 6,759,066, 6,692,778, 6,592,912, 6,586,023, 6,555,145, 6,479,071, 6,472,000, 6,444,241, 6,365,209, 6,174,514, 5,693,334, 4,711,784, 4,816,265, and 4,384,004, the contents of all of which are incorporated herein by reference for all purposes.

In some embodiments, a delivery system may be ground to a particular size for use as a dusting component in an edible composition. For example, in some embodiments, a dusting component may be ground to 710, 420, or 250 microns. In some embodiments, the delivery system may be ground to an average particle size such as, for example, 710, 420, or 250 microns. In some embodiments, the delivery system may be ground to a maximum particle size such as, for example, 710, 420, or 250 microns. The ultimate particle size will depend on the characteristics of the delivery system and/or the edible composition and as such, other sizes are possible in other embodiments. For example, delivery systems and/or edible compositions with smooth, creamy textures require smaller particles sizes (below 125 microns). Also, in some embodiments, particles below a certain size (e.g., 125 microns) may be removed. In some embodiments, the particle size distribution can have a narrow range resulting in a sharp distribution. In some embodiments, the particle size distribution can have a wide range resulting in a smooth distribution.

Encapsulated Dusting by Spray Coating

A thermally stabilized active composition may also be prepared by coating the active by a spray coating method. This process provides an active which is at least partially encapsulated by a polymer such as polyvinyl acetate.

The coating layer which surrounds the active, may also include a solvent which should be capable of dissolving the polymer. The solvent may be any solvent known for this purpose. For example, if the polymer is polyvinyl acetate, suitable solvents include ethyl acetate, diethyl ether, acetone, benzene, ethylene dichloride, methanol, methyl ethyl ketone, ethanol, toluene, xylene, amyl acetate, and combinations thereof.

One or more coating layers may be present which include the encapsulating polymer and optionally may include the same or a different active. In some embodiments wherein more than one coating layer is present, the first coating layer may include a high tensile strength polymer with the optional addition of another active such as a sweetener. A second coating may completely or partially encapsulate the active particles and may include either a single polymer, a combination of different polymers, or a combination of one or more polymers and a sweetener such as sucralose.

Polymers which may be used in the coating layers include acrylic polymers and copolymers, carboxyvinyl polymer, polyamides, polystyrene, polyvinyl acetate, polyvinyl acetate phthalate, polyvinylpyrrolidone, and combinations thereof. One or more different polymers may be used in each of the coating layers. For example, polyvinyl acetate may be included in a first coating with a combination of polyvinyl acetate and another polymer in a subsequent exterior coating.

The encapsulated particles of some embodiments may be prepared by any suitable spray coating method as known in the art. One suitable process is the Wurster process. This process provides a method for encapsulating individual particulate materials. First the particles to be encapsulated are suspended in a fluidizing air stream which provides a generally cyclic flow in front of a spray nozzle. The spray nozzle sprays an atomized flow of the coating solution, which may include sucralose, a polymer and a suitable solvent.

The atomized coating solution collides with the particles as they are carried away from the nozzle to provide a particle coating with the coating solution. The temperature of the fluidizing air stream, which also serves to suspend the particles to be coated, may be adjusted to evaporate the solvent shortly after the coating solution contacts the particles. This serves to solidify the coating on the particles, resulting in the desired encapsulated particle.

This process may be repeated until the desired thickness of the coating is achieved. Alternatively, the process may be repeated with a different coating solution to provide different and distinct coating layers in the encapsulated particle composition.

Following the coating process, the particles may then be formed to an appropriate size as desired, generally from an average particle size range of about 50 μm to about 800 μm. This may be accomplished by any suitable means such as chopping, pulverizing, milling or grinding the particles.

Encapsulated Dusting Component by Extrusion

The active may also be extruded with a low to medium molecular weight polymer to achieve a thermally stabilized active composition. The polymer may be any of those described herein. The molecular weight of the polymer may be less than about 300,000, specifically from about 9,000 to about 200,000 and may be polyvinyl acetate.

In one method of preparing the extruded thermally stabilized active, the active is first combined with the polymer and melted. The combination of active and polymer may then be extruded, cooled and formed to the desired particle size. The particles may be sized by milling, grinding, pulverizing, etc. to achieve a particle having an average particle size from about 50 μm to about 800 μm.

Combination of Thermally Stabilized Composition and Polymer

The thermally stabilized active composition may then be encapsulated in a high molecular weight or high tensile strength polymer. The thermally stabilized active composition may be prepared by any of the methods described hereinabove. Combinations of thermally stabilized active compositions, including combinations of different actives and combinations of compositions prepared by different methods may be combined.

Examples of suitable polymers for the encapsulation of the thermally stabilized active compositions include polyethylene, crosslinked polyvinyl pyrrolidone, polymethylmethacrylate, polylactic acid, polyhydroxyalkanoates, ethylcellulose, polyvinyl acetate phthalate, polyethyleneglycol esters, methacrylicacid-co-methylmethacrylate, acrylic polymers and copolymers, carboxyvinyl polymer, polyamides, polystyrene, polyvinyl acetate and combinations thereof, more specifically the polymer will include polyvinyl acetate either alone or in combination with another polymer. For example, the polymer may have a molecular weight higher than about 300,000, specifically about 500,000 or higher.

The thermally stabilized active composition may be combined with the encapsulating polymer by melt extrusion. This is conducted by melting a combination of one or more polymers in combination with the active composition in the temperature range of about 65° C. to about 140° C. Another sweetener, such as a high-intensity sweetener as described above may be added prior to melting the combination. The extrudate is then cooled and formed into particles of a desired size. This may be accomplished through cutting, grinding, pulverizing, milling or any other appropriate technique as know in the art. The extrudate particles may have an average particle size ranging from about 50 μm to about 800 μm.

The encapsulated active composition may include any desired combination of polymer and the active composition, in addition to an optionally added active, especially a sweetener. The active composition may be present in an amount from about 1% to about 50% by weight of the encapsulated sweetener composition.

Tensile Strength

In some embodiments, selection of an encapsulating material for one or more dusting components may be based on tensile strength desired for the resulting delivery system. For example, in some embodiments, a delivery system produces delayed or otherwise controlled release of a dusting component through the use of a pre-selected or otherwise desired tensile strength.

In some embodiments, increasing the tensile strength of a delivery system may increase the delayed or extended release of a dusting component in the delivery system. The tensile strength for a delivery system may be matched with a desirable release rate selected according to the type of the dusting component(s) to be encapsulated for the delivery system, the encapsulating material used, any other additives incorporated in the delivery system and/or an edible composition using the delivery system as a dusting component, the desired rate of release of the dusting component, and the like. In some embodiments, the tensile strength of a delivery system which can be at least 6,500 psi, including 7500, 10,000, 20,000, 30,000, 40,000, 50,000, 60,000, 70,000, 80,000, 90,000, 100,000, 125,000, 135,000, 150,000, 165,000, 175,000, 180,000, 195,000, 200,000 and all ranges and subranges there between, for example, a tensile strength range of 6,500 to 200,000 psi.

In some embodiments, a delivery system for one or more dusting components can be provided based on the tensile strength of the delivery system having a specific tensile strength when compared to a standard. Thus, the design of the delivery system is not focused on one characteristic (e.g., molecular weight) of one of the materials (e.g., encapsulating material) used to produce the delivery system. In this manner, a delivery system can be formulated to express a desired release profile by adjusting and modifying the tensile strength through the specific selection of the dusting component(s), encapsulating material, additives, amount of the dusting component(s), amount of encapsulating material, relative amounts of dusting component(s) to encapsulating material, etc. If a desired tensile strength is chosen for a delivery system, any delivery system that has the desired tensile strength may be used without being limited to a particular encapsulating material and its molecular weight. The formulation process can be extended to encapsulating materials that exhibit similar physical and chemical properties as the encapsulating material forming part of the standard delivery system.

In some embodiments, a delivery system for delivering a dusting component may be formulated to ensure an effective sustained release of the dusting component based on the type and amount of the dusting component and the desired release rate for the dusting component. For example, it may be desirable to affect the controlled release of a high intensity sweetener from a chewing gum over a period of twenty-five to thirty minutes to ensure against a rapid burst of sweetness that may be offensive to some consumers. A shorter controlled release time may be desirable for other type of dusting components such as pharmaceuticals or therapeutic agents, which may be incorporated into the same edible composition by using separate delivery systems for each of these dusting components. Delivery systems may be formulated with a particular tensile strength associated with a range of release rates based on a standard. The standard may comprise a series of known delivery systems having tensile strengths over a range extending, for example, from low to high tensile strength values. Each of the delivery systems of the standard will be associated with a particular release rate or ranges of release rates. Thus, for example, a delivery system can be formulated with a relatively slow release rate by fabricating a delivering system having a relatively high tensile strength. Conversely, lower tensile strength compositions tend to exhibit relatively faster release rates.

In some embodiments, an edible composition may include a plurality of delivery systems to deliver a plurality of separate dusting components, including dusting components that may be desirably released at distinctly different release rates. Each of the delivery systems may have a different tensile strength. For example, high intensity sweeteners may desirably be released over an extended period of time (e.g., twenty to thirty minutes) while some pharmaceuticals are desirably released over a significantly shorter period of time.

In some embodiments, a delivery system can be prepared such that the release of one or more dusting components in the delivery system agent is at specific rates relative to the time of delivery. For example, in one embodiment, a delivery system can be prepared such that at least one dusting component is released at a rate of 80% over the course of fifteen minutes, 90% over the course of twenty minutes, and/or 95% over the course of thirty minutes. In another embodiment, the delivery system can be prepared such that one or more dusting components are released at a rate of 25% over the course of fifteen minutes, 50% over the course of twenty minutes and/or 75% over the course of thirty minutes.

In some embodiments, encapsulating material in a delivery system may be present in amounts of from about 0.2% to 10% by weight based on the total weight of the edible composition, including 0.3, 0.5, 0.7, 0.9, 1.0, 1.25, 1.4, 1.7, 1.9, 2.2, 2.45, 2.75, 3.0, 3.5, 4.0, 4.25, 4.8, 5.0, 5.5, 6.0, 6.5, 7.0, 7.25, 7.75, 8.0, 8.3, 8.7, 9.0, 9.25, 9.5, 9.8 and all values and ranges there between, for example, from 1% to 5% by weight. The amount of the encapsulating material can depend in part on the amount of the dusting component(s) component that is encapsulated. The amount of the encapsulating material with respect to the weight of the delivery system, is from about 30% to 99%, including 35, 40, 45, 50, 55, 60, 65, 70, 75, 80, 85, 95, 97 and all values and ranges there between, for example, from about 60% to 90% by weight.

In some embodiments, the tensile strength of a delivery system may be selected from relatively high tensile strengths when a relatively slow rate of release for a dusting component in the delivery system is desired and relatively lower tensile strengths when a faster rate of release for a dusting component in the delivery system is desired. Thus, when employing a tensile strength of 50,000 psi for a delivery system, the release rate of the dusting component, will generally be lower than the release rate of the dusting component in a delivery system having a tensile strength of 10,000 psi regardless of the type of encapsulating material (e.g., polyvinyl acetate) chosen.

In some embodiments, the encapsulating material for a delivery system is polyvinyl acetate. A representative example of a polyvinyl acetate product suitable for use as an encapsulating material in the present invention is Vinnapas® B100 sold by Wacker Polymer Systems of Adrian, Mich. A delivery system utilizing polyvinyl acetate may be prepared by melting a sufficient amount of polyvinyl acetate at a temperature of about 65° C to 120° C for a short period of time, e.g., five minutes. The melt temperature will depend on the type and tensile strength of the polyvinyl acetate encapsulating material where higher tensile strength materials will generally melt at higher temperatures. Once the encapsulating material is melted, a suitable amount of a dusting component (e.g., high intensity sweetener such as aspartame) is added and blended into the molten mass thoroughly for an additional short period of mixing. The resulting mixture is a semi-solid mass, which is then cooled (e.g., at 0° C.) to obtain a solid, and then ground to a U.S. Standard sieve size of from about 30 to 200 (600 to 75 microns). The tensile strength of the resulting delivery system can readily be tested according to ASTM-D638.

For additional information regarding how tensile strength of a delivery system may be used to create managed release of one or more dusting components, see U.S. patent application Ser. No. 11/083,968 entitled “A Delivery System for Active Components as Part of an Edible Composition Having Preselected Tensile Strength” and filed on March 21, 2005, and U.S. patent application Ser. No. 10/719,298 entitled “A Delivery System for Active Components as Part of an Edible Composition” and filed Nov. 21, 2003, the complete contents of both of which are incorporated herein by reference for all purposes.

In some embodiments, a delivery system, and/or an edible composition having the delivery system as one of its dusting components, may include one or more additives that act as tensile strength modifying agents for the delivery system. For example, in some embodiments, the formulation of a delivery system with a desirable tensile strength can be made from a variety of encapsulating materials and at least one additive that acts as a tensile strength modifying agent. The additive may be added to the delivery system and/or to the edible composition containing the delivery system. The at least one additive may be used to formulate the delivery system by modifying the tensile strength of the delivery system, including tensile strength-lowering materials such as fats, emulsifiers, plasticizers (softeners), waxes, low molecular weight polymers, and the like, in addition to tensile strength increasing materials such as high molecular weight polymers. In addition, the tensile strength of the delivery system can also be fine tuned by combining different tensile strength modifiers to form the delivery system. For example, the tensile strength of high molecular weight polymers such as polyvinyl acetate may be reduced when tensile strength lowering agents such as fats and/or oils are added. Thus, by employing tensile strength modifiers, the overall tensile strength of the delivery system can be adjusted or altered in such a way that a pre-selected or otherwise desired tensile strength is obtained for the corresponding desired release rate of the dusting component from an edible composition based on a comparison with a standard.

Examples of tensile strength modifiers or modifying agents include, but are not limited to, fats (e.g., hydrogenated or non-hydrogenated vegetable oils, animal fats), waxes (e.g., microcrystalline wax, bees wax), plasticizers/emulsifiers (e.g., mineral oil, fatty acids, mono- and diglycerides, triacetin, glycerin, acetylated monoglycerides, glycerol rosin monostearate esters), low and high molecular weight polymers (e.g., polypropylene glycol, polyethylene glycol, polyisobutylene, polyethylene, polyvinylacetate) and the like, and combinations thereof. Plasticizers may also be referred to as softeners.

For additional information regarding use of tensile strength modifying agents for a delivery system to create managed release of one or more dusting components, see U.S. patent application Ser. No. 11/083,968 entitled “A Delivery System for Active Components as Part of an Edible Composition Having Preselected Tensile Strength” and filed on Mar. 21, 2005, and U.S. patent application Ser. No. 10/719,298 entitled “A Delivery System for Active Components as Part of an Edible Composition” and filed Nov. 21, 2003, the complete contents of both of which are incorporated herein by reference for all purposes.

Hydrophobicity

In some embodiments, the release of one or more dusting components from a delivery system may depend on more than tensile strength. For example, the release of the dusting components may be directly related to the tensile strength of the delivery system and the hydrophobicity (i.e., water resistance) of the encapsulating polymer or other material.

As a more specific example, when a delivery system is used in a chewing gum, moisture may be absorbed in the encapsulated dusting component(s) during mastication and chewing of the chewing gum. This may result in softening of the encapsulating material and releasing of the dusting component(s) during the mastication and chewing of the chewing gum. The softening of the encapsulation material depends on the hydrophobicity of the polymer used as the encapsulation material. In general, the higher the hydrophobicity of the polymer, the longer mastication time is needed for softening the polymer.

As one example, higher hydrophobic polymers such as ethylene-vinylacetate (EVA) copolymer can be used to increase or otherwise manage dusting component (e.g., sweetener) release times from encapsulations. The degree of hydrophobicity can be controlled by adjusting the ratio of ethylene and vinylacetate in the copolymer. In general, the higher the ethylene to vinylacetate ratio, the longer time it will take during consumption to soften the encapsulation particles, and the slower or more delayed will be the release rate of the dusting component. The lower the ethylene to vinylacetate ratio, the shorter time it will take during consumption to soften the encapsulation particles, and the faster or earlier will be the release rate of the dusting component.

As illustrated by the discussion above, in some embodiments, release of a dusting component from a delivery system can be managed or otherwise controlled by formulating the delivery system based on the hydrophobicity of the encapsulating material, e.g., the polymer, for the dusting component. Using highly hydrophobic polymers, the release times of the dusting component can be increased or delayed. In a similar manner, using encapsulating material that is less hydrophobic, the dusting component can be released more rapidly or earlier.

The hydrophobicity of a polymer can be quantitated by the relative water-absorption measured according to ASTM D570-98. Thus, by selecting encapsulating material(s) for a delivery system with relatively lower water-absorption properties and adding that to a mixer, the release of the dusting component contained in the produced delivery system can be delayed compared to those encapsulating materials having higher water-absorption properties.

In some embodiments, polymers with water absorption of from about 50 to 100% (as measured according to ASTM D570-98) can be used. Moreover, to decrease the relative delivery rate, the encapsulating material can be selected such that the water absorption would be from about 15% to about 50% (as measured according to ASTM D570-98). Still further, in other embodiments, the water absorption properties of the encapsulating material can be selected to be from 0.0% to about 5% or up to about 15% (as measured according to ASTM D570-98). In other embodiments, mixtures of two or more delivery systems formulated with encapsulating material having different water-absorption properties can also be used in subsequent incorporation into an edible composition.

Polymers with suitable hydrophobicity which may be used for delivery systems include homo- and co-polymers of, for example, vinyl acetate, vinyl alcohol, ethylene, acrylic acid, methacrylate, methacrylic acid and others. Suitable hydrophobic copolymers include the following non-limiting examples, vinyl acetate/vinyl alcohol copolymer, ethylene/vinyl alcohol copolymer, ethylene/acrylic acid copolymer, ethylene/methacrylate copolymer, ethylene/methacrylic acid copolymer.

In some examples, the hydrophobic encapsulating material in a delivery system may be present in amounts of from about 0.2% to 10% by weight based on the total weight of an edible composition containing the delivery system, including 0.3, 0.5, 0.7, 0.9, 1.0, 1.25, 1.4, 1.7, 1.9, 2.2, 2.45, 2.75, 3.0, 3.5, 4.0, 4.25, 4.8, 5.0, 5.5, 6.0, 6.5, 7.0, 7.25, 7.75, 8.0, 8.3, 8.7, 9.0, 9.25, 9.5, 9.8 and all values and ranges there between, for example, from 1% to 5% by weight. The amount of the encapsulating material will, of course, depend in part on the amount of the dusting component that is encapsulated. The amount of the encapsulating material with respect to the weight of the delivery system, is from about 30% to 99%, including 35, 40, 45, 50, 55, 60, 65, 70, 75, 80, 85, 95, 97 and all values and ranges there between, for example, from about 60% to 90% by weight.

In formulating the delivery system based on the selection criteria of hydrophobicity of the encapsulating material, the encapsulated dusting component can be entirely encapsulated within the encapsulating material or incompletely encapsulated within the encapsulating material provided the resulting delivery system meets the criteria set forth hereinabove. The incomplete encapsulation can be accomplished by modifying and/or adjusting the manufacturing process to create partial coverage of the dusting component.

For example, if ethylene-vinyl acetate is the encapsulating material for a dusting component, the degree of hydrophobicity can be controlled by adjusting the ratio of ethylene and vinyl acetate in the copolymer. The higher the ethylene to vinylacetate ratio, the slower the release of the dusting component. Using vinylacetate/ethylene copolymer as an example, the ratio of the vinylacetate/ethylene in the copolymer can be from about 1 to about 60%, including ratios of 2.5, 5, 7.5, 9, 12, 18, 23, 25, 28, 30, 35, 42, 47, 52, 55, 58.5% and all values and ranges there between.

In some embodiments, a method of selecting a target delivery system containing a dusting component for an edible composition is based on the hydrophobicity of the encapsulating material for the dusting component in the delivery system. The method generally includes preparing a targeted delivery system containing a dusting component to be encapsulated, an encapsulating material and optional additives, with the encapsulating material having a pre-selected or otherwise desired hydrophobicity. The hydrophobicity of the encapsulating material employed in the targeted delivery system can be selected to provide a desirable release rate of the dusting component. This selection of the encapsulating material is based on the hydrophobicity of sample delivery systems having the same or similar dusting component and known release rates of the dusting component. In a more preferred another embodiment of the invention, the method comprises (a) obtaining a plurality of sample delivery systems comprising at least one dusting component, at least one encapsulating material, and optional additives, wherein each of the delivery systems is prepared with different encapsulating materials having different hydrophobicities; (b) testing the sample delivery systems to determine the respective release rates of the dusting component(s); and (c) formulating a target delivery system containing the same dusting component(s) with a hydrophobic encapsulating material corresponding to a desired release rate of the dusting component(s) based on the obtained sample delivery systems.

The method of selecting at least one delivery system suitable for incorporation into an edible composition preferably can begin by determining a desired release rate for a dusting component (i.e., a first active component). The determination of the desired release rate may be from known literature or technical references or by in vitro or in vivo testing. Once the desired release rate is determined, the desired hydrophobicity of the encapsulating material can be determined (i.e., a first hydrophobic encapsulating material) for a delivery system (i.e., first delivery system) that can release the first active component at the desired release. Once the delivery system is obtained which can deliver the first active component as required it is then selected for eventual inclusion in an edible composition.

The method described above may then be repeated for a second active component and for additional active components as described via the determination and selection of a suitable delivery system.

For additional information regarding the relationship of hydrophobicity of an encapsulating material to the release of a dusting component from a delivery system, see U.S. patent application Ser. No. 11/134,364 entitled “A Delivery System For Active Components as Part of an edible Composition” and filed on May 23, 2005,with the U.S. Patent and Trademark Office, the complete contents of which are incorporated herein by reference for all purposes.

Ratio of Dusting Component to Encapsulating Material for Dusting Component in Delivery System

In general, the “loading” of a dusting component in a delivery system can impact the release profile of the dusting component when the dusting component is used in an edible composition. Loading refers to the amount of one or more dusting components contained in the delivery relative to the amount of encapsulating material. More specifically, the ratio of the amount of one or more dusting components in a delivery system to the amount of encapsulating material in the delivery system can impact the release rate of the one or more dusting components. For example, the lower the ratio or loading of the amount of one or more dusting components in a delivery system to the amount of encapsulating material in the delivery system, the longer or more delayed will be the release of the one or more dusting components from the delivery system. The higher the ratio or loading of the amount of one or more dusting components in a delivery system to the amount of encapsulating material in the delivery system, the faster or earlier will be the release of the one or more dusting components from the delivery system. This principle can be further employed to manage the release profiles of the one or more dusting components by using higher loading of dusting components designed to be released early in combination with lower loading of dusting components designed to be released later. In some embodiments, the one or more dusting components can be the same or different.

As a more specific example, three delivery systems including aspartame encapsulated with a polyvinylacetate and a fat were created using a conventional mixing process wherein the polyvinyl acetate first was melted in a mixer. The aspartame and fat then were added and the three ingredients were mixed to create a homogenous mixture. The delivery systems had the following aspartame to polyvinyl to fat ratios: (1) 5:90:5; (2) 15:80:5, (3) 30:65:5. The molten delivery systems were cooled and sized by passing ground powder through a 420 micron screen. Three chewing gums were created, each using a different delivery system. It was determined that the chewing gum using the first ratio of the ingredients had a lower or slower release of aspartame than the chewing gums using the second or third ratios of the ingredients. Similarly, the gum using the second ratio of the ingredients had a lower or slower release of aspartame than the chewing gum using the third ratio of the ingredients.

For additional information regarding the relationship of the ratio of the amount ingredient in a delivery system to the amount of encapsulating material in the delivery system to the release of an ingredient from a delivery system, see U.S. patent application Ser. No. 11/134,371 entitled “A Delivery System For Active Components as Part of an edible Composition” and filed on May 23, 2005, with the U.S. Patent and Trademark Office, the complete contents of which are incorporated herein by reference for all purposes.

Change or Manage Characteristic of Dusting Component

In some embodiments, the vapor pressure of the one or more dusting components can be manipulated to affect release of the one or more dusting components. For example, a volatile material can be combined with a fixative to decrease its vapor pressure and delay release from the delivery system. Examples of materials that can be used as fixatives include, but are not limited to sequiterpenes such as viridiflorol, poly limonene, sucrose acetate isobutyrate (SAIB), ester gum, ethyl cellulose or related polymers, hydrocolloids, vegetable oils, medium chain triglycerides, triethyl citrate, triglycerides such as triacetin and the like, glycerin, and propylene glycol.

In some embodiments, the phase of the one or more dusting components can be changed to affect release. For example, liquid dusting components can be processed into solid materials prior to encapsulation. In some embodiments, the one or more liquid dusting components can be processed by spray drying, spray chilling, fluidized bed drying, coacervation, absorption, adsorption, or inclusion processed to form complexes with cyclodextrins or glasses such as sucrose, maltodextrin, polyols, and the like.

Variations in Particle Size of Dusting Component or Delivery System

In some embodiments, release of a dusting component (e.g., a sweetener) in an edible composition can be modified or otherwise managed by varying particle size and distribution of the delivery system that includes the dusting component. For example, smaller particle size and sharper particle size distribution of a delivery system will result in faster or earlier release of the encapsulated dusting component as compared to delivery systems having bigger particle sizes and wider distributions. A sharp particle size distribution can be obtained by having a more narrow range of particle sizes. Increasing the particle size of the delivery system will delay the release of the encapsulated dusting component. Also, smoothing the particle size distribution can provide sustained release. A particle size distribution can be smoothed by expanding the range of particle sizes. This principle can also be applied to design delivery systems that manage release profile. For example, one or more dusting components in delivery systems with smaller, sharper particle sizes can be combined with one or more dusting components in delivery systems with larger, smoother particles to provide both faster and delayed release of the respective one or more dusting components.

As a more specific example, a delivery system can include the following dusting components by percentage: aspartame (30%), polyvinylacetate (65%), hydrogenated oil (3.75%), glycerolmonstearate (1.25%). The polyvinylacetate can be melted in a twin screw extruder. Hydrogenated oil and glycerolmonostearate are mixed under high shear in the extruder and dispersed completely in the polymer melt. The molten encapsulation blends are cooled and sized by passing ground powder through three different particle size screens. For example, the screens may be 250, 420 and 710 microns sizes. Particles passing through each screen can then be collected and used. When the particles passing through the screen are collected and used, the screen size becomes the maximum particle size for the material. Very small particles from all the three sized powders can be removed by passing the powders through a 125 micron screen and removing the particles that pass through the 125 micron screen.

For gums prepared containing the above mentioned encapsulated aspartame particles, aspartame released in the order of smallest to largest maximum particle size (i.e., 250>420>710 micron particle sizes). The larger the size of the delivery system, the more delayed or the slower the release. By changing the particle size of the encapsulated aspartame (e.g., the size of the delivery system), the release of the aspartame in chewing gum can be managed to create or approximate a desired release profile.

For additional information regarding the relationship of particle size of a delivery system to the release of a dusting component from the delivery system, see U.S. patent application Ser. No. 11/134,480 entitled “A Delivery System for Active Components as Part of an Edible Composition Having Selected Particle Size” and filed on May 23, 2005, the complete contents of which are incorporated herein by reference for all purposes.

Pre-Treatment of a Dusting Component Prior to Encapsulation

In some embodiments, some or all of the dusting component(s) encapsulated within an encapsulating material may be miscible with the encapsulating material. For example, polyvinylacetate is one type of encapsulating material that can be used in some embodiments. Some components, such as flavors comprising short or medium chain esters, may interact with the polyvinylacetate (PVA) and thereby reduce the effectiveness of the controlled and/or delayed release profile of the dusting component. In addition, or alternatively, to the issue of miscibility, one or more of the dusting components may be sensitive to heat and may become compromised, lose effectiveness, or otherwise be damaged when exposed to heat. For example, the dusting components may be subjected to heat during the encapsulation process.

Therefore, in some embodiments, by itself or combined with the other embodiments described herein, a dusting component is coated with a “coating material” that is not miscible or at least less miscible relative to its miscibility with the encapsulating material. The coating also may thermally stabilize the encapsulated dusting component(s) or at least make them less sensitive to the application of heat. The dusting component can be treated with the coating material prior to or concurrently with its encapsulation with the encapsulating material.

The coating material in some embodiments can reduce the miscibility of the dusting component with the encapsulating material by at least 5%, preferably 25%, more preferably at least 50%, including, 10, 15, 20, 30, 40, 60, 70, 75, 80, 85, 90, 95% or more relative to the miscibility of the dusting component that is not coated by the coating material. The coating material also may reduce the thermal sensitivity of the dusting component(s) and assist in stability of the dusting component during processing.

In some embodiments, the material used to coat the dusting component may be a water soluble and/or hydrophilic material. Non-limiting examples of suitable coating materials include, gum Arabic, cellulose, modified cellulose, gelatin, polyols (e.g., sorbitol, xylitol, maltitol), cyclodextrin, zein, polyvinylalcohol, polymethylmethacrylate, and polyurethane. Mixtures of various coating materials also may be used.

The coating thickness will vary depending on starting particle size and shape of the dusting component as well as the desired weight percent coating level. The coating thickness is preferably from about 1 to about 200 microns, including 10, 20, 30, 40, 50, 60, 70, 80, 90, 100, 110, 120, 130, 140, 150, 160, 170, 180 and 190 microns and all values and ranges there between, for example, the thickness of coating material can be from about ten to about fifty microns and twenty to 54% by weight.

In addition to providing a barrier that can reduce and/or eliminate the miscibility of the dusting component, the coating material also may have good film forming properties that facilitates the formation of a barrier between the dusting component and the encapsulating material. Film forming properties as used herein means that the coating material, after dissolution in at least one solvent (e.g., water and/or organic solvents), leaves a film on the dusting component to which it is applied, for example, once the at least one solvent evaporates, absorbs and/or dissipates on the dusting component. Furthermore, when the coating material is used in the preparation of edible compositions, such as chewing gum, the coating material can be chosen based on its taste, shelf life, stickiness, resistance to microbial growth, and other common criteria for selecting dusting components for consumption.

The dusting component can be coated with the coating material by applying the coating material to the dusting component using a pan, spray, batch, and/or continuous processes typically used to coat materials. In some embodiments, the coating material is dissolved or dispersed in a solvent to facilitate coating on the dusting component. The coating material can be delivered using conventional methods of coating substrates. In a preferred method of coating, a fluidized bed technique is employed which is described, for example, in U.S. Pat. No. 3,196,827, the relevant contents of which are incorporated herein by reference.

In a further embodiment, by coating the dusting component and encapsulating the dusting component according to the description provided herein, a longer shelf life of the edible compositions can be attained. As used herein, shelf life is an indicia of the stability of the components of the edible compositions containing the dusting component. Using flavorants and/or sweeteners for illustration, this increase in shelf life can be assessed by determining the perceived flavor and/or sweetness of the flavorant and/or sweetener contained in the edible composition. When using a coating material to coat the dusting component a 5% increase in shelf life relative to a similar product in which the dusting component has not been coated with the barrier material can be achieved, including 10, 20, 30, 40, 50, 60, 70, 80, 90, 100% or more, as well as all values and ranges there between, increased shelf life. In another embodiment, the longer shelf life can be correlated to the time of storage after manufacture, for example at ten weeks the shelf life of the edible composition containing the dusting component will demonstrate a 50%, 75%, 80%, or 90% improvement relative to a similar composition but not containing a dusting component coated with a coating material. In a further example, at twenty-four weeks of storage, the dusting component will show an 80 to 90% improvement relative to a similar composition but not containing the dusting component coated with a coating material.

For additional information regarding coating or pre-treatment of an ingredient used in a delivery system, see U.S. patent application Ser. No. 11/134,365 entitled “A Delivery System for Active Components and a Material Having Preselected Hydrophobicity as Part of an Edible Composition” and filed on May 23, 2005, the complete contents of which are incorporated herein by reference for all purposes.

Post-Treatment of a Dusting Component After Encapsulation

In some embodiments, a delivery system may be post-treated prior to being added as a dusting component in an edible composition. For example, a delivery system may include a high intensity sweetener encapsulated in a first core coating comprising a low molecular weight encapsulating material (e.g., polyvinylacetate) and a second outer hydrophilic coating. This multiple coating system may provide improved resistance to the high intensity sweetener to attack from the flavor component when the delivery system is incorporated into a chewing gum, and improved stability to high temperatures. When applied to sweeteners such as aspartame, these coatings may effectuate sustained release of the sweetener, thereby extending the period of sweetener perception and enjoyment of the chewing gum or confection while at the same time enhancing the initial intensity and experience of sweetness release. The sweetener delivery system can be used in both sugar gums and in sugarless gum formulations. Examples of a post-treatment of a dusting component after encapsulation can be found in U.S. Pat. Nos. 4,933,190. For additional information regarding coating of a delivery system, see U.S. patent application Ser. No. 11/134,370 entitled “A Coated Delivery System for Active Components as Part of an Edible Composition” and filed on May 23, 2005, the complete contents of which are incorporated herein by reference for all purposes.

As one example of a hydrophilic coating, sucralose was mixed with powdered polyvinyl acetate and 5% fat and extruded at 110° C. Extensive discoloration indicating degradation of the sucralose was observed. In an alternative encapsulation, sucralose was mixed with powdered polyvinyl acetate, 2% polyvinylpyrollidone and 1% magnesium stearate and pressed into tablets at 25° C. The tablets were then heated to 80° C., which softened the polymer and fused the polyvinylacetate with the sucralose. No discoloration was observed. Thereafter, the tablets were cooled, ground and sized and analyzed. Again, no discoloration of the sucralose was observed. As another example, a polymer/sweetener matrix was prepared as described above in this paragraph. A solution of gum arabic was made and coated on the polymer/sweetener matrix particles using the method described in U.S. Pat. No. 3,196,827, the relevant portions of which are incorporated herein by reference. Coating levels were 20, 30, 40, and 50% for different samples. Chewing gums prepared with the coated polymer/sweetener matrix particles were chewed by a panel with bolus collection at 5, 10, 15, 20 minutes. Residual sucralose was analyzed in each chewed bolus. The chewing gums with higher levels of coating showed more residual sucralose remaining in the bolus at each time point.

Multiple Layers of Encapsulation

In some embodiments, a delivery system may have multiple layers of encapsulating material for one or more dusting components. One or more of the layers may be the same or different. Each of the layers may partially or completely surround one or more dusting components or a previous encapsulation layer or form a matrix with the one or more dusting components or the previous encapsulation layer.

As one example, in a delivery system having two or more layers of encapsulation for particles of a dusting component, the delivery system may have: (1) the same inner encapsulating layer and the same inner encapsulating layer for all particles of the same dusting component; (2) the same inner encapsulating layer, but different outer encapsulating layers, for different particles of the same dusting component; (3) different inner encapsulating layers, but the same outer encapsulating layer, for different particles of the same dusting component; (4) different inner encapsulating layers and different outer encapsulating layers for different particles of the same dusting component; or (5) encapsulating layers created by different methods of encapsulation. When encapsulating layers are different, the difference may be created by, for example, different polymers, different hydrophobicities, etc.

As another example, in a delivery system having two or more layers of encapsulation for groups of multiple dusting components, the delivery system may have: (1) the same inner encapsulating layer and the same outer encapsulating layer for each group of the multiple dusting components; (2) the same inner encapsulating layer, but different outer encapsulation layers, for different groups of the multiple dusting components; (3) different inner encapsulation layers, but the same outer encapsulation layer, for different groups of the multiple dusting components; (4) different inner encapsulation layers and different outer encapsulation layers for different groups of the multiple dusting components; or (5) different layers of encapsulation for different groups of multiple dusting components created by different methods of encapsulation.

Co-Crystallized/Precipitated Complex

The co-crystallized/precipitated complex of some embodiments may primarily include an active, such as sucralose, with cyclodextrin. Within the co-crystallized/precipitated complex, the cyclodextrin may be present in an amount greater than zero up to about 25% by weight of the complex, more specifically up to about 15% or up to about 5%. The cyclodextrin may be any of α-cyclodextrin, β-cyclodextrin, γ-cyclodextrin, and combinations thereof.

A co-crystallized/precipitated complex of sucralose and cyclodextrin may be prepared by first preparing a solution in water or a combination of water with another suitable organic solvent. The solution is then heated to a temperature in the range from about 40° C. to about 80° C. for about 10 minutes to about 20 minutes. The heating of the solution has been found not to result in an appreciable degradation of a sucralose active, as measured by changed in color, i.e., discoloration as measured by spectrophotometry, as described below in the examples.

After the sucralose/cyclodextrin solution has been maintained under heat for a sufficient time to form the co-crystallized/precipitated complex of sucralose and cyclodextrin, the co-crystallized/precipitated complex is then obtained upon drying or otherwise removing the solvent. If necessary, the particles obtained after drying may be formed to a desired size. This may be accomplished by any mechanical means such as milling, grinding, or other methods of comminuting. In some embodiments the co-crystallized/precipitated complex has an average particle size ranging from about 1 μm to about 150 μm.

Delivery Systems

Some embodiments provide delivery systems or delivery vehicles, which may incorporate the dusting compositions described above. The delivery systems generally encompass any confectionery or chewing gum compositions. More particularly, the delivery system may be selected from forms such as, but not limited to, chewing gum, center-filled chewing gum, compressed chewing gum, candy gum, and the like.

In general, any of the dusting compositions described herein may be present in amounts of about 0.001% to about 20% by weight of the delivery system, such as a chewing gum product. In some embodiments, the dusting composition may be present in amounts of about 0.25% to about 10% by weight of the delivery system.

Chewinf Gum Compositions

The dusting compositions as described herein may also be used in a gum composition, including but not limited to chewing gums and bubble gums, particularly where the active is sucralose or another sweetener. In some embodiments, chewing gum compositions may include a gum base, a dusting composition, a flavor agent and a sweetening agent. The dusting composition may be applied to the chewing gum such that it at least partially surrounds the outer surface of the gum. Encapsulation of the dusting component provides advantages in the preparation of gum compositions by providing an enhanced or prolonged active perception to person who is chewing the gum. This perception results from the manner in which the dusting component is released over time as a result of the gum being chewed.

The gum compositions of some embodiments may include a gum base. The gum base may include any component known in the chewing gum art. For example, the gum composition may include elastomers, bulking agents, waxes, elastomer solvents, emulsifiers, plasticizers, fillers and mixtures thereof.

The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight of the gum region, desirably from about 35% to about 40% by weight. In some embodiments, elastomer is present in an amount of about 5% to about 50% by weight of a chewing gum composition, center-fill chewing gum composition, or chewing gum tablet.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax. The wax may be present in the gum base in an amount from about 6% to about 10%, and preferably from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11%, by weight of the gum base.

The gum base may also include emulsifiers which aid in dispersing the immiscible components into a single stabilized system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also included are the hydrogenated vegetable oils and include soybean oil and cottonseed oil which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base of this invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. The amount of filler, may be present in an amount from about zero to about 40%, and more specifically from about zero to about 30%, by weight of the gum base.

A variety of traditional ingredients may be optionally included in the gum base in effective amounts such as coloring agents, antioxidants, preservatives, flavoring agents, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, and mixtures thereof, may also be included. Other conventional chewing gum additives known to one having ordinary skill in the chewing gum art may also be used in the gum base.

The gum composition may include amounts of conventional additives selected from the group consisting of sweetening agents (sweeteners), plasticizers, softeners, emulsifiers, waxes, fillers, bulking agents (carriers, extenders, bulk sweeteners), mineral adjuvants, flavoring agents (flavors, flavorings), coloring agents (colorants, colorings), antioxidants, acidulants, thickeners, medicaments, and the like, and mixtures thereof. Some of these additives may serve more than one purpose. For example, in sugarless gum compositions, a sweetener, such as maltitol or other sugar alcohol, may also function as a bulking agent.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carob, tragacanth, locust bean gum, pectin, alginates, galactomannans such as guar gum, carob bean gum, glucomanman, gelatin, starch, starch derivatives, dextrins and cellulose derivatives such as carboxy methyl cellulose, acidulants such as malic acid, adipic acid, citric acid, tartaric acid, fumaric acid, and mixtures thereof, and fillers, such as those discussed above under the category of mineral adjuvants.

In some embodiments, the gum region may also contain a bulking agent. Suitable bulking agents may be water-soluble and include sweetening agents selected from, but not limited to, monosaccharides, disaccharides, polysaccharides, sugar alcohols, and mixtures thereof; randomly bonded glucose polymers such polydextrose available under the trade name LITESSE manufactured by Danisco Sweeteners, Terre Haute, Ind.; isomalt (a racemic mixture of alpha-D-glucopyranosyl-1,6-mannitol and alpha-D-glucopyranosyl-1,6-sorbitol manufactured under the trade name PALATINIT by Suddeutsche Zucker), maltodextrins; hydrogenated starch hydrolysates; hydrogenated hexoses; hydrogenated disaccharides; minerals, such as calcium carbonate, talc, titanium dioxide, dicalcium phosphate; celluloses; and mixtures thereof.

Suitable sugar bulking agents include monosaccharides, disaccharides and polysaccharides such as xylose, ribulose, glucose (dextrose), mannose, galactose, fructose (levulose), sucrose (sugar), maltose, invert sugar, partially hydrolyzed starch and corn syrup solids, and mixtures thereof.

Suitable sugar alcohol bulking agents include sorbitol, erythritol, xylitol, mannitol, galactitol, maltitol, and mixtures thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

Any sweetening agent, as described above, may also be added as an additional, optional, and independent component to the gum compositions.

Any of the flavoring agents sensates, coloring agents, intense sweeteners, breath fresheners, functional agents, and the like described above may be used in the chewing gum composition.

Suitable oils and fats usable in gum compositions include partially hydrogenated vegetable or animal fats, such as coconut oil, palm kernel oil, beef tallow, and lard, among others. These ingredients when used are generally present in amounts up to about 7%, and preferably up to about 3.5%, by weight of the gum composition.

Some embodiments may include a method for preparing the improved chewing gum compositions for the gum region, including both chewing gum and bubble gum compositions. The chewing gum compositions may be prepared using standard techniques and equipment known to those skilled in the art. The apparatus useful in accordance with some embodiments comprises mixing and heating apparatuses well known in the chewing gum manufacturing arts, and therefore the selection of the specific apparatus will be apparent to the artisan.

Center-Fill Chewing Gum Compositions

As described in detail herein, the dusting compositions may be applied to one or more regions of a center-fill gum composition. Center-fill gum compositions may include a center-fill region, a gum region, which includes a gum base, and a dusting composition. The dusting composition may include a dusting component and an encapsulating material, which at least partially encapsulates the dusting components. In other center-fill embodiments, the dusting component may be unencapsulated or a combination of encapsulated and unencapsualted dusting components may be employed. The gum region may at least partially surround or be positioned adjacent to the center-fill region. Optionally, a third region, or a coating, may at least partially surround the gum region.

The dusting composition may be applied to one or more regions of the center-fill gum. In some embodiments, the center-fill gum may have a center-fill contacting surface. The dusting composition may be applied to such surface.

In some embodiments, the gum region may have a non-uniform thickness. In particular, the gum region in layered configuration embodiments may be thinner on the ends than on the sides of the gum piece.

The center-fill region of the gum composition may be a liquid, solid or semi-solid, gas, or the like. Embodiments that include a liquid center-fill composition, as well as some semi-solid center-fill compositions, may involve concerns regarding retention of the liquid center during manufacturing and shelf-life, as mentioned above. It may be desirable, therefore, to employ gum region compositions with liquid-fill gums that substantially reduce or prevent leaking of the liquid center. Suitable gum region compositions are discussed in detail below.

Non-liquid, i.e., solid, some semi-solid and gaseous center-fill regions, however, may not involve leaking concerns. Accordingly, gum region compositions that may exhibit leaking problems when combined with liquid centers may be suitable for use with non-liquid centers. As such, in addition to the gum region compositions discussed below for use with liquid centers, any conventional chewing gum composition may be employed in the gum region in non-liquid center-fill embodiments.

In some embodiments, the composition in the center-fill may be lipophilic. In such embodiments, it may be desirable to adjust the gum region composition to account for such compositions. In particular, in some embodiments, the gum base used in the gum region composition may be adjusted to include higher proportions of fat when the center-fill composition is lipophilic.

In some embodiments, the center-fill region may be substantially or completely filled with the liquid, solid, semi-solid or gaseous center-fill composition. In some other embodiments, the center-fill region may be only partially filled with the liquid, solid, semi-solid or gaseous center-fill composition.

In some embodiments, the center-fill region may include two or more center-fill compositions. The two or more center-fill compositions may be the same or different forms. For example, some embodiments may contain a mixture of two or more distinct liquids, which may or may not be miscible. Similarly, some embodiments may contain two or more distinct solids, semi-solids or gasses in the center-fill region. Mixtures of different center-fill forms also may be included in some embodiments. For example, a liquid and a solid may be included in the center-fill region. The two or more liquids, solids, semi-solids and/or gasses employed in the center-fill region may be included in the same or different amounts and may have similar or distinct characteristics. More specifically, in some embodiments, the two or more center-fill compositions may differ in a variety of characteristics, such as, viscosity, color, flavor, taste, texture, sensation, ingredient components, functional components, sweeteners, or the like.

In some embodiments, the center-fill composition also may include non-liquid components, such as, for example, flavor beads, fruit particles, nut particles, flavor particles, gelatin beads or portions, and the like.

The center-fill gum composition and other compositions described herein may be formed by any technique known in the art which includes the method described by U.S. Pat. No. 6,280,780 to Degady et al. (“Degady”), referred to above. Degady describes an apparatus and method for forming center-filled gum pellets. The method includes first extruding a liquid-filled rope of a chewing gum layer and passing the rope through a sizing mechanism including a series of pairs of pulley-shaped roller members. The roller members “size” the rope or strand of gum material such that it leaves the series of rollers with the desired size and shape for entering a tablet-forming mechanism.

The rope is then led into a tablet-forming mechanism including a pair of rotating chain die members which are endless chain mechanisms and both rotate at the same speed by a motor and gear mechanism. Each of the chain mechanisms include a plurality of open curved die groove members which mate and form die cavities in which the pieces of gum material (pellets or tablets) are formed. While Degady is limited to the formation of pellet or tablet shaped pieces, the gum pieces may be of other shapes as described above. The shape of the die groove members may be altered to provide any desired shape.

The gum may optionally be passed through a cooling tunnel either before entering the tablet-forming mechanism, after exiting the tablet-forming mechanism or both. Cooling of the rope prior to entering the tablet-forming mechanism may be beneficial to prevent rebound of the individual pieces and thus may provide an increase in productivity.

The cooled pieces of gum material are then fed into a storage container for conditioning and further processing. At this point, the cooled pieces of gum material could also be fed directly into a coating tunnel mechanism, such as a rotating tunnel mechanism.

Whether the pieces of formed gum material are first stored, transported in a storage container, or fed directly into a coating tunnel or mechanism, the individual pieces of gum material may subsequently be subjected to a conventional sugar or sugarless coating process in order to form a hard exterior shell on the liquid-filled gum material. A variety of coating processes or mechanisms of this type are known. In some embodiments, the coating is applied in numerous thin layers of material in order to form an appropriate uniform coated and finished quality surface on the gum products. The hard coating material, which may include sugar, maltitol, sorbitol or any other polyol, including those described herein, and optionally flavoring, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products. In some embodiments, the coating, or outermost region, can be formed by lamination, dual or multiple extrusions, or any other process that creates an outermost region.

The coating composition may range from about 2% to about 80%, more specifically, about 20% to about 40% by weight of an individual gum piece which includes a center-fill, a gum region and a coating; even more specifically, from 25% to 35% and still more specifically around 30%. The coating may include sugar or polyol such as maltitol as the primary component, but may also include flavors, colors, etc. as described below in the discussion of the gum region. The coating or outermost region may be crystalline or amorphous.

In some embodiments, the center-filled chewing gum provides resistance from moisture migration from the center-fill to the gum region by modifying both the saccharide or polyol composition and gum base composition present in the gum region. This is particularly relevant for liquid-fill chewing gum embodiments. This is in contrast to the aforementioned conventional approaches and which have not fully addressed the problems associated with manufacturing and shelf-stability of liquid center-filled products.

In some embodiments of the invention, there are included smaller piece-sizes. For example, the smallest conventional piece sizes of commercially available gum are generally in pellet forms. These piece-sizes currently range from about 5-7 grams. In some embodiments liquid filled products have been made using substantially smaller piece sizes, i.e., 50-60% smaller by weight, without loss of liquidity or migration of liquid into the gum region or beyond into the coating. Some inventive embodiments provide a liquid-filled gum piece size range which is greater than about 0.5 grams, more specifically greater than 1.5 grams up to about 3 grams, including the addition of an outer hard coating shell. In addition, in some embodiments a gum piece may include a center-fill, a gum region including a gum base and an outer coating. Such gum pieces may be about 2.2 grams total weight per piece.

With respect to liquid-fill embodiments, it has been discovered that pieces of such small size and particularly with gum shapes or configurations having proportionally more liquid-fill surface area as compared to the weight of the liquid per se, have a greater tendency to lose the liquidity of the center due to the interaction of different factors. While not limited to a single theory, these factors include the small amount of liquid-fill in comparison to the surface of the gum region in which the liquid-fill is in direct contact, the interaction of the type of elastomer with the center-fill (i.e. SBR versus non-SBR), the compatibility of the gum region components with the liquid-fill components, and the potential capillary action of the polyol used in the gum region. For example, the structure of sorbitol, which is customarily used in gum formulations in the United States, does not provide a tightly packed crystalline structure, giving almost a sponge-like appearance. Therefore, in order to provide a center-filled gum piece of less than about 3 grams, the present invention alters the gum and gum base in some embodiments to include a polyol composition having a dense, tightly packed crystalline structure which is unlike the sponge-like structure in conventional sorbitol gum region formulations, in order to provide a center-filled gum piece which resists loss of liquidity.

For other useful center-fill gum compositions and/or components for use therein, see the following co-pending commonly owned patent applications, the contents of which are incorporated herein by reference in their entirety: U.S. Application No. 60/776,748, filed on Feb. 24, 2006, entitled “Liquid-Filled Chewing Gum Composition”; U.S. Application No. 60/776,642, filed on Feb. 24,2006, entitled “Liquid-Filled Chewing Gum Composition”; U.S. Application No. 60/776,641, filed on Feb. 24, 2006, entitled “Liquid-Filled Chewing Gum Composition”; U.S. Application No. 60/776,508, filed on Feb. 24, 2006, entitled “Center-Filled Chewing Gum with Barrier Layer”; U.S. Application No. 60/776,382, filed on Feb. 24, 2006, entitled “Center-Filled Chewing Gum Composition”; and U.S. Application No. 60/776,637, filed on Feb. 24, 2006, entitled “Center-Filled Chewing Gum Composition”.

Gum Region

The gum region, also referred to as the second region in the claims, may include one or more cavities therein to house the center-fill. The shape of the cavity will be largely dictated by the final configuration of the chewing gum piece. The gum region also may include a gum base. In some embodiments, a chewing gum composition, a center-fill chewing gum, or a chewing gum tablet includes a chewing gum piece selected from the group consisting of a slab, pellet, stick, center-fill gum, candy gum, and deposited gum.

In some liquid-fill embodiments, the gum region may provide a liquid barrier to surround and prevent the liquid-fill from migration and premature release. By selection of the ratio of the desired cavity surface area to the liquid-fill weight, optimization of the reduction in potential liquid-fill migration in to the gum region area can be achieved. This is particularly useful when the gum piece size is desired to be substantially smaller than conventional commercialized gum pieces. In particular, liquid-filled pellet gums having sizes of 2 to 3 grams by weight of the entire gum piece have been successfully made. However, smaller gum pieces, as small as about 0.5 grams are contemplated.

Some embodiments, particularly liquid-fill embodiments, may incorporate a modified polyol composition including at least one polyol incorporated into the gum region as discussed herein. Moreover, the selection of a non-SBR gum base in the gum region, in combination with the modified polyol composition has been found to be particularly useful in achieving stable liquid-filled chewing gum compositions.

As mentioned above, the gum region may include a gum base. The gum base may include any component known in the chewing gum art, such as those described in detail above. Wherein the gum region is included in a three component composition including a center-fill, a gum region and a coating layer, the gum region may comprise from about 40% to about 97%, more specifically from about 55% to about 65% by weight of the chewing gum piece, even more specifically about 62%.

The amount of the gum base which is present in the gum region may also vary. In some embodiments, the gum base may be included in the gum region in an amount from about 25% to about 45% by weight of the gum region. A more specific range of gum base in some embodiments may be from about 28% to about 42% by weight of the gum region. Even more specifically, the range may be from about 28% to about 35% or from about 28% to about 30% in some embodiments. Alternatively, in some high gum base embodiments, the gum base may be present in an amount from about 45% to about 100% by weight of the gum region.

In some embodiments, particularly liquid-fill embodiments, the gum region may include a specific polyol composition including at least one polyol which is from about 30% to about 80% by weight of said gum region, and specifically from 50% to about 60%. In some liquid-fill embodiments, such gum region compositions may substantially reduce or prevent leaking of the liquid center. The polyol composition may include any polyol known in the art including, but not limited to maltitol, sorbitol, erythritol, xylitol, mannitol, isomalt, lactitol and combinations thereof. Lycasin™ which is a hydrogenated starch hydrolysate including sorbitol and maltitol, may also be used.

The amount of the polyol composition or combination of polyols used in the gum region will depend on many factors including the type of elastomers used in the gum base and the particular polyols used. For example, wherein the total amount of the polyol composition is in the range of about 40% to about 65% based on the weight of the gum region, the amount of maltitol may be from about 40% to about 60% in addition to an amount of sorbitol from about 0 up to about 10%, more specifically, an amount of maltitol may be from about 45% to about 55% in combination with sorbitol from about 5% to about 10% based on the weight of the gum region.

Maltitol is a sweet, water-soluble sugar alcohol useful as a bulking agent in the preparation of beverages and foodstuffs and is more fully described in U.S. Pat. No. 3,708,396, which disclosure is incorporated herein by reference. Maltitol is made by hydrogenation of maltose which is the most common reducing disaccharide and is found in starch and other natural products.

The polyol composition which may include one or more different polyols which may be derived from a genetically modified organism (“GMO”) or GMO free source. For example, the maltitol may be GMO free maltitol or provided by a hydrogenated starch hydrolysate. For the purposes of this invention, the term “GMO-free” refers to a composition that has been derived from a process in which genetically modified organisms are not utilized.

Some embodiments may include a polyol composition including maltitol which has a greater crystalline density than sorbitol. Other polyols which exhibit a greater crystalline density than sorbitol include xylitol and mannitol. The greater the crystalline density of the polyol the better the barrier properties are. Specifically, a polyol of a greater crystalline density results in a structure with fewer pores, which provides less surface area for potential moisture or fluid migration into the gum region from the liquid-fill.

Since sugar (sucrose) is generally accepted as the baseline for sweetness intensity comparison of sweeteners, including polyols, the polyol composition of some embodiments is described similarly. For example, the polyol composition may have a sweetness of greater than about 50% of the sweetness of sucrose. More specifically, the polyol composition of the present invention may have sweetness greater than about 70% the sweetness of sucrose.

The polyol composition of some embodiments may also be described in terms of the solubility of the composition. The solubility of the polyol composition will depend on the solubility of the one or more polyols included in the composition. For example, if maltitol is the only polyol included in the polyol composition, the solubility of the polyol composition in water will be about 60% at 25° C.

Blends of different polyols may also be used in some embodiments. Examples of useful polyols are erydiritol, lactitol, xylitol, mannitol, maltitol, sorbitol, isomalt, and combinations thereof. Where a blend of more than one polyol is used, the solubility of the polyol composition will depend on a weighted ratio of the amount of the polyol in the blend and the solubility of each individual polyol which is included. For example, a combination of two or more polyols may have a water solubility range of about 60% to about 72%, if it includes maltitol, which has a water solubility of 60% at 25° C., and sorbitol, which has a water solubility of about 72% at 25° C. Other suitable solubility ranges, which depend on the included two or more polyols include the ranges from about 40% to about 60% at 25° C. and 55% to 65% at 25° C. The range of the solubility may vary, depending on the particular polyols used, Alternative suitable solubilities of a polyol combination include those having a solubility less than sucrose (i.e., less than 67%).

In some embodiments, the polyol composition may include particles of a variety of sizes. Specifically, the average particle size of the polyol composition ranges from about 30 microns to about 600 microns, more specifically from about 30 microns to about 200 microns.

With respect to the center-fill layer, the gum region may have a water activity greater than or equal to the water activity of the center-fill composition. However, in compositions wherein a greater water activity is desired in the center or liquid-fill, the water activity of the center-fill composition may be greater than that of the gum region. A higher moisture content will aid in hydration of thickeners like xanthan gum and cellulose when present in the center-fill.

The gum region may have a total moisture content of about 14% by weight of the gum region and more specifically may have a total moisture content from about 9% to about 14% by weight, with a free moisture content of less than about 5%. The center-fill further may have total moisture content including free and bound moisture from about zero up to about 35% by weight of said center-fill, specifically about 22%.

Center-Fill Composition

The center-fill, also referred to as the interior portion, of the chewing gum composition can take the physical form of a solid, a liquid, a semi-solid or a gas. Depending on the physical form of the center, adjustments can be made to the adjacent portion of the chewing gum composition that will be in contact with the interior portion.

In some embodiments, liquid centers may present viscosity differences that can be manipulated for a desired effect. In some embodiments, liquid centers can be formulated to have low viscosities that consumers perceive as refreshing.

In some embodiments, solid centers may be particulate or unitary. In embodiments where the solid center is particulate, the center can include a plurality of particles. In some particulate solid center-fill embodiments, variables such as particle size and particle size distribution can be manipulated for a desired effect. In some embodiments, small particles with narrow particle size distribution can be included in the center to provide rapid dissolution when contacted with saliva.

In embodiments where the solid center is unitary, the center can include a cohesive mass where distinct particles are not discernible. In some unitary solid center embodiments, the texture can be manipulated for a desired effect. In some embodiments, a unitary solid center can comprise a confectionery format such as nougat to provide a chewy texture experience.

In some embodiments, gaseous centers can form a void in the chewing gum composition that alters the chewing gum composition's texture profile by collapsing upon chewing. In some embodiments, the gaseous center can include a trapped gas such as nitrogen while in other embodiments, the gaseous center can include a mixed gas composition such as air. In some embodiments, the gas can be included in the center as part of a matrix such as a foam or glassy matrix.

Additionally in some embodiments, the physical form of the center region can change. In some embodiments, the center can be solid when manufactured and then become liquid over time. In some embodiments, the initially solid center portion can be a substrate-enzyme blend where the enzyme acts upon the substrate to liquefy the solid. In other embodiments, the initial center solid portion can be a solid at a manufacturing temperature that is lower than the storage temperature such that the center liquefies as the temperature reaches the storage temperature. In some embodiments, the center is a liquid-filled particle that remains solid until ruptured or disrupted when it releases liquid. In some embodiments, the initially solid center portion can interact with an adjacent region configured to contain free moisture such that the center portion pulls moisture from the adjacent region and becomes liquid.

Solid Center-Fill Compositions

In some embodiments, the solid center can include particulates. Particulates can include, but are not limited to nuts; seeds; cocoa beans; coffee beans; milk powders; fruit-containing particles such as restructured fruit as described in U.S. Pat. No. 6,027,758; freeze dried fruit; freeze dried vegetables; fat particles; cocoa powder; sucrose; starch; polyols such as xylitol, erythritol, sorbitol, mannitol, lactitol, maltitol, isomalt, hydrogenated starch hydrolysates; waxes; and combinations thereof.

In some embodiments, the solid center can include particles onto which other materials have been complexed. In some embodiments, the solid particle can include an absorbent material to which a second material is absorbed. In some embodiments, the solid particle can include an adsorbent material to which a second material is adsorbed. In some embodiments, the solid particle can include a complexation material to which a second material is complexed. In some embodiments, silica particles can absorb at least a second material to form a particulate solid interior portion. In some embodiments, cyclodextrin particles can complex with at least a second material to form a particulate solid interior portion.

In some embodiments where the solid center can change to a liquid, the solid center can include a mixture of invertase and sucrose. Such invertase operates on sucrose to form liquid invert sugar resulting in a liquid interior portion over time. In some embodiments, the center can be a fat with melting characteristics such that at manufacturing temperatures the fat is solid and then melts to become liquid at storage temperatures. In some embodiments, the solid center can include liquid-filled gelatin or sucrose beads that release liquid when ruptured or disrupted.

In some embodiments, the solid center can include a unitary or particulate solid confectionery composition. Such confectionery compositions can include, but are not limited to, chocolate, compound coating, carob coating, cocoa butter, butter fat, hydrogenated vegetable fat, illipe butter, fondant including fondant-based cremes, fudge, frappe, caramel, nougat, compressed tablet, candy floss (also known as cotton candy), marzipan, hard boiled candy, gummy candy, jelly beans, toffees, jellies including pectin-based gels, jams, preserves, butterscotch, nut brittles or croquant, candied fruit, marshmallow, pastilles, pralines or nougats, flour or starch confectionery, truffles, nonpareils, bon bons, after-dinner mints, fourres, nut pastes, peanut butter, chewing gum, kisses, angel kisses, montelimart, nougatine, fruit chews, Turkish delight, hard gums, soft gums, starch jellies, gelatin jellies, agar jellies, persipan, coconut paste, coconut ice, lozenges, cachous, crame paste, dragees, sugared nuts, sugared almonds, comfits, aniseed balls, licorice, licorice paste, chocolate spreads, chocolate crumb, truffles, gasified candy and combinations thereof.

Liquid Center-Fill Compositions

In some embodiments, the liquid center can be aqueous while in other embodiments the liquid center can be non-aqueous. In some embodiments, the liquid center can be a solution while in other embodiments, the center can be a suspension while in still other embodiments, the center can be an emulsion.

In some embodiments, the viscosity of the liquid center can be manipulated for a variety of reasons including, but not limited to, processing efficiency or creation of a desired perception. In some embodiments, the viscosity of the liquid center can be 3,000 to 10,000 pascal seconds. In some embodiments, the viscosity of the liquid center can be 4,000 to 6,5000 pascal seconds.

In some embodiments, the water activity of the liquid center can be manipulated for a variety of reasons including, but not limited to, microbial stability or maintenance of a desired texture. In some embodiments, the water activity of the liquid center can be 0.1 to 0.7. In some embodiments, the water activity of the liquid center can be 0.25 to 0.35.

Liquids that can be included in the liquid center can include, but are not limited to, fruit juice; vegetable juice; fruit puree; fruit pulp; vegetable pulp; vegetable puree; fruit sauce; vegetable sauce; honey; maple syrup; molasses; corn syrup; sugar syrup; polyol syrup; hydrogenated starch hydrolysates syrup; emulsions; vegetable oil; glycerin; propylene glycol; ethanol; liqueurs; chocolate syrup, dairy-based liquids such as milk, cream, etc.; and combinations thereof.

Gaseous Center-Fill Compositions

In some embodiments, a gaseous center can be formed by creating a hollow center. The gas can include a mixed composition gas such as air or it can include a single gas such as nitrogen, carbon dioxide, or oxygen. In some embodiments, a gaseous center will include gas trapped in a matrix such as a glassy matrix or foam. In some embodiments where gas can be trapped in a glassy matrix, the glass can be sucrose and the gas can be carbon dioxide. In some embodiments where gas can be introduced into the center in a foam, the foam can include milk proteins and the gas can include a mixed composition gas such as air.

Any of the center-fill compositions discussed above may include any components known in the art for incorporation with a center-fill composition. In some embodiments, particularly liquid-fill embodiments, for instance, this may include glycerine in addition to one or more other polyols in amounts greater than zero up to about 20%, more specifically, up to about 10% by weight of the total chewing gum composition, i.e., including a center-fill composition, a gum region and a coating. In some embodiments, the center-fill is approximately 8% by weight of the total chewing gum composition. In some embodiments, the other polyol component includes desirably maltitol, sorbitol, xylitol, or a combination thereof.

In some embodiments, the centers may contain those traditional ingredients well known in the chewing gum and confectionery arts, such as flavoring agents, sweetening agents, and the like, and mixtures thereof, as described above. In addition to confectionery additives, the centers may also contain pharmaceutical additives such as medicaments, breath fresheners, vitamins, minerals, caffeine, fruit juices, and the like, and mixtures thereof. The confectionery and pharmaceutical agents may be used in many distinct physical forms well known in the art to provide an initial burst of sweetness and flavor and/or therapeutic activity or a prolonged sensation of sweetness and flavor and/or therapeutic activity. Without being limited thereto, such physical forms include free forms, such as spray dried, powdered, and beaded forms, and encapsulated forms, and mixtures thereof. Illustrative, but not limiting, examples of liquid centers suitable for use in some embodiments include those centers disclosed in U.S. Pat. Nos. 3,894,154, 4,156,740, 4,157,402, 4,316,915, and 4,466,983, which disclosures are incorporated herein by reference. Specific examples of suitable additional components include taurine, guarana, vitamins, Actizol™, chlorophyll, Recaldent™ tooth remineralization technology, and Retsyn™ breath freshening technology.

In some embodiments, particularly liquid-fill embodiments, the center-fill composition also may include a natural or synthetic gum such as carboxymethylcellulose, pectin, propylene glycol aginate, agar and gum tragacanth. These compositions serve to increase viscosity by reducing the amount of free water in the composition. The viscosity of the center-fill may range from about 300 cp to about 6,000 cp at 25° C. In liquid-fill compositions which have a greater water activity than the surrounding gum region, the viscosity may range from about 3,000 cp to about 6,000 cp at 25° C.

Xanthan gum may also be used to increase the viscosity of the center-fill composition. In some liquid-fill embodiments, increasing viscosity of the liquid also helps prevent the liquid from leaking through the gum piece. Xanthan gum is available under the tradename Keltrol® from CP Kelco of Atlanta, Ga.

Some embodiments extend to methods of making the improved center-filled chewing gum compositions. The improved compositions may be prepared using standard techniques and equipment known to those skilled in the art. The apparatus useful in accordance with the embodiments described herein comprises mixing and heating apparatuses well known in the chewing gum manufacturing arts, and therefore the selection of the specific apparatus will be apparent to the artisan. Such methods and apparatus are disclosed, for example, in U.S. Pat. Nos. 3,806,290 and 3,857,963, which disclosures are incorporated herein by reference.

Coating Composition

In some embodiments, an optional coating may be applied to the center-fill chewing gum. When present, the coating may at least partially surround the gum region. In some embodiments, the dusting composition may be applied to the center-fill region or gum region prior to coating the product with a coating composition. The dusted chewing gum then may be coated with a coating composition. Alternatively, the dusting composition may be removed from the center-fill or gum region, in some embodiments, prior to application of the coating. In some other embodiments, the dusting composition may be applied to the outer surface of the coated chewing gum.

The coating composition, when included in the center-fill compositions, may be applied by any method known in the art including the method described above. The coating composition may be present in an amount from about 2% to about 80%, more specifically from about 25% to about 35% by weight of the total center-filled gum piece, even more specifically about 30% by weight of the gum piece.

The outer coating may be hard, crunchy or soft. Typically, the outer coating may include sorbitol, maltitol, xylitol, erythritol, isomalt, and other crystallizable polyols; sucrose may also be used. Furthermore the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition comprises a coating, it is possible that one or more oral care actives can be dispersed throughout the coating. This is especially preferred if one or more oral care actives is incompatible in a single phase composition with another of the actives. Flavors may also be added to yield unique product characteristics.

In some embodiments, the coating may also be formulated to assist with increasing the thermal stability of the gum piece and preventing leaking of the liquid fill. In some embodiments, the coating may include a gelatin composition. The gelatin composition may be added as a 40% by weight solution and may be present in the coating composition from about 5% to about 10% by weight of the coating composition, and more specifically about 7% to about 8%. The gel strength of the gelatin may be from about 130 bloom to about 250 bloom.

Other materials may be added to the coating to achieve desired properties. These materials may include without limitation, cellulosics such as carboxymethyl cellulose, gelatin, pullulan, alginate, starch, carrageenan, xanthan gum, gum arabic and polyvinyl acetate (PVA).

The coating composition may also include a pre-coating which is added to the individual gum pieces prior to an optional hard coating. The pre-coating may include an application of polyvinyl acetate (PVA). This may be applied as a solution of PVA in a solvent, such as ethyl alcohol. When an outer hard coating is desired, the PVA application may be approximately 3% to 4% by weight of the total coating or about 1% of the total weight of the gum piece (including a center-fill, gum region and hard coating).

Various other coating compositions and methods of making are also contemplated including but not limited to soft panning, dual or multiple extrusion, lamination, etc. Thus, in some embodiments, the coating can be amorphous or crystalline and the resulting texture can be hard, crunchy, crispy, soft or chewy.

A variety of traditional additives also may be used in the coating, such as flavors, sweeteners, coloring agents, sensates, and the like, as described in detail above.

Compressible Chewing Gum Composition

As described in detail herein, the dusting compositions may be applied to a compressible chewing gum composition. Compressible chewing gum compositions may include a compressible gum base composition and a dusting composition, the dusting composition may include a dusting component and an encapsulating material, which at least partially encapsulates the dusting component. In other compressed gum embodiments, the dusting component may be unencapsulated or a combination of unencapsulated and encapsulated dusting components may be employed.

The dusting compositions may also be applied to a chewing gum tablet. Chewing gum tablets may include a particulate chewing gum base component pressed into a tablet form and a dusting composition, the dusting composition may include a dusting component and an encapsulating material, which at least partially encapsulates the dusting component. In other chewing gum tablets, the dusting component may be unencapsulated or a combination of unencapsulated and encapsulated dusting components may be employed.

The gum base used in the compressible chewing gum compositions of the present invention may be any conventional chewing gum base used in making chewing gum. As opposed to molten, or thermoplastic, gum base, however, the gum base in the compressible chewing gum compositions may be in a particulate form, such as, but not limited to, a powdered or granular gum base. The particulate gum base may be essentially free of water and can readily be formed into any desired shape, such as by compression.

The gum base may include any component known in the chewing gum art, as described in detail above.

A dusting composition may be applied to the particulate gum base at any point in the process where adherence to processing equipment could occur. In some embodiments, dusting is applied to the particulate gum base after mixing and during forming. In some embodiments, a dusting component at least partially surrounds the particulate chewing gum base component, tablet form or both.

The particulate gum base may be formed using standard grinding techniques known in the art. The starting material may be any conventional gum base, such as those used to produce molten gum bases. The particulate gum base may be formed, for example, by shredding, grinding or crushing the gum base or other processes, as described in U.S. Pat. Nos. 3,262,784, 4,405,647, 4,753,805 and 6,290,985 and U.S. Publication No. 2003/00276871, all of which are incorporated herein by reference in their entirety. In some embodiments, a dusting composition is applied to the particulate gum base before, during, and/or after the forming operation.

Desirably, the particulate gum base is ground or the like into a particulate form that is similar in particle size to a tableting powder, which is used with the particulate gum base to form the pressed gum tablet. By using components of like particle size, a homogenous mix of gum base and tableting powder may be achieved, which may provide a gum tablet of similar homogenous make-up. The gum base and tableting powder may have a particle size of about 4 to about 100 mesh, desirably about 8 to about 25 mesh, and more desirably about 12 to about 20 mesh. In some embodiments, a particulate chewing gum base component includes a compressible gum base component and a tableting powder.

The particulate gum base may be present in amounts of about 10% to about 80% by weight of the chewing gum composition, or tablet, desirably about 20% to about 50% by weight, and more desirably about 30% to about 40% by weight. In some embodiments, a gum base is present in an amount from about 5% to about 50% by weight of a chewing gum composition, a center-fill chewing gum composition, or a chewing gum tablet.

As mentioned above, the particulate gum base may be combined with a tableting powder to form the pressed gum tablet. The tableting powder can be in a dry, finely-divided form. Desirable particle size is provided above. The tableting powder may be a sucrose-based, dextrose-based or polyol-based powder, or combinations thereof. For example, the polyol-based powder may be a sorbitol or mannitol powder. The tableting powder may include other optional ingredients, such as flavor agents, color agents, sugar and/or sugarless sweeteners, and the like and combinations thereof.

In some embodiments, it may be desirable to combine a food-grade lubricant with the particulate gum base and tableting powder. Food-grade lubricants may assist in processing the gum composition into pressed tablets. More specifically, lubricants are used to prevent excess wear on dies and punches in tableting manufacture. Lubricants may be useful immediately after compression of the tablet within the die to reduce friction between the tablet and inner die wall. In some embodiments, lubricants are included in a dusting composition.

The food-grade lubricant may be added separately or it may be included with the tableting powder, as in some commercially available tableting powders. Examples of suitable food-grade lubricants include: metallic stearates; fatty acids; hydrogenated vegetable oil; partially hydrogenated vegetable oils; animal fats; polyethylene glycols; polyoxyethylene monostearate; talc; silicon dioxide; and combinations thereof. Food-grade lubricants may be present in amounts of about 0-6% by weight of the gum composition.

As described above, the compressible chewing gum composition can be in the form of a pressed gum tablet. In some embodiments, the particulate gum base and modified release ingredients are pressed into a tablet form. In some embodiments, a dusting composition is applied to the pressed tablets. Upon chewing, the pressed gum tablet consolidates into a soft chewy substance.

In some embodiments, the compressible chewing gum composition is a single-layer pressed tablet. In some embodiments, the compressible chewing gum composition is a multi-layer pressed tablet. Multi-layer tablet embodiments may have any desirable number of layers. Different layers may have the same or different thicknesses. In addition, different layers may include the same or different ingredients.

The pressed gum tablet also may have a coating layer surrounding the tablet. The coating layer may contain any ingredients conventionally used in the chewing gum art. For instance, the coating may contain sugar, polyols or high intensity sweeteners or the like, coloring agents, flavor agents and warming and/or cooling agents, among others. In some embodiments, the coating layer also may include a modified release ingredient as described above.

The compressible chewing gum compositions, or pressed tablets, desirably have a very low moisture content. In some embodiments, the tablets are essentially free of water. Accordingly, some embodiments have a total water content of greater than about 0% to about 5% by weight of the composition. The density of the composition, or tablet, may be about 0.2 to about 0.8 g/cc. Further, the compressible chewing gum compositions, or tablets, may have a dissolution rate of about 1 to about 20 minutes. When in a pressed tablet form, the chewing gum may have a Shore hardness of about 30 to about 200.

In contrast to dough mixed chewing gums where the gum mixture can achieve temperatures of 35 C to 60 C, compressed chewing gum temperatures can remain around ambient temperature (23 C to 25 C). In some embodiments, subjecting the compressible chewing gum compositions to lower temperatures can protect temperature sensitive ingredients from thermal degradation. Similarly, the absence of intimate mixing at temperatures above ambient can protect delivery systems that include temperature sensitive ingredients or ingredients subject to degradation from gum ingredients such as flavors, plasticizers, etc. Thus, ingredients susceptible to thermal or chemical degradation due to conventional dough mixing can be less likely to experience degradation in compressed chewing gum systems.

In some embodiments, methods of preparing pressed chewing gum tablets are employed. In accordance therewith, a particulate chewing gum base is provided. The particulate chewing gum base may be prepared by grinding or other similar means to obtain the desired particulate form, such as, for example, a finely divided powder. The particulate chewing gum base is mixed with a tableting powder, as described above. The particulate gum base and tableting powder may be mixed in any conventional way.

It may be desirable to mix the particulate gum base and tableting powder until a homogenous mix is achieved. Further, it may be desirable to use a particulate gum base and tableting powder that have similarly sized particles to obtain such a homogenous mixture. A homogenous mixture may provide a pressed gum tablet of similar homogenous make-up. Conventional mixing apparatus known to those skilled in the art may be used.

A modified release ingredient may be added to the mixture of particulate gum base and tableting powder during mixing. Once the modified release ingredients and any other components are blended in, the mixture may be passed through a screen of desired mesh size. Other components, such as lubricants, may be added and the batch may be further mixed. It may be desirable to mix until the batch is a homogenous powder. The batch then may be punched or pressed into gum tablets on a conventional tableting machine, such as a Piccola Model D-8 mini rotary tablet press or a Stokes machine.

Alternatively, the compressible chewing gum composition can be prepared by forming a dough mixed chewing gum composition and granulating the mixture using any suitable granulation process. Thus, in some embodiments, a chewing gum composition, a center-fill chewing gum or a chewing gum tablet are in granulated form. Moreover, in some embodiments, a particulate chewing gum base component includes a granulated dough mixed chewing gum composition. In some embodiments, dusting is applied to the dough mixed chewing gum before, during and/or after the granulation process. The granulated mixture may be passed through a screen of desired mesh size. The modified release ingredient(s) may be added to the granulated mixture and mixed. In some embodiments, modified release ingredient(s) are including in a dusting composition applied to the compressible chewing gum. Other components, such as lubricants, may be added and the batch may be further mixed. In some embodiments, lubricants are included in a dusting composition. It may be desirable to mix until the batch is a homogenous powder. The batch then may be punched or pressed into gum tablets on a conventional tableting machine, such as a Piccola Model D-8 mini rotary tablet press or a Stokes machine.

In single-layer embodiments, the powder batch may be pressed into gum tablets as described above. Thus, in some embodiments, the gum tablets include one layer.

In multi-layer embodiments, a separate layer batches may be filled into the tableting machine in sequence and pressed together to form a multi-layer gum tablet. Thus, in some embodiments, the gum tablet includes more than one layer.

Any number of powder batches may be filled into the tableting machine in any sequence and compressed together to form tablets having any desired number of layers.

It will be understood by one of ordinary skill in the art that modified release as well as free or unencapsulated ingredients as described above can be included in a compressible gum in any combination. Thus, compressed chewing gum tablets can have single or multiple ingredients in free or modified release forms, and those one or more free or modified release ingredients may be included singly or in combination.

Candy Gum Composition

As described in detail herein, the dusting compositions may be applied to a candy gum composition. Candy gum compositions may include a cooked saccharide region, an elastomeric region, which is adjacent to the cooked saccharide region, and a dusting composition, the dusting composition may include a dusting component and an encapsulating material, which at least partially encapsulates the dusting component. In other compressed gum embodiments, the dusting component may be unencapsulated or a combination of unencapsulated and encapsulated dusting components may be employed, where the dusting composition at least partially surrounds at least one of the cooked saccharide region, the elastomeric region or both regions.

Cooked Saccharide Region

In addition to center filled and compressible chewing gums, chewing gum formats can include a candy gum format comprising a cooked saccharide region and an elastomeric region. In some embodiments, confectionery products are formed by combining cooked saccharide (sugar or sugar free) syrups with elastomeric and other ingredients such as flavor, color, etc. In other embodiments, a cooked saccharide region includes cooked saccharide (sugar or sugar free) syrups along with other ingredients such as, but not limited to, starches, fats, and hydrocolloids. As described in more detail below in the “Texture Modification” section, in some embodiments, the composition of the cooked saccharide region is influenced by the composition of the elastomeric region. In some embodiments, the cooked saccharide region includes a saccharide selected from sugar/com syrup blends, isomalt, erythritol, maltitol and combinations thereof.

In some embodiments, the cooked syrups include saccharides with low hygroscopicity and low tendency to crystallize such that when combined with the elastomeric region, the resultant chewing confectionery products demonstrate desired shelf life stability. Examples of such cooked syrups include sugar/com syrup blends, isomalt, erythritol, maltitol, and combinations of these saccharides. In some embodiments, the tendency of the saccharides to crystallize is exploited by seeding the cooked syrup such that the saccharides crystallize over time to adjust the texture from a harder texture during manufacture to a softer texture at the time of consumption.

In some embodiments, a cooked saccharide region can include confectionery compositions. Such confectionery compositions can include, but are not limited to, chocolate, compound coating, carob coating, cocoa butter, butter fat, hydrogenated vegetable fat, illipe butter, fondant including fondant-based cremes, fudge, frappe, caramel, nougat, compressed tablet, candy floss (also known as cotton candy), marzipan, hard boiled candy, gummy candy, jelly beans, toffees, taffy, jellies including pectin-based gels, jams, preserves, butterscotch, nut brittles or croquant, candied fruit, marshmallow, pastilles, pralines or nougats, flour or starch confectionery, truffles, nonpareils, bon bons, after-dinner mints, fourres, nut pastes, peanut butter, chewing gum, kisses, angel kisses, montelimart, nougatine, fruit chews, Turkish delight, hard gummies, soft gummies, starch jellies, gelatin jellies, agar jellies, persipan, coconut paste, coconut ice, lozenges, cachous, came paste, dragees, sugared nuts, sugared almonds, comfits, aniseed balls, licorice, licorice paste, chocolate spreads, chocolate crumb, and combinations thereof.

In some embodiments, the cooked saccharide region may contain those traditional ingredients well known in the confectionery arts, such as flavoring agents, sweetening agents, and the like, and mixtures thereof, as described above. In addition to confectionery additives, the cooked saccharide region may also contain pharmaceutical additives such as medicaments, breath fresheners, vitamins, minerals, caffeine, phytochemicals, nutraceuticals, fruit juices, and the like, and mixtures thereof. The confectionery and pharmaceutical agents may be used in many distinct physical forms well known in the art to provide an initial burst of sweetness and flavor and/or therapeutic activity or a prolonged sensation of sweetness and flavor and/or therapeutic activity. Without being limited thereto, such physical forms include free forms, such as spray dried, powdered, and beaded forms, and encapsulated forms, and mixtures thereof. Specific examples of suitable additional components include taurine, guarana, vitamins, Actizol™, chlorophyll, Recaldent™ tooth remineralization technology, and Retsyn™ breath freshening technology.

In some embodiments, a dusting composition can be applied to a cooked saccharide region. In some embodiments, the dusting composition can include dusting components providing flavor, taste, functionality, sensations in either encapsulated or non-encapsulated form. In some embodiments, a dusting composition facilitates processing by reducing surface tackiness.

Elastomeric Region

The elastomeric region may include at least one modified release component, as discussed in more detail below. Moreover, in some embodiments, the elastomeric region may include a component that exhibits modified release properties in combination with the same component in its free, or unmodified, form.

The elastomeric region may be varied to provide a range of characteristics. For example, in some embodiments, an elastomeric region can include a level of mineral adjuvant or filler that provides a desired chewing texture and is higher than an elastomeric region with a lesser amount of filler. In other embodiments, an elastomeric region can include low melting point fats that provide an unctuous mouthfeel and indulgent chewing experience.

The elastomeric region may include a gum base and/or other elastomeric materials. The gum base or elastomeric materials may include any component known in the chewing gum art, as described in detail above. For example, the elastomeric region may include elastomers, bulking agents, waxes, elastomer solvents, emulsifiers, plasticizers, fillers and mixtures thereof. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof. Wherein the elastomeric region is included in a dual component composition including a cooked saccharide region and an elastomeric region, the elastomeric region may comprise from about 5% to about 95%, more specifically from about 30% to about 70% by weight of the confectionery composition piece, even more specifically about 50%.

The amount of the gum base or elastomeric material which is present in the elastomeric region may also vary. In some embodiments, the gum base or elastomeric materials may be included in the elastomeric region in an amount from about 25% to about 100% by weight of the elastomeric region. A more specific range of gum base or elastomeric materials in some embodiments may be from about 30% to about 75% by weight of the elastomeric region. Even more specifically, the range may be from about 35% to about 65% or from about 40% to about 50% in some embodiments.

The amount of elastomer employed in the elastomeric region may vary depending upon various factors such as the type of elastomer used, the consistency of the elastomeric region desired and the other components used in the elastomeric region to make the final confectionery product. In general, the elastomer will be present in the elastomeric region in an amount from about 10% to about 60% by weight of the elastomeric region, desirably from about 35% to about 40% by weight.

In some embodiments, the elastomeric region may include wax. It softens the polymeric mixture and improves the elasticity of the elastomeric region. When present, the waxes employed will have a melting point below about 60° C., and preferably between about 45° C. and about 55° C. The low melting wax may be a paraffin wax. The wax may be present in the elastomeric region in an amount from about 6% to about 10%, and preferably from about 7% to about 9.5%, by weight of the elastomeric region.

In addition to the low melting point waxes, waxes having a higher melting point may be used in the elastomeric region in amounts up to about 5%, by weight of the elastomeric region. Such high melting waxes include beeswax, vegetable wax, candelilla wax, camuba wax, most petroleum waxes, and the like, and mixtures thereof.

In addition to the components set out above, the elastomeric region may include a variety of other ingredients, such as components selected from elastomer solvents, emulsifiers, plasticizers, fillers, and mixtures thereof.

The elastomeric region may contain elastomer solvents to aid in softening the elastomeric materials. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the elastomeric region in amounts from about 2% to about 15%, and preferably from about 7% to about 11%, by weight of the elastomeric region.

The elastomeric region may also include emulsifiers which aid in dispersing the immiscible components into a single stable system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the elastomeric region.

The elastomeric region may also include plasticizers or softeners to provide a variety of desirable textures and consistency properties. Because of the low molecular weight of these ingredients, the plasticizers and softeners are able to penetrate the fundamental structure of the elastomeric region making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the elastomeric region. The plasticizers and softeners are generally employed in the elastomeric region in amounts up to about 20% by weight of the elastomeric region, and more specifically in amounts from about 9% to about 17%, by weight of the elastomeric region.

Plasticizers also include the hydrogenated vegetable oils and include soybean oil and cottonseed oil which may be employed alone or in combination. These plasticizers provide the elastomeric region with good texture and soft chew characteristics. These plasticizers and softeners are generally employed in amounts from about 5% to about 14%, and more specifically in amounts from about 5% to about 13.5%, by weight of the elastomeric region.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin maybe maintained under anhydrous conditions throughout the preparation of the confectionery composition.

In some embodiments, the elastomeric region of this invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the elastomeric region in various amounts. The amount of filler, may be present in an amount from about zero to about 40%, and more specifically from about zero to about 30%, by weight of the elastomeric region. In some embodiments, the amount of filler will be from about zero to about 15%, more specifically from about 3% to about 11%.

A variety of traditional ingredients may be optionally included in the elastomeric region in effective amounts such as coloring agents, antioxidants, preservatives, flavoring agents, high intensity sweeteners, and the like as described in detail above.

In some embodiments, a dusting composition can be applied to an elastomeric region. In some embodiments, the dusting composition can include dusting components providing flavor, taste, functionality, sensations in either encapsulated or non-encapsulated form. In some embodiments, a dusting composition facilitates processing by reducing surface tackiness.

Some embodiments extend to methods of making the confectionery compositions. The manner in which the elastomeric region components are mixed is not critical and is performed using standard techniques and apparatus known to those skilled in the art. In a typical method, an elastomer is admixed with an elastomer solvent and/or a plasticizer and/or an emulsifier and agitated for a period of from 1 to 30 minutes. The remaining ingredients, such as the low melting point wax, are then admixed, either in bulk or incrementally, while the elastomeric region mixture is blended again for 1 to 30 minutes.

In some embodiments, particularly confectionery composition embodiments, the elastomeric region may include a specific polyol composition including at least one polyol which is from about 30% to about 80% by weight of said elastomeric region, and specifically from 50%. to about 60%. In some confectionery composition embodiments, such elastomeric region compositions may have low hygroscopicity. The polyol composition may include any polyol known in the art including, but not limited to maltitol, sorbitol, erythritol, xylitol, mannitol, isomalt, lactitol and combinations thereof. Lycasin™ which is a hydrogenated starch hydrolysate including sorbitol and maltitol, may also be used.

The amount of the polyol composition or combination of polyols used in the elastomeric region will depend on many factors including the type of elastomers used in the elastomeric region and the particular polyols used. For example, wherein the total amount of the polyol composition is in the range of about 40% to about 65% based on the weight of the elastomeric region, the amount of isomalt may be from about 40% to about 60% in addition to an amount of sorbitol from about 0 up to about 10%, more specifically, an amount of isomalt may be from about 45% to about 55% in combination with sorbitol from about 5% to about 10% based on the weight of the elastomeric region.

The polyol composition may include one or more different polyols which may be derived from a genetically modified organism (“GMO”) or GMO free source. For example, the maltitol may be GMO free maltitol or provided by a hydrogenated starch hydrolysate. For the purposes of this invention, the term “GMO-free” refers to a composition that has been derived from process in which genetically modified organisms are not utilized.

Some embodiments may include a method for preparing the improved compositions for the elastomeric region, including elastomeric materials for both chewing gum and bubble gum compositions. The elastomeric region compositions may be prepared using standard techniques and equipment known to those skilled in the art. The apparatus useful in accordance with some embodiments comprises mixing and heating apparatuses well known in the confectionery manufacturing arts, and therefore the selection of the specific apparatus will be apparent to the artisan. In some embodiments, a dusting composition can be applied to the elastomeric region.

Texture Modification

In some embodiments, the texture of confectionery compositions are varied by varying the ratios and/or characteristics of the cooked saccharide and elastomeric regions, by changing processing parameters, or by including a texture modifying component.

When describing the texture profile of a confectionery composition, both analytical/instrumentation-based measures and sensory evaluation measures can be used. Analytical/instrumentation-based measures can include, but are not limited to, penetrometers, textureometers, tenderometers, universal testing machines, and the Texture Analyzer available from Stable MicroSystems of Surrey, United Kingdom. Sensory evaluation measures can include, but are not limited to, texture profiling and qualitative descriptive analysis. In some embodiments, the methods of measuring texture for a confectionery composition include a temporal component that measures the texture over time while the confectionery composition is being consumed.

In some embodiments, varying the ratios and/or characteristics of the cooked saccharide and elastomeric regions can vary the texture of the finished confectionery composition. For example, a confectionery composition comprising 60% to 80% w/w of a cooked saccharide composition wherein the cooked saccharide composition is a hard boiled candy with less than 3% moisture will provide a harder initial texture as compared to a confectionery composition comprising only 20% to 30% w/w of the same cooked saccharide composition. Alternatively, a confectionery composition comprising 40% to 50% w/w of a cooked saccharide composition wherein the cooked saccharide composition is a hard boiled candy with 2% moisture will provide a harder initial texture than a confectionery composition with the same amount (40%-50% w/w) of a hard boiled candy with 5% moisture. Similarly, a confectionery composition comprising 30% to 40% w/w of a cooked saccharide composition wherein the cooked saccharide composition is a hard boiled candy with 5% moisture will provide a harder initial texture than a confectionery composition with the same amount (40-50% w/w) of a chewy candy such as taffy wherein the taffy includes approximately 12% fat and about 8% moisture.

In some embodiments, varying the characteristics of the elastomeric region can vary the texture of the confectionery composition. For example, an elastomeric region including low melting point fats can provide a softer confectionery composition when combined with a cooked saccharide region than an elastomeric region including high melting point fats. Similarly, elastomeric regions containing lower levels of plasticizers and softeners may provide softer confectionery compositions when combined with cooked saccharide regions than elastomeric regions including higher levels of plasticizers and softeners.

In some embodiments, the texture of the confectionery composition may be varied by changing the characteristics of the confectionery composition. For example, the confectionery composition can include an outer layer or coating/shell. In some embodiments, the outer layer can be applied by pan coating techniques resulting in a crispy initial texture. In other embodiments, the confectionery composition can include a center-fill. The center-fill can be liquid, semi-solid, solid or gaseous. In some embodiments, a confectionery composition with a liquid center fill has a softer initial texture and requires less energy to bite through than a confectionery composition without a liquid center fill.

In some embodiments, the solid center can include particulates. Particulates can include, but are not limited to nuts; seeds; cocoa beans; coffee beans; milk powders; fruit-containing particles such as restructured fruit as described in U.S. Pat. No. 6,027,758; freeze dried fruit; freeze dried vegetables; fat particles; cocoa powder; sucrose; starch; polyols such as xylitol, erythritol, sorbitol, mannitol, maltitol, isomalt, hydrogenated starch hydrolysates; waxes; and combinations thereof.

In some embodiments, the solid center can include particles onto which other materials have been complexed. In some embodiments, the solid particle can include an absorbent material to which a second material is absorbed. In some embodiments, the solid particle can include an adsorbent material to which a second material is adsorbed. In some embodiments, the solid particle can include a complexation material to which a second material is complexed. In some embodiments, silica particles can absorb at least a second material to form a particulate solid interior portion. In some embodiments, cyclodextrin particles can complex with at least a second material to form a particulate solid interior portion.

In some embodiments where the solid center can change to a liquid, the solid center can include a mixture of invertase and sucrose such invertase operates on sucrose to form liquid invert sugar resulting in a liquid interior portion over time. In some embodiments, the center can be a fat with melting characteristics such that at manufacturing temperatures the fat is solid and then melts to become liquid at storage temperatures. In some embodiments, the solid center can include liquid-filled gelatin or sucrose beads that release liquid when ruptured or disrupted.

In some embodiments, the solid center can include a unitary or particulate solid confectionery composition. Such confectionery compositions can include, but are not limited to, chocolate, compound coating, carob coating, cocoa butter, butter fat, hydrogenated vegetable fat, illipe butter, fondant including fondant-based cremes, fudge, frappe, caramel, nougat, compressed tablet, candy floss (also known as cotton candy), marzipan, hard boiled candy, gummy candy, jelly beans, toffees, jellies including pectin-based gels, jams, preserves, butterscotch, nut brittles or croquant, candied fruit, marshmallow, pastilles, pralines or nougats, flour or starch confectionery, truffles, nonpareils, bon bons, after-dinner mints, fourres, nut pastes, peanut butter, chewing gum, kisses, angel kisses, montelimart, nougatine, fruit chews, Turkish delight, hard gums, soft gums, starch jellies, gelatin jellies, agar jellies, persipan, coconut paste, coconut ice, lozenges, cachous, creme paste, dragees, sugared nuts, sugared almonds, comfits, aniseed balls, licorice, licorice paste, chocolate spreads, chocolate crumb, and combinations thereof.

In some embodiments, the liquid center can be aqueous while in other embodiments the liquid center can be non-aqueous. In some embodiments, the liquid center can be a solution while in other embodiments, the center can be a suspension while in still other embodiments, the center can be an emulsion.

In some embodiments, the viscosity of the liquid center can be manipulated for a variety of reasons including, but not limited to, processing efficiency or creation of a desired perception. In some embodiments, the viscosity of the liquid center can be 3,000 to 10,000 pascal seconds. In some embodiments, the viscosity of the liquid center can be 4,000 to 6,5000 pascal seconds.

In some embodiments, the water activity of the liquid center can be manipulated for a variety of reasons including, but not limited to, microbial stability or maintenance of a desired texture. In some embodiments, the water activity of the liquid center can be 0.1 to 0.7. In some embodiments, the water activity of the liquid center can be 0.25 to 0.35.

Liquids that can be included in the liquid center can include, but are not limited to, fruit juice; vegetable juice; fruit puree; fruit pulp; vegetable pulp; vegetable puree; fruit sauce; vegetable sauce; honey; maple syrup; molasses; corn syrup; sugar syrup; polyol syrup; hydrogenated starch hydrolysates syrup; emulsions; vegetable oil; glycerin; propylene glycol; ethanol; liqueurs; chocolate syrup, dairy-based liquids such as milk, cream, etc.; and combinations thereof.

In some embodiments, a gaseous center can be formed by creating a hollow center. The gas can include a mixed composition gas such as air or it can include a single gas such as nitrogen, carbon dioxide, or oxygen. In some embodiments, a gaseous center will include gas trapped in a matrix such as a glassy candy matrix or foam. In some embodiments where gas can be trapped in a glassy candy matrix, the glass matrix can be sucrose and the gas can be carbon dioxide. In some embodiments where gas can be introduced into the center in a foam, the foam can include milk proteins and the gas can include a mixed composition gas such as air.

In some embodiments, varying processing parameters can result in confectionery products with different textures. In some embodiments, the confectionery composition is prepared by using an extruder to mix the components. The extruder can be configured to input more or less energy into the confectionery composition. In some embodiments, a harder initial texture results from configuring the extruder to input less energy and provide gentle mixing. In other embodiments, the same composition can provide a softer initial texture by configuring the extruder to input more energy and provide vigorous mixing. In some embodiments, a dusting composition is applied to the confectionery composition.

In some embodiments, ingredients can be included in a dusting composition that is applied to the cooked saccharide region, the elastomeric region, and/or the confectionery composition. In some embodiments, thermally sensitive ingredients are included in a dusting composition to reduce their exposure to heat.

In some embodiments, a method for providing a desired texture includes determining a desired confectionery composition rheology (or a range of desired rheologies) and then determining rheologies for the cooked saccharide region and the elastomeric region. The desired confectionery composition rheology can be created by varying processing parameters of the extruder based on the rheologies of the regions.

Additional embodiments described herein relate to methods of developing confectionery products which provide a consumer-preferred texture. In accordance therewith, a consumer preference for a texture may first be identified. A variety of methods may be used to identify a consumer preference for a specific texture, such as, market research, including consumer surveys, taste panels, and the like. Once a consumer preference for a texture, such as, for example, a tougher chew that provides more salivation, is identified, a confectionery product tailored to satisfy that preference may be provided. In particular, any of the confectionery products described herein may be prepared. The confectionery product may be marketed to consumers based on the consumer-preferred texture.

The consumer-preferred texture provided by the confectionery product may be marketed to consumers in a variety of manners. Suitable marketing strategies, include, for example, print, radio, satellite radio, television, movie theater and online advertising campaigns, point-of-purchase advertisements, billboard advertisements, public transportation and telephone booth advertisements, indicia on the product packaging, including slogans, trademarks, terms and colors, instant messaging, ringtones, and the like.

In some embodiments, a texture modifying component is added to the confectionery composition. Inclusion of the texture modifying component can result in finished confectionery products with a variety of texture characteristics ranging from hard and friable to soft and pliable. In some embodiments, a texture modifying component is included in a dusting composition applied to the cooked saccharide region, the elastomeric region, and/or the confectionery composition.

In some embodiments, a texture modifying component can include a particulate material. Suitable particulate materials can include, but are not limited to, sucrose, polyols such as sorbitol, xylitol, mannitol, galactitol, lactitol, maltitol, erythritol, isomalt, hydrogenated starch hydrolysates and mixtures thereof, starches, proteins, and combinations thereof. In some embodiments, the particulate material serving as a texture modifying component is selected based on its ability or lack of ability to crystallize the saccharides in the cooked saccharide region. For example, when isomalt is included in the cooked saccharide region, sorbitol powder can be added to the confectionery composition because it will not cause the isomalt to crystallize. Alternatively, when erythritol is included in the cooked saccharide region, erythritol powder can be added to the confectionery composition because it will cause the erythritol to crystallize. Such particulates can be included in amounts from 5% to 35% w/w of the confectionery composition.

In some embodiments, a particulate texture modifying component can also include a flavoring component. For example, in embodiments where sorbitol is used as a texture modifying component, peppermint flavoring can be added to the sorbitol powder.

In some embodiments, a texture modifying component can include fats, oils, or other hydrophobic materials. Suitable fats can include, but are not limited to, partially hydrogenated vegetable or animal fats, such as coconut oil, corn oil, palm kernel oil, peanut oil, soy bean oil, sesame oil, cottonseed oil, cocoa butter, milk fat beef tallow, and lard, among others. Suitable hydrophobic materials include chocolate, chocolate crumb, carob coatings, and compound coatings. Such fats, oils, and/or hydrophobic materials can be included in amounts of 1% to 10% w/w of the confectionery composition.

In some embodiments, the sensory perception of the texture modifying component is similar to that of fat, oil, or other hydrophobic materials even though the texture modifying component is present in the confectionery composition at a lower level. For example, a confectionery composition including 2.5% hydrogenated cottonseed oil can provide the same mouthfeel perception as a confection including 10%-50% fat as measured by sensory evaluation techniques.

In some embodiments, a texture modifying component is incorporated into the confectionery composition when the cooked saccharide composition is being mixed with the elastomeric composition.

Appearance

In some embodiments, a confectionery composition including a cooked saccharide region and an elastomeric region provides a desired appearance. For example, in some embodiments, an exterior surface of a confectionery composition provides a desired level or shine or gloss. Appearance aspects of shine and gloss can be measured by a variety of methods such as optometric methods including, but not limited to, reflectance meters, spectophotometers, and consumer testing.

In some embodiments, a confectionery composition can be configured to include a cooked saccharide region and an elastomeric region that have been adjusted to be visually different.

The features and advantages of the present invention are more fully shown by the following examples which are provided for purposes of illustration, and are not to be construed as limiting the invention in any way.

### EXAMPLES

### Examples 1-78

The following examples 1-78 include a variety of modified release components, which may be used in dusting compositions. More specifically, a variety of different components, which may be used as dusting components, are encapsulated with encapsulating materials in the following examples. These dusting compositions may be applied to any form of chewing gum product described herein.

For instance, Example 6 provides encapsulated malic acid. The encapsulated malic acid of Example 6 could be used to dust one or more regions of a center-fill gum, for example. Multiple dusting compositions also may be employed.

Moreover, any of the encapsulated components provided in Examples 1-78 could be combined with the same component in its unencapsulated form to provide a dusting composition. For example, the encapsulated xylitol of Example 2 could be combined with unencapsulated xylitol to form a dusting composition. This composition could be used to dust a chewing gum product, such as a center-fill gum, compressed gum, candy gum, or the like.

### Ingredient Examples

### Ingredient Examples of Single Ingredients in a Delivery System.

EXAMPLE 1
Encapsulation of Glycyrrhizin - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Glycyrrhizin | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Glycyrrhizin is then added to the resulting mixture and mixed under high shear to completely disperse the | |
| # ingredients. The resulting filled polymer melt is cooled and ground to produce a powdered material with a particle size of less than 420 microns. The encapsulated Glycyrrhizin matrix is stored in air tight containers with low humidity below 35° C. | |

EXAMPLE 2
Encapsulation of Xylitol - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Xylitol | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Xylitol is then added to the resulting mixture and mixed under high shear to completely disperse the ingredients. The | |
| # resulting filled polymer melt is cooled and ground to produce a powdered material with a particle size of less than 420 microns. The encapsulated xylitol matrix is stored in air tight containers with low humidity below 35° C. | |

EXAMPLE 3
Encapsulation of Erythritol

| Composition: | |
|---|---|
| Ingredient | Weight percent |
| Polyvinyl Acetate | 55.00% |
| Hydrogenated Oil | 3.75% |
| Glycerol Monostearate | 1.25% |
| Erythritol | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Erythritol are then added to the resulting mixture and mixed under high shear to completely disperse the | |
| # ingredients. The resulting filled polymer melt is cooled and ground to produce a powdered material with a particle size of less than 420 microns. The erythritol encapsulation matrix is stored in air tight containers with low humidity below 35° C. | |

EXAMPLE 4
Encapsulation of Adipic acid - Polyvinyl acetate matrix

| Composition: | |
|---|---|
| Ingredient | Weight percent |
| Polyvinyl Acetate | 60.00% |
| Hydrogenated Oil | 3.75% |
| Glycerol Monostearate | 1.25% |
| Adipic acid | 35.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Adipic acid is then added to the resulting mixture and mixed under high shear to completely disperse the | |
| # ingredients. The resulting filled polymer melt is cooled and ground to produce a powdered material with a particle size of less than 420 microns. The encapsulated adipic acid matrix is stored in air tight containers with low humidity below 35° C. | |

EXAMPLE 5
Encapsulation of Citric Acid - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Citric Acid | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Citric acid is then added to the resulting mixture and mixed under high shear to completely disperse the ingredients. The | |
| # resulting filled polymer melt is cooled and ground to produce a powdered material with a particle size of less than 420 microns. The encapsulated citric acid matrix is stored in air tight containers with low humidity below 35° C. | |

EXAMPLE 6
Encapsulation of Malic acid - Polyvinyl acetate.

| Composition: | |
|---|---|
| Ingredient | Weight percent |
| Polyvinyl Acetate | 55.00% |
| Hydrogenated Oil | 3.75% |
| Glycerol Monostearate | 1.25% |
| Malic acid | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Malic acid are then added to the resulting mixture and mixed under high shear to completely disperse the ingredients. The | |
| # resulting filled polymer melt is cooled and ground to produce a powdered material with a particle size of less than 420 microns. The malic acid encapsulation matrix is stored in air tight containers with low humidity below 35° C. | |

EXAMPLE 7
Encapsulation of Spray dried peppermint flavor - Polyvinyl acetate

| Composition: | |
|---|---|
| Ingredient | Weight percent |
| Polyvinyl Acetate | 75.00% |
| Hydrogenated Oil | 3.75% |
| Glycerol Monostearate | 1.25% |
| Spray dried peppermint flavor | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Spray dried peppermint flavor is then added to the resulting mixture and mixed under high shear to completely disperse | |
| # the ingredients. The resulting filled polymer melt is cooled and ground to produce a powdered material with a particle size of less than 420 microns. The encapsulated peppermint flavor in Polyvinyl acetate matrix is stored in air tight containers with low humidity below 35° C. | |

EXAMPLE 8
Encapsulation of Spray dried strawberry flavor - Polyvinyl acetate

| Composition: | |
|---|---|
| Ingredient | Weight percent |
| Polyvinyl Acetate | 55.00% |
| Hydrogenated Oil | 3.75% |
| Glycerol Monostearate | 1.25% |
| Spray dried strawberry flavor | 40.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Spray dried strawberry flavor is then added to the resulting mixture and mixed under high shear to completely disperse | |
| # the ingredients. The resulting filled polymer melt is cooled and ground to produce a powdered material with a particle size of less than 420 microns. The encapsulated strawberry flavor is stored in air tight containers with low humidity below 35° C. | |

EXAMPLE 9
Encapsulation of Monosodium Glutamate

| Composition: | |
|---|---|
| Ingredient | Weight percent |
| Polyvinyl Acetate | 55.00% |
| Hydrogenated Oil | 3.75% |
| Glycerol Monostearate | 1.25% |
| Monosodium glutamate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Monosodium glutamate is then added to the resulting mixture and mixed under high shear to completely disperse the | |
| # ingredients. The resulting filled polymer melt is cooled and ground to produce a powdered material with a particle size of less than 420 microns. The encapsulation matrix is stored in air tight containers with low humidity below 35° C. | |

EXAMPLE 10
Encapsulation of Salt - Polyvinyl acetate matrix

| Composition: | |
|---|---|
| Ingredient | Weight percent |
| Polyvinyl Acetate | 60.00% |
| Hydrogenated Oil | 3.75% |
| Glycerol Monostearate | 1.25% |
| Sodium chloride | 35.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium chloride is then added to the resulting mixture and mixed under high shear to completely disperse the | |
| # ingredients. The resulting filled polymer melt is cooled and ground to produce a powdered material with a particle size of less than 420 microns. The encapsulated matrix is stored in air tight containers with low humidity below 35° C. | |

EXAMPLE 11
Encapsulation of Sodium acid sulfate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium acid sulfate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium acid sulfate is then added to the resulting mixture and mixed under high shear to completely disperse the ingredients. The resulting filled polymer melt is cooled and ground to produce a powdered | |
| # material with a particle size of less than 420 microns. The encapsulated matrix is stored in air tight containers with low humidity below 35° C. | |

EXAMPLE 12
Encapsulation of WS-3 in Polyvinyl acetate.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Cooling sensate WS-3 | 30.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. WS-3 is then added to the resulting mixture and mixed under high shear to completely disperse the ingredients. The resulting encapsulation is cooled and ground to produce a powdered material with a particle size | |
| # of less than 420 microns. The malic acid encapsulation matrix is stored in air tight containers with low humidity below 35° C. | |

EXAMPLE 13
Encapsulation of WS-23 - Polyvinyl acetate matrix

| Composition: | |
|---|---|
| Ingredient | Weight percent |
| Polyvinyl Acetate | 65.00% |
| Hydrogenated Oil | 3.75% |
| Glycerol Monostearate | 1.25% |
| Cooling sensate WS-23 | 30.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. WS-23 is then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 14
Encapsulation of menthol - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Menthol | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Menthol crystals is then added to the resulting mixture and mixed under high shear to completely disperse the ingredients. The resulting polymer melt is cooled and ground to produce a powdered material | |
| # with a particle size of less than 420 microns. The encapsulated menthol matrix is stored in air tight containers with low humidity below 35° C. | |

EXAMPLE 15
Encapsulation of Caffeine - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Caffeine | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Caffeine is then added to the resulting mixture and mixed under high shear to completely disperse the ingredients. The resulting polymer melt is cooled and ground to produce a powdered material with a particle size | |
| # of less than 420 microns. The encapsulated caffeine matrix is stored in air tight containers with low humidity below 35° C. | |

EXAMPLE 16
Encapsulation of Ascorbic Acid - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Ascorbic Acid | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Ascorbic Acid is then added to the resulting mixture and mixed under high shear to completely disperse the ingredients. The resulting polymer melt is cooled and ground to produce a powdered material | |
| # with a particle size of less than 420 microns. The encapsulated Ascorbic Acid matrix is stored in air tight containers with low humidity below 35° C. | |

EXAMPLE 17
Encapsulation of Calcium Lactate - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Calcium Lactate | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Calcium Lactate is then added to the resulting mixture and mixed under high shear to completely disperse the ingredients. The resulting polymer melt is cooled and ground to produce a powdered material | |
| # with a particle size of less than 420 microns. The encapsulated Calcium Lactate matrix is stored in air tight containers with low humidity below 35° C. | |

EXAMPLE 18
Encapsulation of Zinc Citrate - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Zinc Citrate | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Zinc Citrate is then added to the resulting mixture and mixed under high shear to completely disperse the ingredients. The resulting polymer melt is cooled and ground to produce a powdered material | |
| # with a particle size of less than 420 microns. The encapsulated Zinc Citrate matrix is stored in air tight containers with low humidity below 35° C. | |

EXAMPLE 19
Encapsulation of Niacin - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Niacin | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Niacin is then added to the resulting mixture and mixed under high shear to completely disperse the ingredients. The resulting polymer melt is cooled and ground to produce a powdered material with a particle size | |
| # of less than 420 microns. The encapsulated Niacin matrix is stored in air tight containers with low humidity below 35° C. | |

EXAMPLE 20
Encapsulation of Pyridoxine - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Pyridoxine | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Pyridoxine is then added to the resulting mixture and mixed under high shear to completely disperse the ingredients. The resulting polymer melt is cooled and ground to produce a powdered material with a particle size | |
| # of less than 420 microns. The encapsulated Pyridoxine matrix is stored in air tight containers with low humidity below 35° C. | |

EXAMPLE 21
Encapsulation of Thiamine - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Thiamine | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Thiamine is then added to the resulting mixture and mixed under high shear to completely disperse the ingredients. The resulting polymer melt is cooled and ground to produce a powdered material with a particle size | |
| # of less than 420 microns. The encapsulated Thiamine matrix is stored in air tight containers with low humidity below 35° C. | |

EXAMPLE 22
Encapsulation of Riboflavin - Polyvinyl acetate matrix

| Composition: | |
|---|---|
| Ingredient | Weight percent |
| Polyvinyl Acetate | 75.00% |
| Hydrogenated Oil | 3.75% |
| Glycerol Monostearate | 1.25% |
| Riboflavin | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Riboflavin is then added to the resulting mixture and mixed under high shear to completely disperse the ingredients. The resulting polymer melt is cooled and ground to produce a powdered material with a particle size | |
| # of less than 420 microns. The encapsulated Riboflavin matrix is stored in air tight containers with low humidity below 35° C. | |

EXAMPLE 23
Encapsulation of Sucralose - Polyvinyl acetate matrix (Sucralose 20%).

| Composition: | |
|---|---|
| Ingredient | Weight percent |
| Polyvinyl Acetate | 77.00% |
| Hydrogenated Oil | 3.00% |
| Sucralose | 20.00% |
| Total | 100.00% |
| Procedure: Polyvinyl acetate is melted at a temperature of about 85° C. in a high shear mixer such as extruder (single or twin screw) or sigma or Banbury mixer. The hydrogenated oil is added to the molten polyvinyl acetate. Sucralose is then added to the resulting mixture and mixed under high shear to completely disperse the ingredients. The resulting filled polymer melt is cooled and ground to produce a powdered material with a particle size of less than 590 | |
| # microns. The encapsulated sucralose matrix is stored in air tight containers with low humidity below 35° C. | |

EXAMPLE 24
Multiple encapsulation of sucralose/polyvinyl acetate matrix (from
example 23).

| Composition: | |
|---|---|
| Ingredient | Grams |
| Center Cores | |
| Sucralose/Polymer Matrix (from Example 23) | 700.0 |
| Coating Solution | |
| Purified Water | 1168.0 |
| Gum Arabic | 293.0 |
| Total Coating solution | 1461.0 |
| Procedure: Wurster process is used to encapsulate Sucralose/Polymer Matrix. Coating solution using the above mentioned recipe is prepared by stirring water and gum at 35° C. for 2 hrs. 700 gms of Sucralose//Polymer Matrix are suspended in a fluidizing air stream which provide generally cyclic flow in front of a spray nozzle. The spray nozzle sprays an atomized flow of 1461 gms of the coating solution for 115 minutes. The coated particles are then dried in the | |
| # fluidized chamber for 50 minutes and stored below 35° C. under dry conditions. | |

EXAMPLE 25 A
High Tensile strength encapsulation of Aspartame - Polyvinyl acetate
matrix (Aspartame 30%). Particle size less than 420 microns.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame is then added to the resulting mixture and mixed under high shear to completely disperse the ingredients. The resulting high tensile strength/low fat content encapsulation is cooled and ground to produce a | |
| # powdered material with a particle size of less than 420 microns. | |

EXAMPLE 25 B
Low Tensile Strength encapsulation of Aspartame - Polyvinyl acetate
matrix (Aspartame 30%)

| Composition: | |
|---|---|
| Ingredient | Weight percent |
| Polyvinyl Acetate | 50.00% |
| Hydrogenated Oil | 10.00% |
| Glycerol Monostearate | 10.00% |
| Aspartame | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame is then added to the resulting mixture and mixed under high shear to completely disperse the ingredients. The resulting low Tensile Strength encapsulation is cooled and ground to produce a powdered | |
| # material with a particle size of less than 420 microns. | |

EXAMPLE 25 C
High Tensile strength encapsulation of Aspartame - Polyvinyl acetate
matrix (Aspartame 30%). Particle size less than 177 microns.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame is then added to the resulting mixture and mixed under high shear to completely disperse the ingredients. The resulting high tensile strength/low fat content encapsulation is cooled and ground to produce a | |
| # powdered material with a particle size of less than 177 microns. | |

EXAMPLE 26
Encapsulation of AceK - Polyvinyl acetate matrix (AceK 30%)

| Composition: | |
|---|---|
| Ingredient | Weight percent |
| Polyvinyl Acetate | 65.00% |
| Hydrogenated Oil | 3.75% |
| Glycerol Monostearate | 1.25% |
| AceK | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. AceK is then added to the resulting mixture and mixed under high shear to completely disperse the ingredients. The resulting filled polymer melt is cooled and ground to produce a powdered material with a | |
| # particle size of less than 420 microns. The encapsulated AceK matrix is stored in air tight containers with low humidity below 35° C. | |

EXAMPLE 27
Encapsulation of Neotame - Polyvinyl acetate matrix (Neotame 10%)

| Composition: | |
|---|---|
| Ingredient | Weight percent |
| Polyvinyl Acetate | 75.00% |
| Hydrogenated Oil | 10.00% |
| Glycerol Monostearate | 5.00% |
| Neotame | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Neotame is then added to the resulting mixture and mixed under high shear to completely disperse the ingredients. The resulting filled polymer melt is cooled and ground to produce a powdered material with a | |
| # particle size of less than 420 microns. The encapsulated Neotame polymer encapsulation particles are stored in air tight containers with low humidity below 35° C. | |

EXAMPLE 28
Encapsulation of Pectin in Polyvinyl acetate matrix (Pectin 30%)

| Composition: | |
|---|---|
| Ingredient | Weight percent |
| Polyvinyl Acetate | 65.00% |
| Hydrogenated Oil | 3.75% |
| Glycerol Monostearate | 1.25% |
| Pectin | 30.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Pectin is then added to the resulting mixture and mixed under high shear to completely disperse the ingredients. The resulting filled polymer melt is cooled and ground to produce a powdered material with a | |
| # particle size of less than 420 microns. The encapsulated pectin polymer encapsulation particles are stored in air tight containers with low humidity below 35° C. | |

### Ingredient Examples of Multiple Ingredients in a Delivery System.

EXAMPLE 29
Encapsulation of Aspartame, Ace-K, and Sucralose

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| AceK | 10.00% |
| Sucralose | 10.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame, Ace-K, and Sucralose are then added to the resulting mixture and mixed under high shear to completely disperse the ingredients. The resulting filled polymer melt is cooled and ground to produce a | |
| # powdered material with a particle size of less than 420 microns. The encapsulated sweeteners are stored in air tight containers with low humidity below 35° C. | |

EXAMPLE 30
Encapsulation of Aspartame, Ace-K, and Glycyrrhizin

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| Ace-K | 10.00% |
| Glycyrrhizin | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame, Ace-K, and Glycyrrhizin are then added to the resulting mixture and mixed under high shear to completely disperse the ingredients. The resulting filled polymer melt is cooled and ground to produce a | |
| # powdered material with a particle size of less than 420 microns. The encapsulated sweeteners are stored in air tight containers with low humidity below 35° C. | |

EXAMPLE 31
Encapsulation of Aspartame, Ace-K, and Menthol

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| Ace-K | 10.00% |
| Menthol | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame, Ace-K, and Menthol are then added to the resulting mixture and mixed under high shear to completely disperse the ingredients. The resulting filled polymer melt is cooled and ground to produce a | |
| # powdered material with a particle size of less than 420 microns. The encapsulated sweeteners are stored in air tight containers with low humidity below 35° C. | |

EXAMPLE 32
Encapsulation of Aspartame, Ace-K, and Adipic Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 10.00% |
| Ace-K | 5.00% |
| Adipic acid | 25.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame, Ace-K, and Adipic Acid are then added to the resulting mixture and mixed under high shear to completely disperse the ingredients. The resulting filled polymer melt is cooled and ground to produce a | |
| # powdered material with a particle size of less than 420 microns. The encapsulated sweeteners are stored in air tight containers with low humidity below 35° C. | |

EXAMPLE 33
Encapsulation of Adipic, Citric, and Malic Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Adipic Acid | 10.00% |
| Citric Acid | 20.00% |
| Malic Acid | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Adipic, Citric, and Malic Acid are then added to the resulting mixture and mixed under high shear to completely disperse the ingredients. The resulting filled polymer melt is cooled and ground to produce a powdered | |
| # material with a particle size of less than 420 microns. The encapsulated acids are stored in air tight containers with low humidity below 35° C. | |

EXAMPLE 34
Encapsulation of Sucralose, and Citric Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sucralose | 10.00% |
| Citric Acid | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sucralose and Citric Acid are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 35
Encapsulation of Sucralose and Adipic Acid

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sucralose | 10.00% |
| Adipic Acid | 30.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Sucralose and Adipic Acid are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 36
Encapsulation of Aspartame and Salt

| Composition: | |
|---|---|
| Ingredient | Weight percent |
| Polyvinyl Acetate | 55.00% |
| Hydrogenated Oil | 3.75% |
| Glycerol Monostearate | 1.25% |
| Aspartame | 20.00% |
| Salt | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Salt are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 37
Encapsulation of Aspartame with WS-3

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 20.00% |
| WS-3 | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame and WS-3 are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 38
Encapsulation of Sucralose with WS-23

| Composition: | |
|---|---|
| Ingredient | Weight percent |
| Polyvinyl Acetate | 75.00% |
| Hydrogenated Oil | 3.75% |
| Glycerol Monostearate | 1.25% |
| Sucralose | 10.00% |
| WS-23 | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sucralose and WS-23 are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 39
Encapsulation of Sucralose and Menthol

| Composition: | |
|---|---|
| Ingredient | Weight percent |
| Polyvinyl Acetate | 70.00% |
| Hydrogenated Oil | 3.75% |
| Glycerol Monostearate | 1.25% |
| Sucralose | 10.00% |
| Menthol | 15.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sucralose and Menthol are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 40
Encapsulation of Aspartame and Neotame

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 30.00% |
| Neotame | 5.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Aspartame and Neotame are then added to the resulting mixture and mixed under high shear to completely disperse the ingredients. The resulting encapsulation is cooled and ground to produce a powdered material | |
| # with a particle size of less than 420 microns. The encapsulation matrix is stored in air tight containers with low humidity below 35° C. | |

EXAMPLE 41
Encapsulation of Aspartame and Adenosine
monophosphate (bitterness inhibitor)

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 20.00% |
| Adenosine monophosphate (AMP) | 10.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and AMP are then added to the resulting mixture and mixed under high shear to completely disperse the ingredients. The resulting filled polymer melt is cooled and ground to produce a powdered | |
| # material with a particle size of less than 420 microns. The encapsulation is stored in air tight containers with low humidity below 35° C. | |

EXAMPLE 42
Encapsulation of Aspartame and Caffeine

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 20.00% |
| Caffeine | 15.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Caffeine are then added to the resulting mixture and mixed under high shear to completely disperse the ingredients. The resulting polymer melt is cooled and ground to produce a powdered material | |
| # with a particle size of less than 420 microns. The encapsulation is stored in air tight containers with low humidity below 35° C. | |

EXAMPLE 43
Encapsulation of sucralose and Calcium Lactate

| Composition: | |
|---|---|
| Ingredient | Weight percent |
| Polyvinyl Acetate | 55.00% |
| Hydrogenated Oil | 3.75% |
| Glycerol Monostearate | 1.25% |
| sucralose | 10.00% |
| Calcium Lactate | 30.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Calcium Lactate are then added to the resulting mixture and mixed under high shear to completely disperse the ingredients. The resulting polymer melt is cooled and ground to produce a | |
| # powdered material with a particle size of less than 420 microns. The encapsulation is stored in air tight containers with low humidity below 35° C. | |

EXAMPLE 44
Encapsulation of Sucralose and Vitamin C

| Composition: | |
|---|---|
| Ingredient | Weight percent |
| Polyvinyl Acetate | 65.00% |
| Hydrogenated Oil | 3.75% |
| Glycerol Monostearate | 1.25% |
| Sucralose | 10.00% |
| Ascorbic Acid (Vitamin C) | 20.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Sucralose and Ascorbic Acid is then added to the resulting mixture and mixed under high shear to completely disperse the ingredients. The resulting polymer melt is cooled and ground to produce a powdered material | |
| # with a particle size of less than 420 microns. The encapsulation is stored in air tight containers with low humidity below 35° C. | |

EXAMPLE 45
Encapsulation of Aspartame and Niacin

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 15.00% |
| Niacin | 15.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Aspartame and Niacin are then added to the resulting mixture and mixed under high shear to completely disperse the ingredients. The resulting polymer melt is cooled and ground to produce a powdered material | |
| # with a particle size of less than 420 microns. The encapsulation is stored in air tight containers with low humidity below 35° C. | |

EXAMPLE 46
Encapsulation of sucralose and Folic Acid

| Composition: | |
|---|---|
| Ingredient | Weight percent |
| Polyvinyl Acetate | 75.00% |
| Hydrogenated Oil | 3.75% |
| Glycerol Monostearate | 1.25% |
| Sucralose | 10.00% |
| Folic Acid | 10.00% |
| Total | 100.00% |
| Procedure: Polyvinyl acetate is melted at a temperature of about 90° C. in a high shear mixer such as extruder (single or twin screw) or sigma or Banbury mixer. The hydrogenated oil and Glycerol monostearate are then added to the molten polyvinyl acetate. Sucralose and Folic Acid are then added to the resulting mixture and mixed under high shear to completely disperse the ingredients. The resulting polymer melt is cooled and ground to produce a powdered material | |
| # with a particle size of less than 420 microns. The encapsulation is stored in air tight containers with low humidity below 35° C. | |

EXAMPLE 47
Encapsulation of mixed Aspartame and AceK - Polyvinyl
acetate matrix (Actives = 30%)

| Composition: | |
|---|---|
| Ingredient | Weight percent |
| Polyvinyl Acetate | 65.00% |
| Hydrogenated Oil | 3.75% |
| Glycerol Monostearate | 1.25% |
| Aspartame | 21.00% |
| AceK | 9.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Aspartame and AceK (60/40) are then added to the resulting mixture and mixed under high shear to completely disperse the ingredients. The resulting filled polymer melt is cooled and ground to produce a | |
| # powdered material with a particle size of less than 420 microns. The mixed Aspartame and AceK encapsulation matrix is stored in air tight containers with low humidity below 35° C. | |

EXAMPLE 48
Encapsulation of mixed WS-3 and WS-23 - Polyvinyl acetate matrix.

| Composition: | |
|---|---|
| Ingredient | Weight percent |
| Polyvinyl Acetate | 65.00% |
| Hydrogenated Oil | 3.75% |
| Glycerol Monostearate | 1.25% |
| Cooling sensate WS-3 | 15.00% |
| Cooling sensate WS-23 | 15.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. WS-3 and WS-23 are then added to the resulting mixture and mixed under high shear to completely disperse the ingredients. The resulting filled polymer melt is cooled and ground to produce a powdered | |
| # material with a particle size of less than 420 microns. The mixed WS-3 and WS-23 encapsulation matrix is stored in air tight containers with low humidity below 35° C. | |

EXAMPLE 49
Encapsulation of mixed Aspartame and
Calciumcarbonate - Polyvinyl acetate matrix.

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 20.00% |
| Calciumcarbonate | 15.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Aspartame and calcium carbonate are then added to the resulting mixture and mixed under high shear to completely disperse the ingredients. The resulting filled polymer melt is cooled and ground to produce a powdered material with a | |
| # particle size of less than 420 microns. The mixed aspartame and calcium carbonate encapsulation matrix is stored in air tight containers with low humidity below 35° C. | |

EXAMPLE 50
Encapsulation of mixed Aspartame and Talc -
Polyvinyl acetate matrix.

| Composition: | |
|---|---|
| Ingredient | Weight percent |
| Polyvinyl Acetate | 60.00% |
| Hydrogenated Oil | 3.75% |
| Glycerol Monostearate | 1.25% |
| Aspartame | 20.00% |
| Talc | 15.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Aspartame and talc are then added to the resulting mixture and mixed under high shear to completely disperse the ingredients. The resulting filled polymer melt is cooled and ground to produce a powdered material with a particle size | |
| # of less than 420 microns. The mixed aspartame and talc encapsulation matrix is stored in air tight containers with low humidity below 35° C. | |

### Ingredient Examples of Single Oral Care Ingredients in a Delivery System.

EXAMPLE 51
Encapsulation of Sodium tripolyphosphate
(Sodiumtripolyphosphate) - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodiumtripolyphosphate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodiumtripolyphosphate is then added to the resulting mixture and mixed under high shear to completely disperse the ingredients. The resulting filled polymer melt is cooled and ground to produce a powdered material with a particle | |
| # size of less than 420 microns. The encapsulated matrix is stored in air tight containers with low humidity below 35° C. | |

EXAMPLE 52
Encapsulation of Sodium Fluoride (NaF) - Polyvinyl acetate matrix

| Composition: | |
|---|---|
| Ingredient | Weight percent |
| Polyvinyl Acetate | 65.00% |
| Hydrogenated Oil | 3.75% |
| Glycerol Monostearate | 1.25% |
| Sodium Fluoride | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. NaF is then added to the resulting mixture and mixed under high shear to completely disperse the ingredients. The resulting filled polymer melt is cooled and ground to produce a powdered material with a particle size of less than | |
| # 420 microns. The encapsulated matrix is stored in air tight containers with low humidity below 35° C. | |

EXAMPLE 53
Encapsulation of Calcium peroxide - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Calcium Peroxide | 40.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Calcium peroxide is then added to the resulting mixture and mixed under high shear to completely disperse the ingredients. The resulting filled polymer melt is cooled and ground to produce a powdered material with a particle size of | |
| # less than 420 microns. The encapsulated matrix is stored in air tight containers with low humidity below 35° C. | |

EXAMPLE 54
Encapsulation of Zinc Chloride - Polyvinyl acetate matrix

| Composition: | |
|---|---|
| Ingredient | Weight percent |
| Polyvinyl Acetate | 65.00% |
| Hydrogenated Oil | 3.75% |
| Glycerol Monostearate | 1.25% |
| Zinc Chloride | 30.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. zinc chloride is then added to the resulting mixture and mixed under high shear to completely disperse the ingredients. The resulting filled polymer melt is cooled and ground to produce a powdered material with a particle size of | |
| # less than 420 microns. The encapsulated matrix is stored in air tight containers with low humidity below 35° C. | |

EXAMPLE 55:
Encapsulation of Carbamide peroxide - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Carbamide Peroxide | 40.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Carbamide peroxide is then added to the resulting mixture and mixed under high shear to completely disperse the ingredients. The resulting filled polymer melt is cooled and ground to produce a powdered material with a particle size | |
| # of less than 420 microns. The encapsulated matrix is stored in air tight containers with low humidity below 35° C. | |

EXAMPLE 56
Encapsulation of Potassium Nitrate (KNO3) -
Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Potassium Nitrate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. KNO3 is then added to the resulting mixture and mixed under high shear to completely disperse the ingredients. The resulting filled polymer melt is cooled and ground to produce a powdered material with a particle size of less than | |
| # 420 microns. The encapsulated matrix is stored in air tight containers with low humidity below 35° C. | |

EXAMPLE 57
Encapsulation of Chlorhexidine - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Chlorhexidine | 40.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Chlorhexidine is then added to the resulting mixture and mixed under high shear to completely disperse the ingredients. The resulting filled polymer melt is cooled and ground to produce a powdered material with a particle size of | |
| # less than 420 microns. The encapsulated matrix is stored in air tight containers with low humidity below 35° C. | |

EXAMPLE 58
Encapsulation of sodium stearate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium stearate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium stearate is then added to the resulting mixture and mixed under high shear to completely disperse the ingredients. The resulting filled polymer melt is cooled and ground to produce a powdered material with a particle size of | |
| # less than 420 microns. The encapsulated matrix is stored in air tight containers with low humidity below 35° C. | |

EXAMPLE 59
Encapsulation of Sodium Bicarbonate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium Bicarbonate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. NaHCO3 is then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 60
Encapsulation of Cetylpridinium chloride (CPC) -
Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Cetylpridinium chloride | 40.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. CPC is then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 61
Encapsulation of Calcium Casein Peptone-Calcium Phosphate
CCP-CP (Recaldent) - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Recaldent | 40.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Recaldent is then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 62
Encapsulation of sodium Ricinoleate - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium Ricinoleate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodium ricinoleate is then added to the resulting mixture and mixed under high shear to completely disperse the ingredients. The resulting filled polymer melt is cooled and ground to produce a powdered | |
| # material with a particle size of less than 420 microns. The encapsulated matrix is stored in air tight containers with low humidity below 35° C. | |

EXAMPLE 63
Encapsulation of sodium hexametaphosphate
(Sodiumhexamataphosphate) - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Sodium Hexametaphosphate | 40.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodiumhexamataphosphate is then added to the resulting mixture and mixed under high shear to completely disperse the ingredients. The resulting filled polymer melt is cooled and ground | |
| # to produce a powdered material with a particle size of less than 420 microns. The encapsulated matrix is stored in air tight containers with low humidity below 35° C. | |

EXAMPLE 64
Encapsulation of Urea - Polyvinyl acetate matrix

| Composition: | |
|---|---|
| Ingredient | Weight percent |
| Polyvinyl Acetate | 55.00% |
| Hydrogenated Oil | 3.75% |
| Glycerol Monostearate | 1.25% |
| Urea | 40.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Urea is then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

### Ingredient Examples of Multiple Oral Care Ingredients in a Delivery Systems.

EXAMPLE 65
Encapsulation of Sodiumtripolyphosphate (STP) and
sodium stearate-Polyvinyl acetate matrix.

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodiumtripolyphosphate | 20.00% |
| Sodium stearate | 10.00% |
| Sucralose | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 66
Encapsulation of Sodium Fluoride and
Sodiumtripolyphosphate - Polyvinyl acetate matrix

| Composition: | Weight |
|---|---|
| Ingredient | percent |
| Polyvinyl Acetate | 57.00% |
| Hydrogenated Oil | 3.75% |
| Glycerol Monostearate | 1.25% |
| Sodiumtripolyphosphate | 25.00% |
| Sodium Fluoride | 3.00% |
| Sucralose | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 67
Encapsulation of Calcium peroxide and
Sodiumhexamataphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Calcium Peroxide | 7.00% |
| Sodiumhexamataphosphate | 23.00% |
| Sucralose | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 68
Encapsulation of Zinc Chloride and
Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Zinc Chloride | 4.00% |
| Sodiumtripolyphosphate | 26.00% |
| Aspartame | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 69
Encapsulation of Carbamide peroxide and Sodiumtripolyphosphate in
Polyvinylacetate encapsulation.

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodiumtripolyphosphate | 20.00% |
| Carbamide Peroxide | 10.00% |
| Sucralose | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 70
Encapsulation of Potassium Nitrate (KNO3) and
Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Potassium Nitrate | 10.00% |
| Sodiumtripolyphosphate | 20.00% |
| Sucralose | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 71
Encapsulation of Chlorhexidine, Sodiumtripolyphosphate and Sodium
Fluoride - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Chlorhexidine | 4.00% |
| Sodiumtripolyphosphate | 23.00% |
| Sodium Fluoride | 3.00% |
| Aspartame | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 72
Encapsulation of sodium stearate, Sodiumtripolyphosphate and Menthol-
Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium stearate | 4.00% |
| Sodiumtripolyphosphate | 19.00% |
| Menthol | 7.00% |
| Sucralose | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 73
Encapsulation of Sodium Bicarbonate, Sodiumtripolyphosphate and
Sodium stearate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium stearate | 4.00% |
| Sodiumtripolyphosphate | 19.00% |
| Sodium bicarbonate | 7.00% |
| Sucralose | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 74
Encapsulation of Cetylpridinium chloride (CPC), Sodium Fluoride and
Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Cetylpridinium chloride | 4.00% |
| Sodiumtripolyphosphate | 23.00% |
| Sodium Fluoride | 3.00% |
| Sucralose | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 75
Encapsulation of Calcium Casein Peptone-Calcium Phosphate CCP-CP
(Recaldent) and Sodiumtripolyphosphate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Recaldent | 10.00% |
| Sodiumtripolyphosphate | 20.00% |
| Sucralose | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 76
Encapsulation of sodium Ricinoleate and Sodiumtripolyphosphate-
Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium Ricinoleate | 4.00% |
| Sodiumtripolyphosphate | 26.00% |
| Aspartame | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

EXAMPLE 77
Encapsulation of sodium hexametaphosphate (SHMP) and
Sodium Stearate - Polyvinyl acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Sodium Hexametaphosphate | 26.00% |
| Sodium stearate | 4.00% |
| Sucralose | 10.00% |
| Total | 100.00% |
| Procedure: Polyvinyl acetate is melted at a temperature of about 110° C. in a high shear mixer such as extruder (single or twin screw) or sigma or Banbury mixer. The hydrogenated oil and Glycerol monostearate are then added to the molten polyvinyl acetate. Sodiumhexamataphosphate is then added to the resulting mixture and mixed under high shear to completely disperse the ingredients. The resulting filled polymer melt is cooled and ground | |
| # to produce a powdered material with a particle size of less than 420 microns. The encapsulated matrix is stored in air tight containers with low humidity below 35° C. | |

EXAMPLE 78
Encapsulation of Urea and Sodiumtripolyphosphate - Polyvinyl
acetate matrix

| Composition: | Weight |
|---|---|
| Ingredient | percent |
| Polyvinyl Acetate | 55.00% |
| Hydrogenated Oil | 3.75% |
| Glycerol Monostearate | 1.25% |
| Urea | 10.00% |
| Sodiumtripolyphosphate | 20.00% |
| Sucralose | 10.00% |
| Total | 100.00% |
| Procedure: Polyvinyl acetate is melted at a temperature of about 80° C. in a high shear mixer such as extruder (single or twin screw) or sigma or Banbury mixer. The hydrogenated oil and Glycerol monostearate are then added to the molten polyvinyl acetate. Actives are then added to the resulting mixture and mixed under high shear to completely disperse the ingredients. The resulting filled polymer melt is cooled and ground to produce a powdered material with a | |
| # particle size of less than 420 microns. The encapsulated matrix is stored in air tight containers with low humidity below 35° C. | |

### Examples 79-82

Examples 79-82 provide various chewing gum compositions, which are dusted by dusting compositions including some of the encapsulated components from Examples 1-78 above.

EXAMPLE 79
Chewing gum including dusting composition

| Chewing Gum Composition: | Weight |
|---|---|
| Ingredient | percent |
| Gum Base | 5-95% |
| Sweeteners | 30-70% |
| Intense Sweeteners | 0-3% |
| Flavors | 0.01-10% |
| Procedure: Gum is prepared in the following manner: The gum base is melted in a mixer. The remaining ingredients are added to the molten gum base. The melted gum base with ingredients is mixed to completely disperse the ingredients. The resulting chewing gum may be allowed to cool and divided into individual chewing gum pieces. The outer surface of the | |
| # individual chewing gum piece is dusted with a dusting composition including the encapsulated erythritol from Example 3 above. | |

EXAMPLE 80
Sugared chewing gum including dusting composition

| Chewing Gum Composition: | Weight |
|---|---|
| Ingredient | percent |
| Gum Base | 36 |
| Sugar Sweeteners | 60 |
| Peppermint Flavor | 3.5 |
| Menthol | 0.5 |
| Procedure: Gum is prepared in the following manner: The gum base is melted in a mixer. The remaining ingredients are added to the molten gum base. The melted gum base with ingredients is mixed to completely disperse the ingredients. The resulting chewing gum may be allowed to cool and divided into individual chewing gum pieces. The outer surface of the | |
| # individual chewing gum piece is dusted with a dusting composition including the encapsulated peppermint flavor from Example 7 above in combination with unencapsulated peppermint flavor. | |

EXAMPLE 81
Sugar-free chewing gum including dusting composition

| Chewing Gum Composition: | Weight |
|---|---|
| Ingredient | percent |
| Gum Base | 39.00 |
| Sorbitol | 43.18 |
| Mannitol | 9.00 |
| Flavor | 3.67 |
| Glycerin | 1.50 |
| Lecithin | 0.20 |
| Aspartame | 0.30 |
| AceK | 0.15 |
| Encapsulated Menthol (from Example 14) | 3.00 |
| Procedure: Gum is prepared in the following manner: The gum base is melted in a mixer. The remaining ingredients are added to the molten gum base. The melted gum base with ingredients is mixed to completely disperse the ingredients. The resulting chewing gum may be allowed to cool and divided into individual chewing gum pieces. The outer surface of the | |
| # individual chewing gum piece is dusted with a dusting composition including the encapsulated WS-23 (cooling sensate) from Example 13 above. | |

EXAMPLE 82
Compressed gum including dusting composition

| Single-Layer Pressed Gum Tablet: | Weight |
|---|---|
| Ingredient | percent |
| Particulate gum base/sorbitol | 70-90 |
| Sorbitol | 10-20 |
| Flavor | 0.5-3.0 |
| Modified Release Ingredient | 0.005-10.00 |
| Silicon dioxide | 0.1-0.5 |
| Magnesium stearate | 2-5 |
| Procedure: Single-layer chewing gum tablet is prepared in the following manner: The particulate gum base and sorbitol are combined with the modified release ingredient, and flavor. The combination is blended for about twelve minutes. The batch is then passed through a size 14 mesh screen. Silicon dioxide is added to the screened batch and the batch is | |
| # blended for about five minutes. The magnesium stearate is divided in half and added to the batch in two portions. After each portion of magnesium stearate is added, the batch is blended for about five minutes until the desirable particulate consistency is achieved. The batch is then filled into the compression apparatus (Piccola Model D-8 mini rotary tablet press) and | |
| # compressed into a gum tablet. The outer surface of the gum tablet is dusted with a dusting composition including the encapsulated mixture of aspartame, Ace-K and menthol from Example 31 above. | |

### Examples 83-90

Examples 83-90 provide various center-fill chewing gum compositions, which are dusted by dusting compositions including some of the encapsulated components from Examples 1-78 above.

TABLE 1
Gum Region Composition

| | % by weight | | | | | | | |
|---|---|---|---|---|---|---|---|---|
| Component | 83 | 84 | 85 | 86 | 87 | 88 | 89 | 90 |
| Gum base* | 28-42 | 28-42 | 28-42 | 28-42 | 28-42 | 28-42 | 28-42 | 28-42 |
| Lecithin | 0.1-0.25 | 0.1-0.25 | 0.05-0.1 | 0.05-0.1 | 0.05-0.1 | 0.05-0.1 | 0.05-0.1 | 0.05-0.1 |
| Maltitol | 52-55 | 45-50 | 46-50 | 50-54 | 52-57 | 45-55 | 47-52 | 50-55 |
| Sorbitol | 0 | 0-10 | 5-10 | 0-5 | 0-5 | 5-10 | 0-5 | 0-5 |
| Lycasin ™ | 0 | 0 | 0.25-0.5 | 0.25-0.5 | 0.25-0.5 | 0.1-0.25 | 0.1-0.25 | 0.1-0.25 |
| Flavors | 2.50-3 | 2.50-3 | 2-2.26 | 2-2.26 | 2-2.26 | 2-2.50 | 2-2.50 | 2-2.50 |
| Cooling | 0.08-0.1 | 0.08-0.1 | 0 | 0 | 0 | 0.08-0.1 | 0.08-0.1 | 0.08-0.1 |
| agent | | | | | | | | |
| Acidulants | 1.2-1.7 | 1.2-1.7 | 0 | 0 | 0 | 0.7-1.2 | 0.7-1.2 | 0.7-1.2 |
| Intense | 3.4-3.9 | 3.4-3.9 | 3.4-3.9 | 2.9-3.4 | 2.9-3.4 | 2.9-3.4 | 2.9-3.4 | 3.4-3.9 |
| sweetener | | | | | | | | |

*gum base may include 3% to 11% by weight of a filler such as, for example, talc, dicalcium, phosphate, and calcium carbonate (the amount of filler in the gum base is based on the weight percent of the gum region composition, for example, in the above compositions A-H, if a gum region composition includes 5% filler, the amount of gum base will be 5% less than the range recited in the table, i.e., from 23-37%)

TABLE 2
Liquid-fill Composition

| | % by weight | | | | | | | |
|---|---|---|---|---|---|---|---|---|
| Component | 83 | 84 | 85 | 86 | 87 | 88 | 89 | 90 |
| Glycerin | 63.00 | 63.00 | 63.00 | 30.00 | 63.00 | 63.00 | 1.50 | 63.00 |
| Lycasin ™ | 29.26 | 29.26 | 29.49 | 56.00 | 29.49 | 29.17 | 65.22 | 29.17 |
| Sorbitol solution | 3.25 | 3.25 | 3.28 | 7.50 | 3.28 | 3.24 | 28.60 | 3.24 |
| Sodium carboxymethyl | 0.08 | 0.008 | 0.15 | 0.25 | 0.15 | 0.20 | 0.20 | 0.20 |
| cellulose | | | | | | | | |
| Color | 0.004 | 0.004 | 0.0004 | 0.004 | 0.0004 | 0.004 | 0.004 | 0.004 |
| Flavors | 1.30 | 1.30 | 4.00 | 4.00 | 4.00 | 0.30 | 1.40 | 0.30 |
| Cooling agent | 0.06 | 0.06 | 0.06 | 0.06 | 0.06 | 0.06 | 0.06 | 0.06 |
| Citric acid | 3.00 | 3.00 | 0 | 2.17 | 0 | 3.00 | 3.00 | 3.00 |
| Intense sweetener | 0.05 | 0.05 | 0.02 | 0.02 | 0.02 | 0.02 | 0.02 | 0.02 |

TABLE 3
Optional Coating Composition

| | % by weight | | | | | | | |
|---|---|---|---|---|---|---|---|---|
| Component | 83 | 84 | 85 | 86 | 87 | 88 | 89 | 90 |
| Maltitol | 95.02 | 95.02 | 95.36 | 95.36 | 95.36 | 95.02 | 95.02 | 95.02 |
| Bleached | 3.32 | 3.32 | 3.32 | 3.32 | 3.32 | 3.32 | 3.32 | 3.32 |
| gum | | | | | | | | |
| Arabic | | | | | | | | |
| Titanium | 0.36 | 0.36 | 0.36 | 0.36 | 0.36 | 0.36 | 0.36 | 0.36 |
| dioxide | | | | | | | | |
| Flavors | 1.07 | 1.07 | 0.51 | 0.51 | 0.51 | 1.07 | 1.07 | 1.07 |
| Cooling | 0.08 | 0.08 | 0.15 | 0.15 | 0.15 | 0.08 | 0.08 | 0.08 |
| agent | | | | | | | | |
| Intense | 0.08 | 0.08 | 0.23 | 0.23 | 0.23 | 0.08 | 0.08 | 0.08 |
| sweetener | | | | | | | | |
| Color | 0 | 0 | 0 | 0 | 0 | 0 | 0 | 0 |
| Candelilla | 0.08 | 0.08 | 0.08 | 0.08 | 0.08 | 0.08 | 0.08 | 0.08 |
| wax | | | | | | | | |

Gum pieces including at least two regions: liquid fill and gum region are prepared according to the compositions in Tables 1-2 above with each region according to the corresponding components for compositions 83-90.

The compositions for the gum regions are prepared by first combining talc, where present, with the gum base under heat at about 85° C. This combination is then mixed with the maltitol, lecithin and other polyols for six minutes. The flavor blends which include a pre-mix of the flavors and cooling agents are added and mixed for 1 minute. Finally, the acids and intense sweeteners are added and mixed for 5 minutes.

The liquid fill composition is then prepared by first preparing a pre-mix of the sodium carboxymethyl cellulose, glycerin, and polyols. This pre-mix is then combined with the colors, flavors, cooling agents, acids and intense sweeteners and mixed.

The gum region and liquid-fill compositions are then extruded together and formed into tablets by the process described above. The center-fill and/or gum region is dusted with a dusting composition. The dusting composition may include any of the encapsulated dusting components set forth in Examples 1-78 above. For example, the outer surface of any of the gum pieces of Examples 83-90 may be dusted with a dusting composition including encapsulated menthol from Example 14 above. The dusting composition could also include unencapsulated menthol. The gum pieces may also be coated with an optional coating as provided in Table 3 above.

### Examples 91-100

Examples 91-100 provide various dusting compositions, which are used to dust chewing gum compositions. These dusting compositions may be used, for example, to dust any of the chewing gum products provided in Examples 79-90 above.

TABLE 4
Dusting Composition
% w/w

| Component | 91 | 92 | 93 | 94 | 95 | 96 | 97 | 98 | 99 | 100 |
|---|---|---|---|---|---|---|---|---|---|---|
| Sugar | q.s. | q.s. | q.s. | q.s. | 5-99 | 5-99 | | | | |
| Mannitol | | | | | 5-99 | 5-99 | q.s. | q.s. | q.s. | q.s. |
| Talc | 1-10 | | 1-10 | | 1-10 | 1-10 | 1-10 | 1-10 | | |
| Calcium | | 1-10 | | 1-10 | 1-10 | 1-10 | | | 1-10 | 1-10 |
| Carbonate | | | | | | | | | | |
| Encapsulated | 1-95 | | | | 1-95 | | 1-95 | | | |
| Erythritol | | | | | | | | | | |
| (from | | | | | | | | | | |
| Example 3) | | | | | | | | | | |
| Encapsulated | | 0.1-3 | | | | | | 0.1-3 | | |
| Caffeine | | | | | | | | | | |
| (from | | | | | | | | | | |
| Example 15) | | | | | | | | | | |
| Encapsulated | | | 0.001-3 | | | 0.001-3 | | | 0.001-3 | |
| neotame | | | | | | | | | | |
| (from | | | | | | | | | | |
| Example 27) | | | | | | | | | | |
| Encapsulated | | | | 0.1-5 | | | | | 0.1-5 | 0.1-5 |
| spray dried | | | | | | | | | | |
| peppermint | | | | | | | | | | |
| flavor (from | | | | | | | | | | |
| Example 7) | | | | | | | | | | |
| Free | | | | | | 0.0001-1 | | | | |
| neotame | | | | | | | | | | |
| Free caffeine | | | | | | | | 01.-3 | | |
| Free | 1-95 | | | | | | | | | 1-95 |
| Erythritol | | | | | | | | | | |

The dusting compositions are prepared by blending the ingredients shown in Table 4. The ingredient representing the largest weight percentage is first added to a dry blender and the remaining ingredients are added with mixing. The dusting composition is mixed until homogeneous.

1. A dusting composition comprising:
a dusting component;
an encapsulating material, wherein said dusting component is at least partially encapsulated by said encapsulating material.

2. The dusting composition of claim 1, wherein said encapsulating material comprises a high molecular weight polymer.

3. The dusting composition of 1, wherein said dusting component is selected from the group consisting of sweeteners, flavors, starches, sensates, potentiators, breath freshening ingredients, dental care ingredients, active ingredients, effervescing system ingredients, appetite suppressor ingredients, mouth moistening ingredients, lubricants, coloring agents, food acid ingredients, micronutrients, throat care ingredients, nutraceuticals, phytochemicals, bioeffecting agents, and combinations thereof.

4. The dusting composition of claim 1, wherein said dusting composition comprises a thermally stabilized active composition.

5. The dusting composition of claim 1, wherein said dusting composition has an average particle size ranging from about 50 μm to about 800 μm.

6. The dusting composition of claim 1, wherein said dusting component is present in amounts of about 1% to about 50% by weight of said composition.

7. The dusting composition of claim 1, wherein said encapsulating material is present in amounts of about 1% to about 50% by weight of said composition.

8. The dusting composition of claim 1, wherein said dusting composition further comprises an unencapsulated dusting component.

9. The dusting composition of claim 8, wherein said unencapsulated dusting component is the same as said encapsulated dusting component.

10. A chewing gum composition comprising:
(a) a chewing gum unit comprising an elastomer; and
(b) a dusting composition comprising:
(i) a dusting component; and
(ii) an encapsulating material, wherein said dusting component is at least partially encapsulated by said encapsulating material; and
wherein said chewing gum unit has an outer surface and wherein said dusting composition is located on said outer surface.

11. A multi-region chewing gum composition comprising:
(a) a chewing gum unit comprising:
(i) a first region composition; and
(ii) a second region composition surrounding at least a portion of said first region composition; said second region composition comprising an elastomer and having a first region contacting surface and an outer surface; and
(b) a dusting composition, at least a portion of which is encapsulated, located on at least one of said first region contacting surface and said outer surface.

12. The chewing gum composition of claim 11, wherein said chewing gum composition is a chewing gum piece selected from the group consisting of: slab; pellet; stick; ball, square, and cube.

13. The chewing gum composition of claim 11, wherein said first region is a center-fill region selected from the group consisting of liquid, solid, semi-solid, gas, and combinations thereof.

14. The chewing gum composition of claim 11, wherein said encapsulating material comprises a high molecular weight polymer.

15. The chewing gum composition of 11, wherein said dusting component is selected from the group consisting of sweeteners, flavors, starches, sensates, taste potentiators, breath freshening ingredients, dental care ingredients, active ingredients, effervescing system ingredients, appetite suppressor ingredients, mouth moistening ingredients, lubricants, coloring agents, food acid ingredients, micronutrients, throat care ingredients, nutraceuticals, phytochemicals, bioeffecting agents, and combinations thereof.

16. The chewing gum composition of claim 11, wherein said dusting composition comprises a thermally stabilized active composition.

17. The chewing gum composition of claim 11, wherein said dusting composition has an average particle size ranging from about 50 μm to about 800 μm.

18. The chewing gum composition of claim 11, wherein said dusting component is present in amounts of about 1% to about 50% by weight of said composition.

19. The chewing gum composition of claim 11, wherein said encapsulating material is present in amounts of about 1% to about 50% by weight of said composition.

20. The chewing gum composition of claim 11, wherein said dusting composition further comprises an unencapsulated dusting component.

21. The chewing gum composition of claim 20, wherein said unencapsulated dusting component is the same as said encapsulated dusting component.

22. The chewing gum composition of claim 20, wherein said unencapsulated dusting component is different from said encapsulated dusting component.

23. The chewing gum composition of claim 10, wherein said chewing gum composition is a chewing gum piece selected from the group consisting of: slab; pellet; stick; ball, square, cube, center-fill gum; compressed gum; candy gum; and deposited gum.

24. The chewing gum composition of claim 11, wherein said elastomer is present in an amount of about 1% to about 50% by weight of said chewing gum composition.

25. The chewing gum composition of claim 11, wherein said dusting composition is present in an amount of about 0.001% to about 20% by weight of said chewing gum composition.

26. A method of preparing a chewing gum unit comprising the steps of:
(a) providing a chewing gum composition comprising an elastomer;
(b) forming a chewing gum unit, said unit having an outer surface; and
(c) applying a dusting composition to said outer surface, said dusting composition comprising a dusting component and an encapsulating material, wherein said dusting component is at least partially encapsulated by said encapsulating material.

27. A method of preparing a multi-region chewing gum unit comprising the steps of:
(a) providing a chewing gum composition comprising:
(i) a first region;
(ii) a second region surrounding at least a portion of said first region, said second region comprising an elastomer;
(b) applying a dusting composition to at least one of said first and said second region, said dusting composition comprising a dusting component and an encapsulating material, wherein said dusting component is at least partially encapsulated by said encapsulating material; and
(c) forming a unit of multi-region chewing gum from the chewing gum composition.

28. The method of claim 27, wherein said method further comprises the step of removing said dusting composition prior to wrapping said unit of chewing gum.

29. A method for modifying a release profile of a dusting component encapsulated with an encapsulating material in a dusting composition, said dusting composition having at least one release characteristic and said dusting composition being included in a chewing gum composition, comprising:
determining a first release profile for said dusting component;
determining a desired change in said first release profile; and
modifying said at least one first release characteristic of said dusting composition based on said desired change in said first release profile.

30. The method of claim 29, wherein said at least one first release characteristic of said dusting composition is selected from the group consisting of tensile strength of said encapsulating material, ratio of said dusting component to said encapsulating material, type of encapsulating material, molecular weight of the encapsulating material, hydrophobicity of the encapsulating material, average particle size of the dusting component, the number of layers of encapsulating material, and combinations thereof.
